(19) United States
(12) Patent Application Publication
(10) Pub. No.: US 2004/0073443 A1
(43) Pub. Date: Apr. 15, 2004

(54) System for automating and managing an IP environment

(76) Inventors: John J. Gabrick, Pittsburgh, PA (US); Cassius A. Elston JR., Sammamish, WA (US)

Correspondence Address: PATRICK M. DWYER, MINDMATTERS TECHNOLOGIES, INC., SUITE 114, 1818 WESTLAKE AVENUE N, SEATTLE, WA, 98109, US

(21) Appl. No.: 10/459,116

(22) Filed: Jun. 10, 2003

Related U.S. Application Data
(63) Continuation-in-part of application No. 09/709,900, filed on Nov. 10, 2000.
(60) Provisional application No. 60/387,770, filed on Jun. 10, 2002.

(51) Int. Cl. G06F 17/60

(52) U.S. Cl. 705/1; 705/10

(57) ABSTRACT

A system for streamlining the process of creating, preserving and protecting proprietary assets. The system identifies, classifies, compiles, tracks and routes real-time data automatically on a continuous basis, and provides instant access to stored database information, such as trade secret archives, patent filings, computed valuations, user information and a variety of detailed reports. An employee has instant access to her latest innovations and proprietary materials, and constant supervision over them.

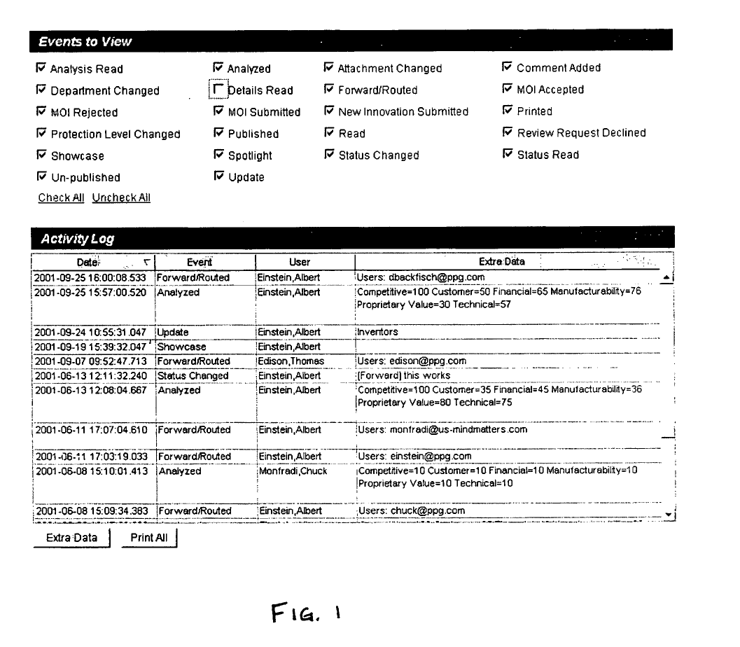

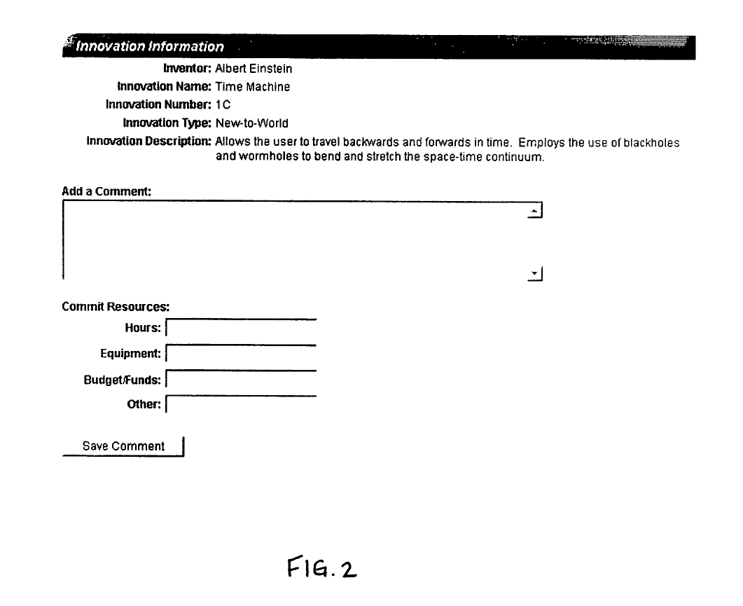

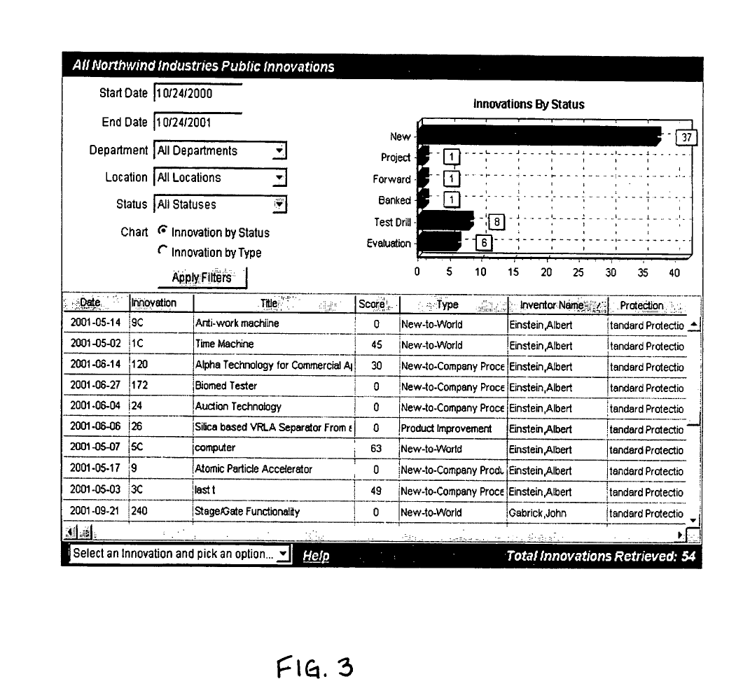

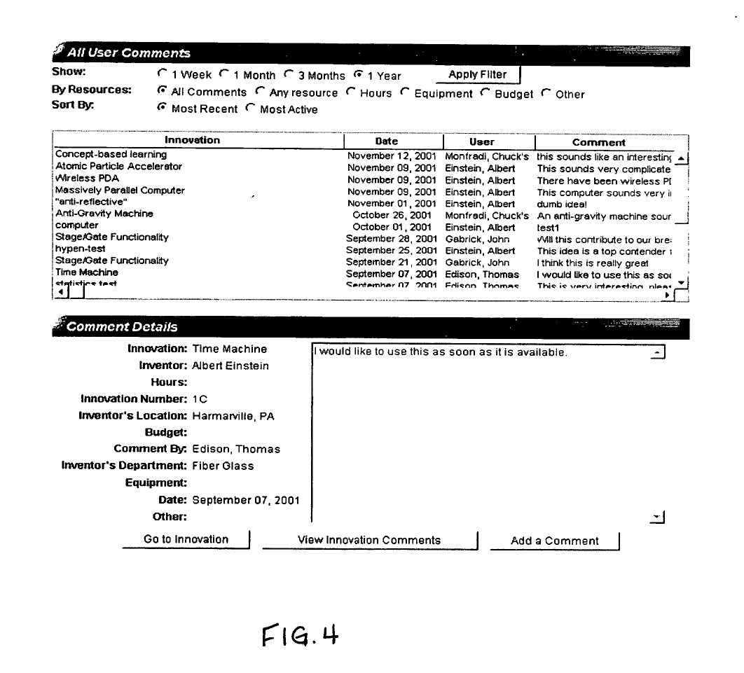

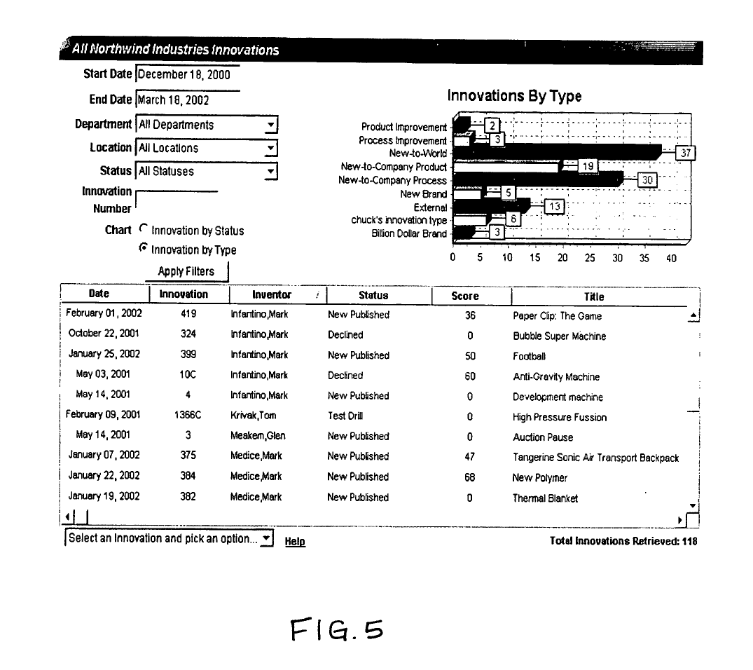

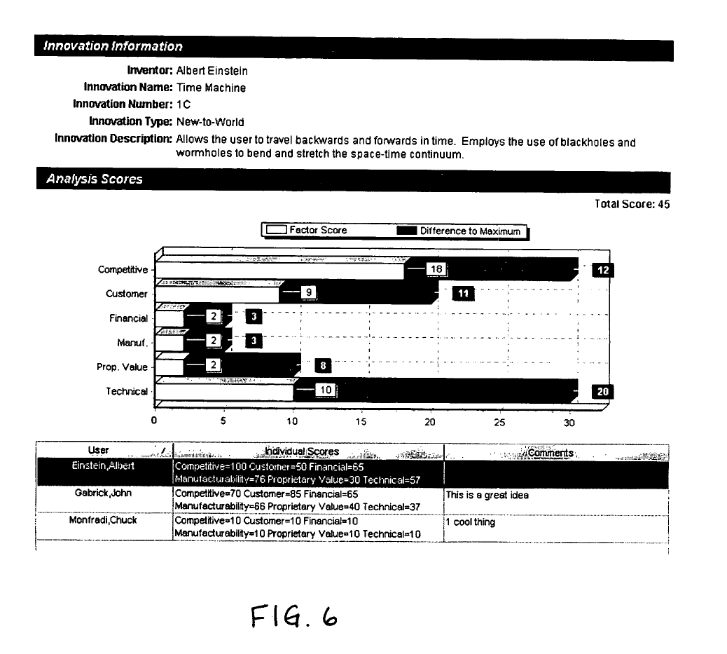

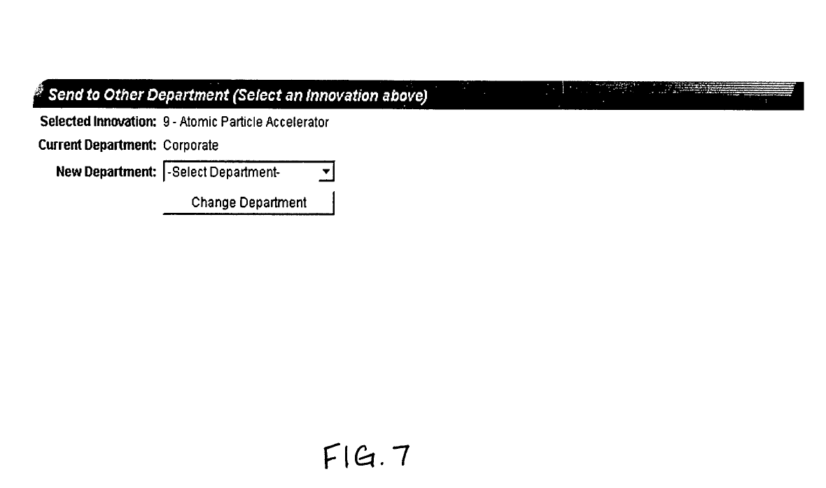

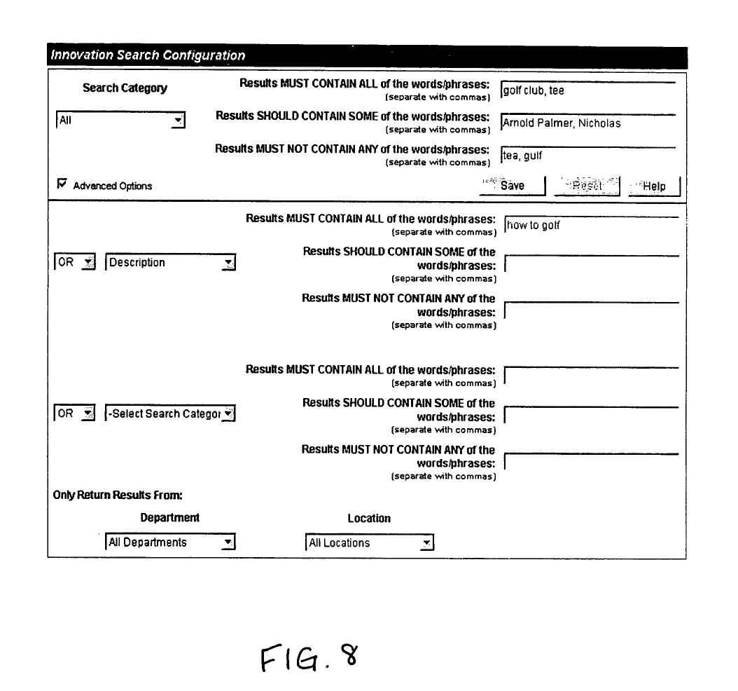

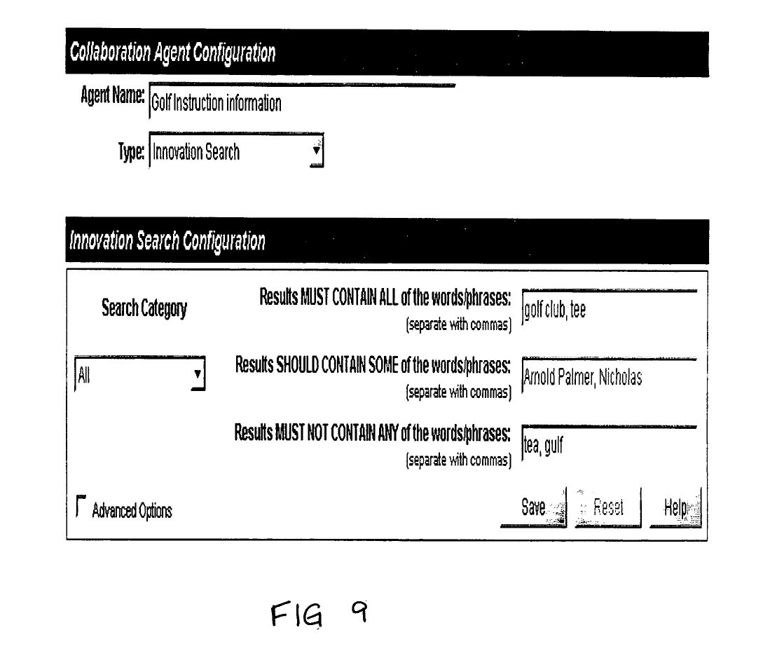

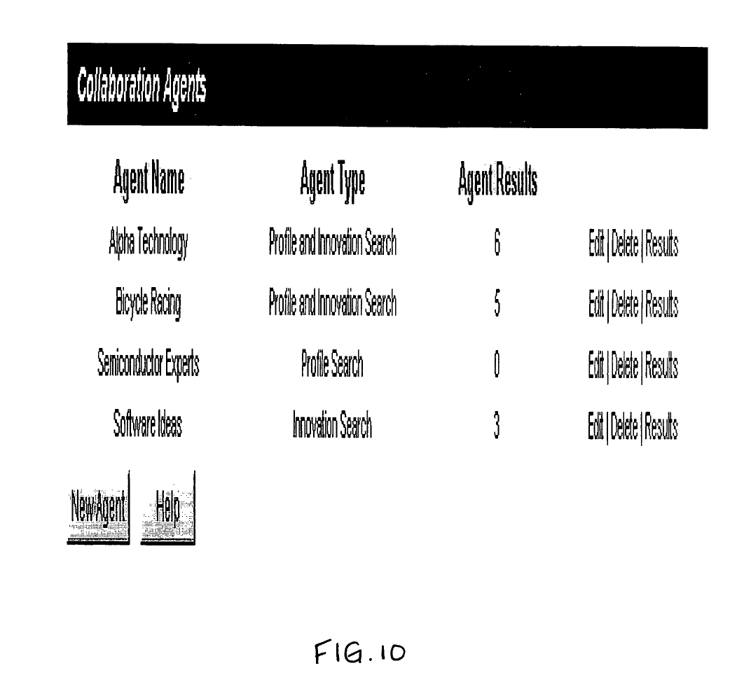

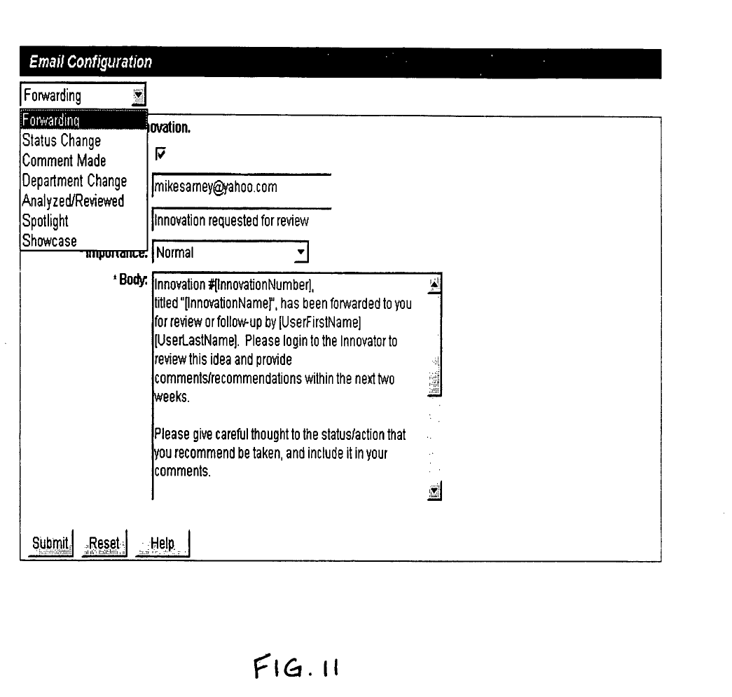

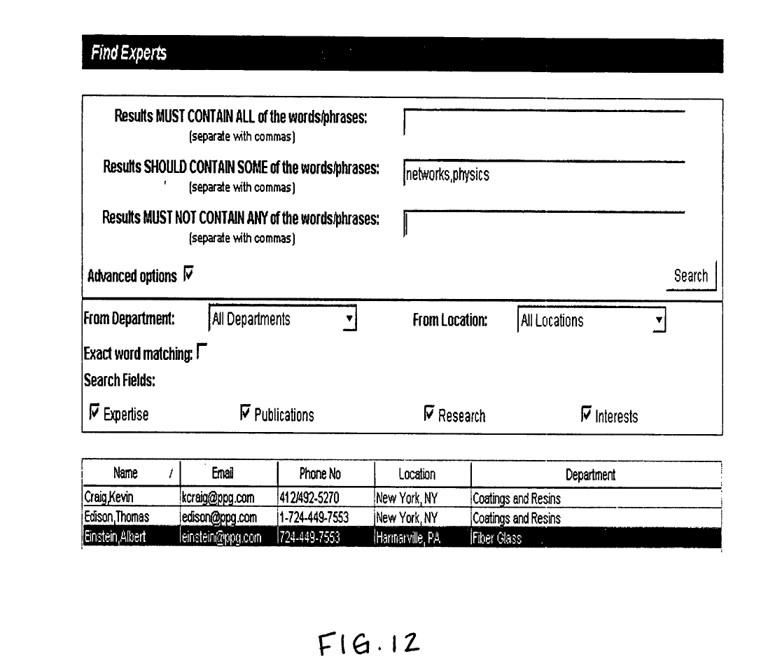

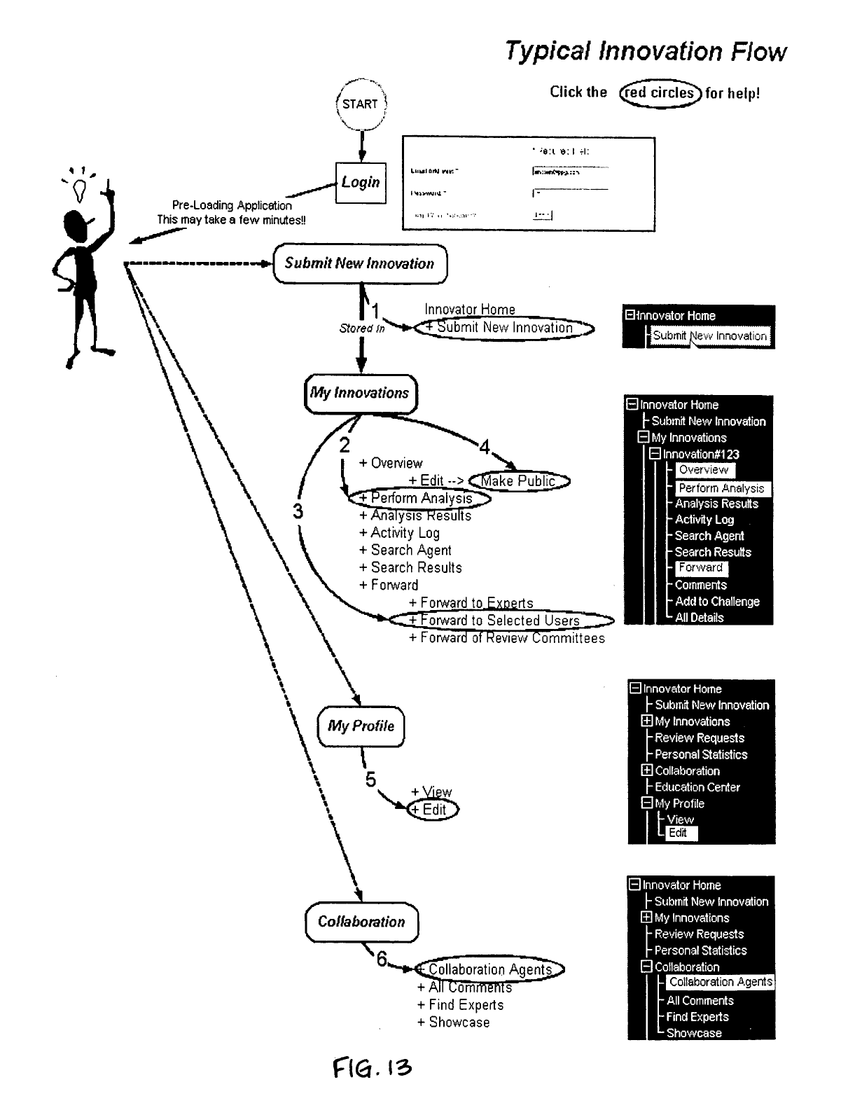

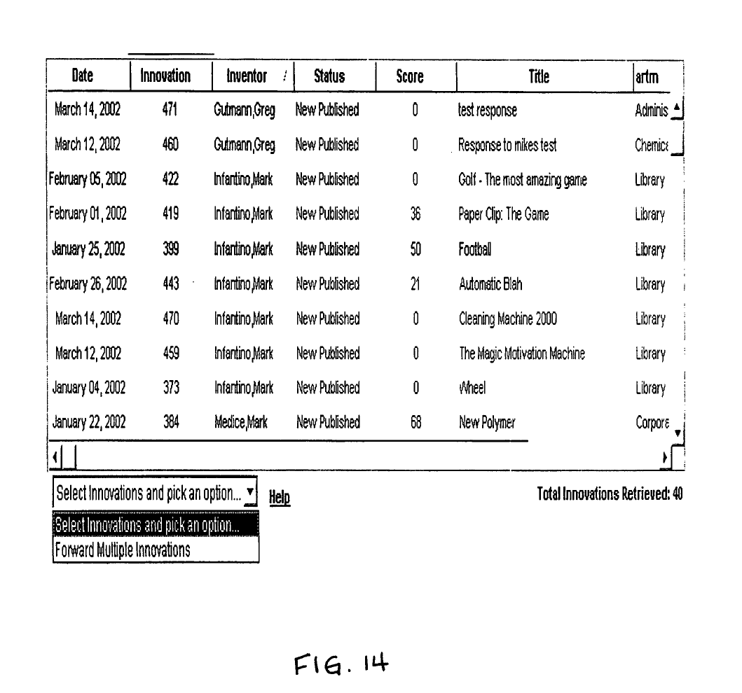

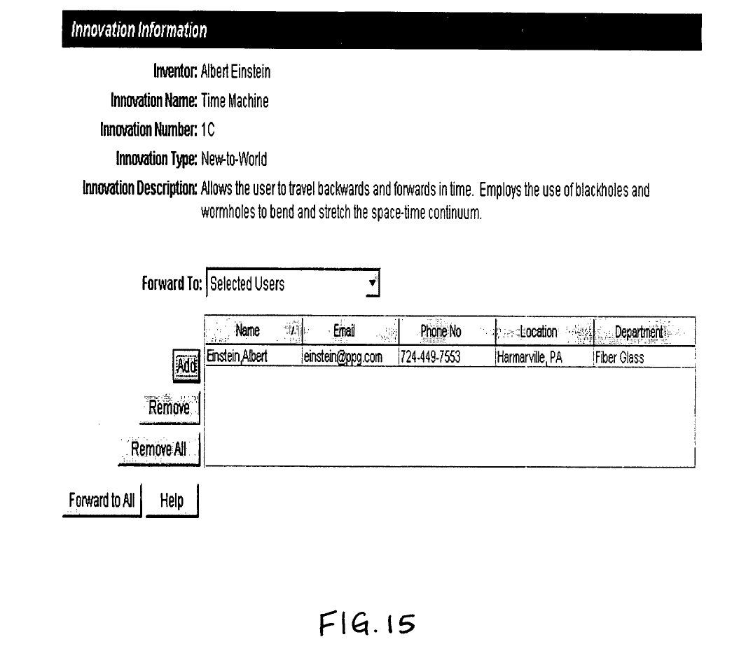

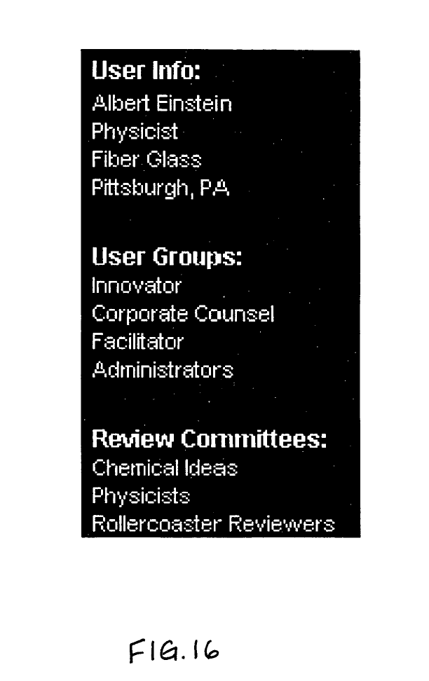

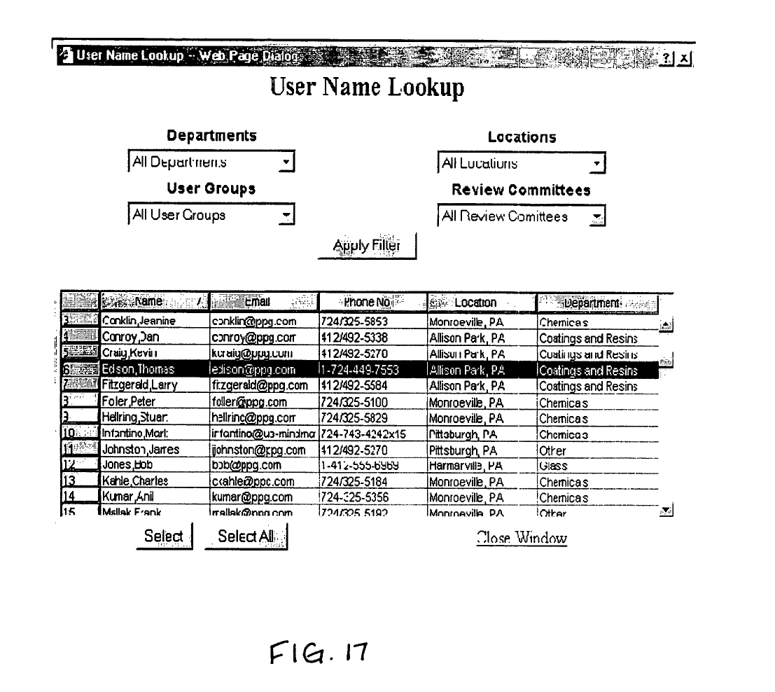

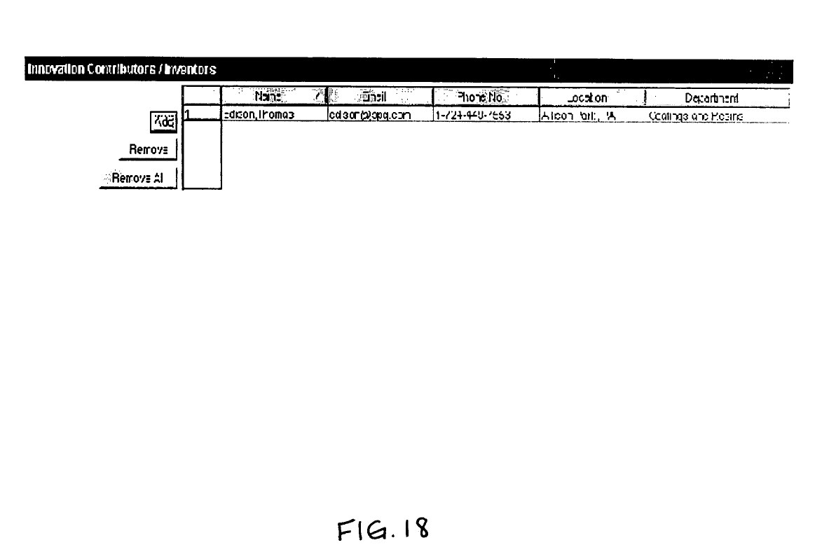

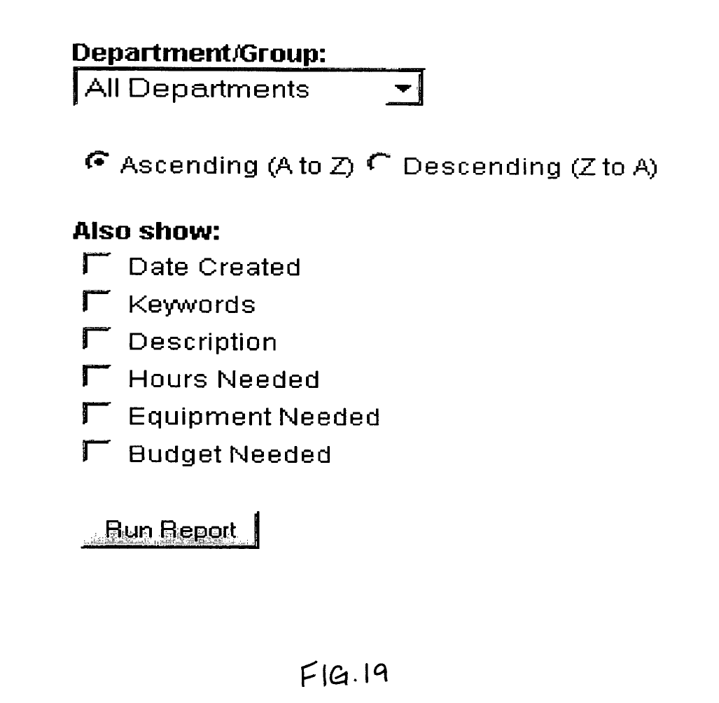

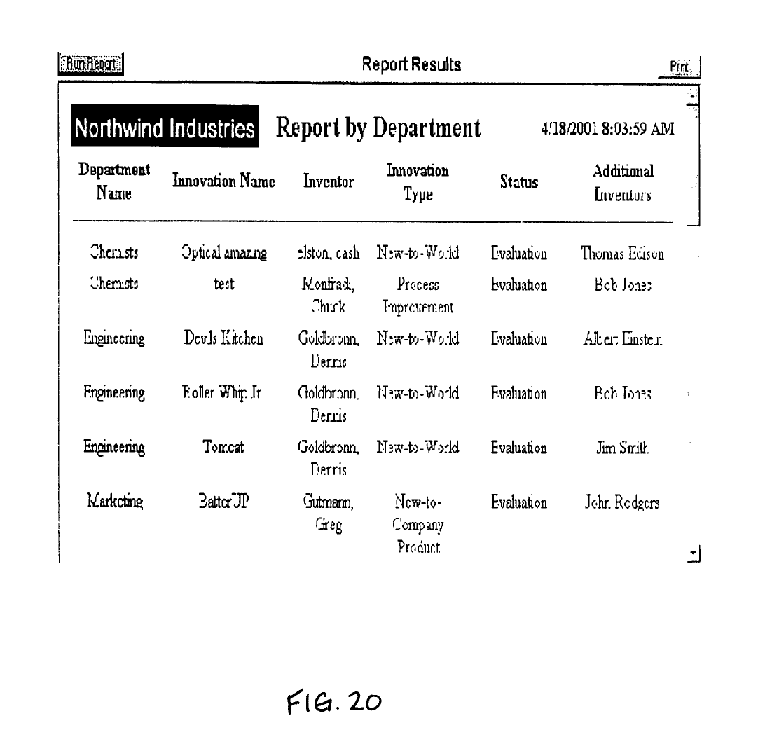

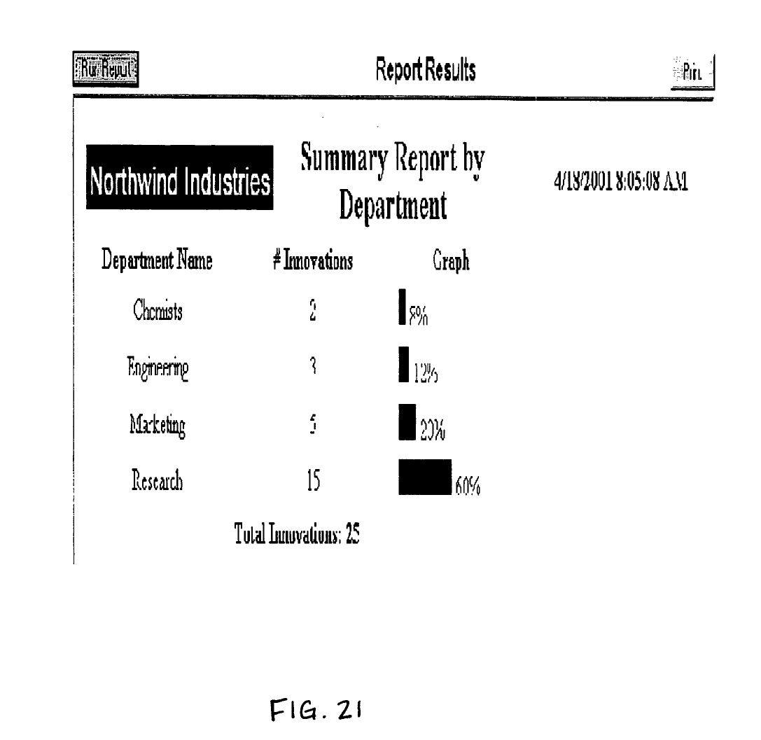

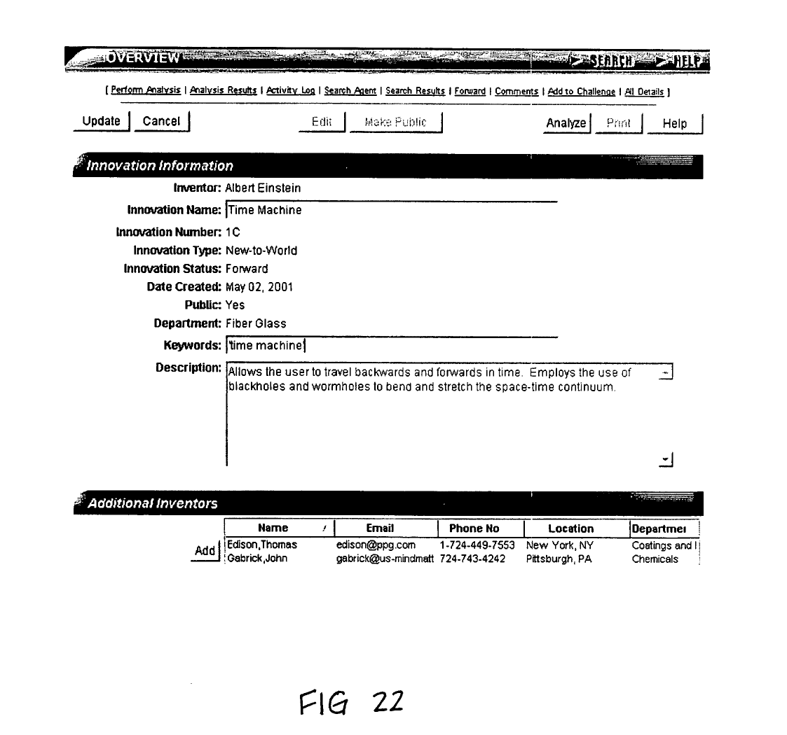

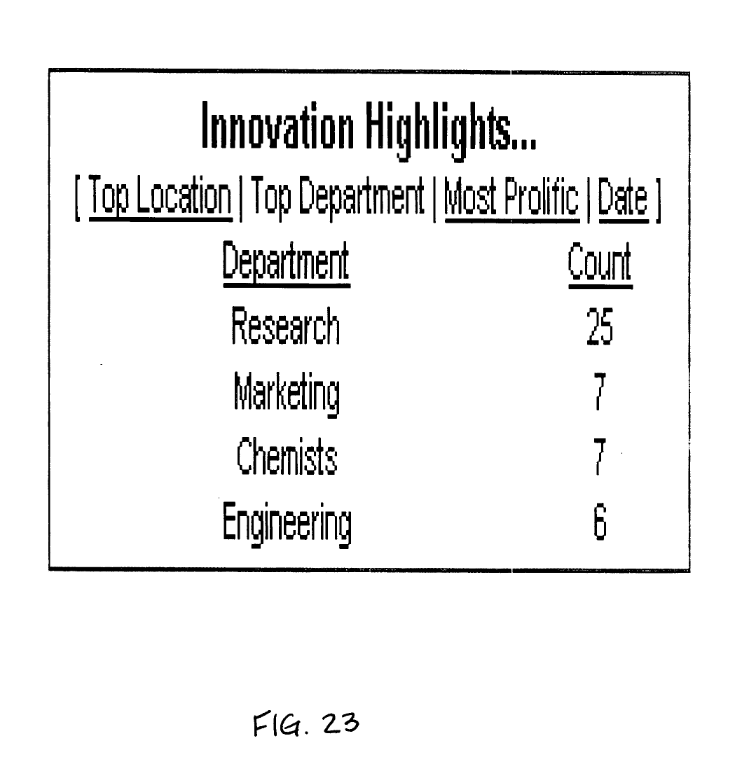

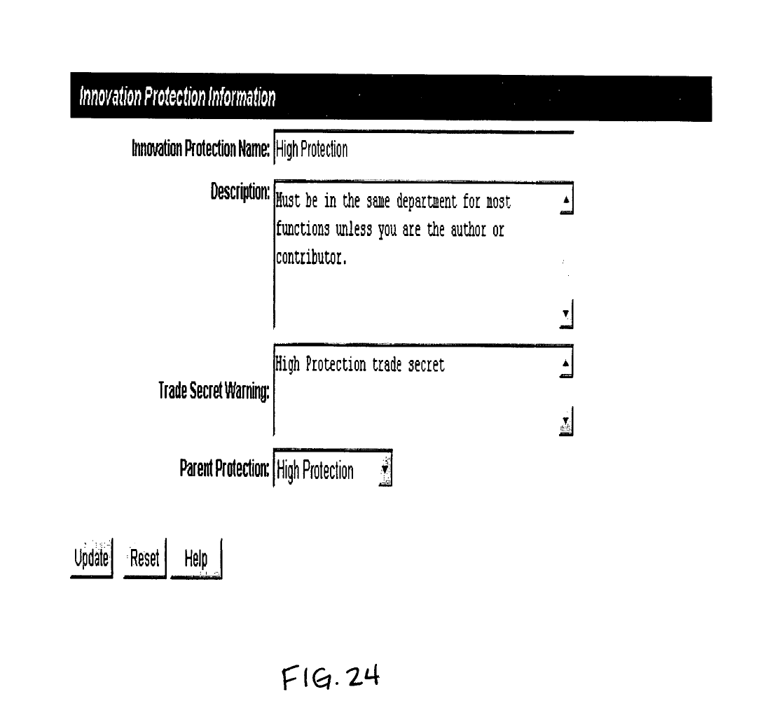

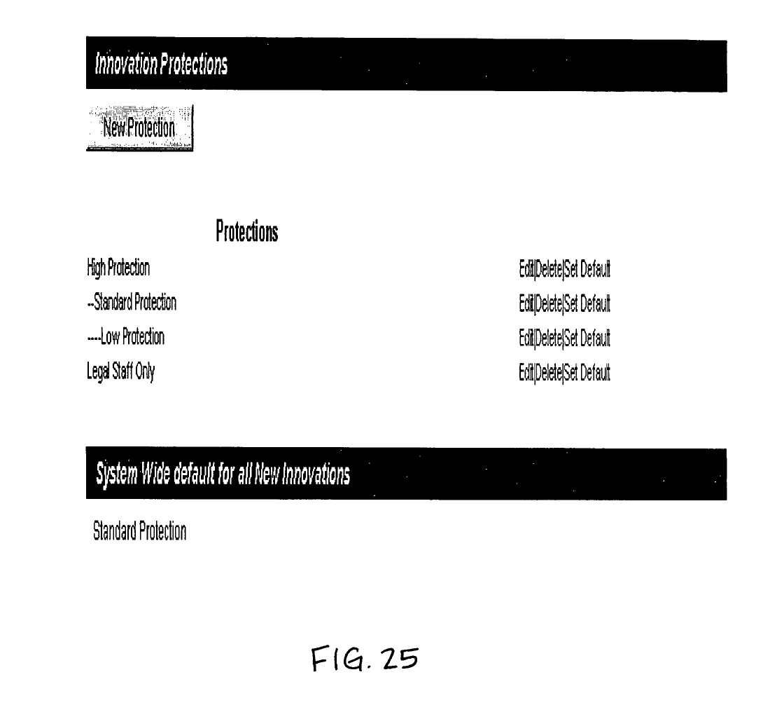

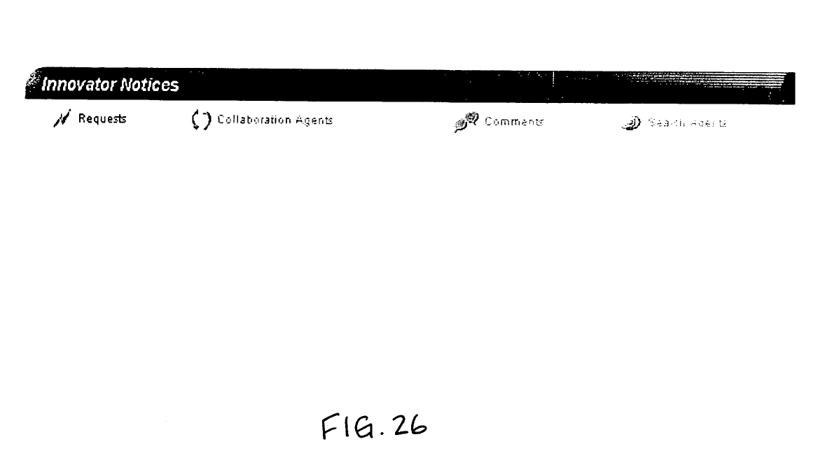

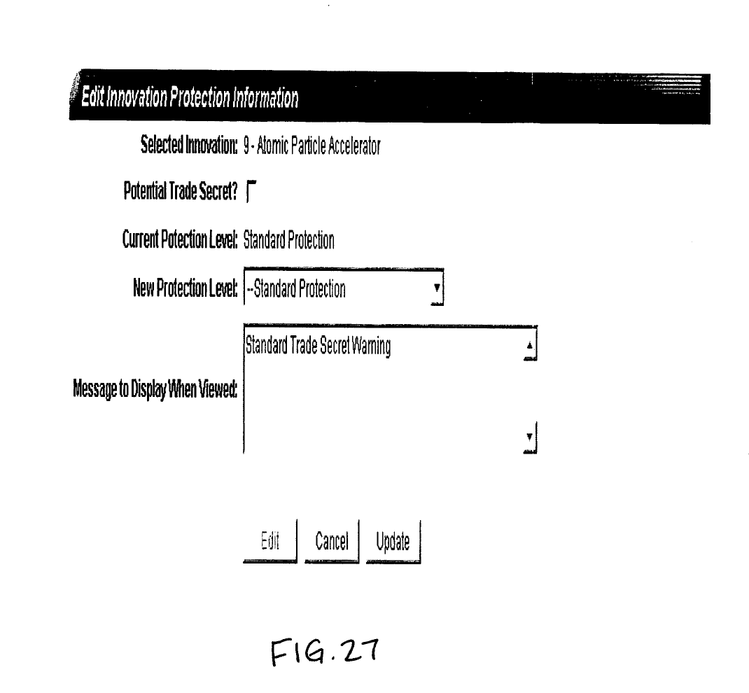

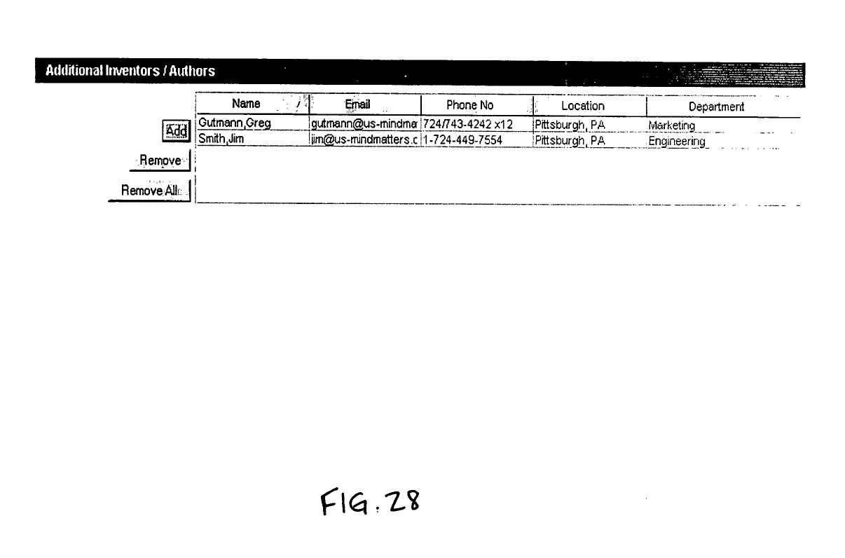

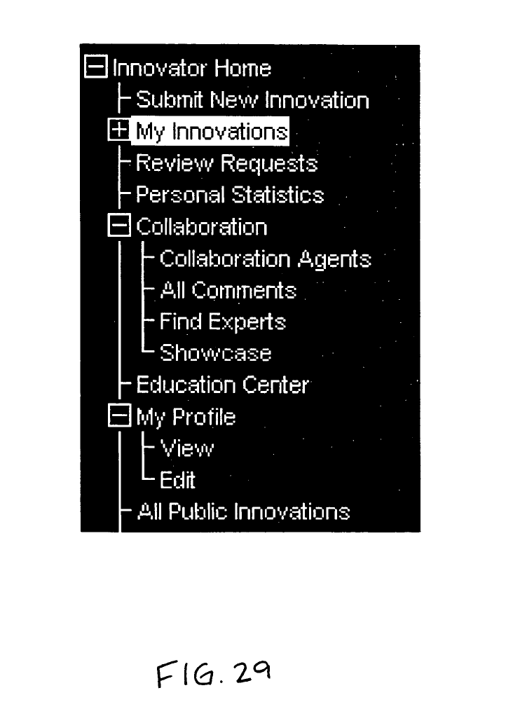

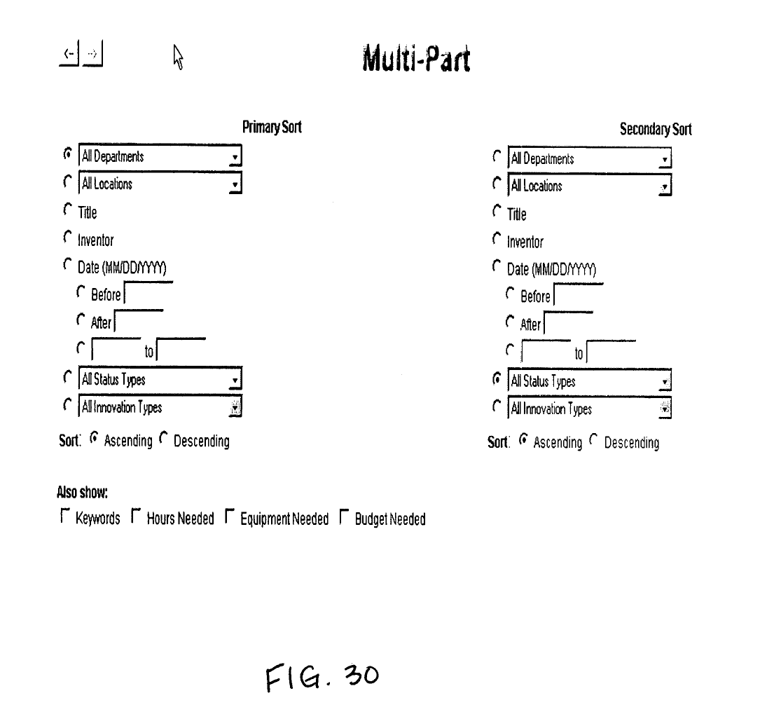

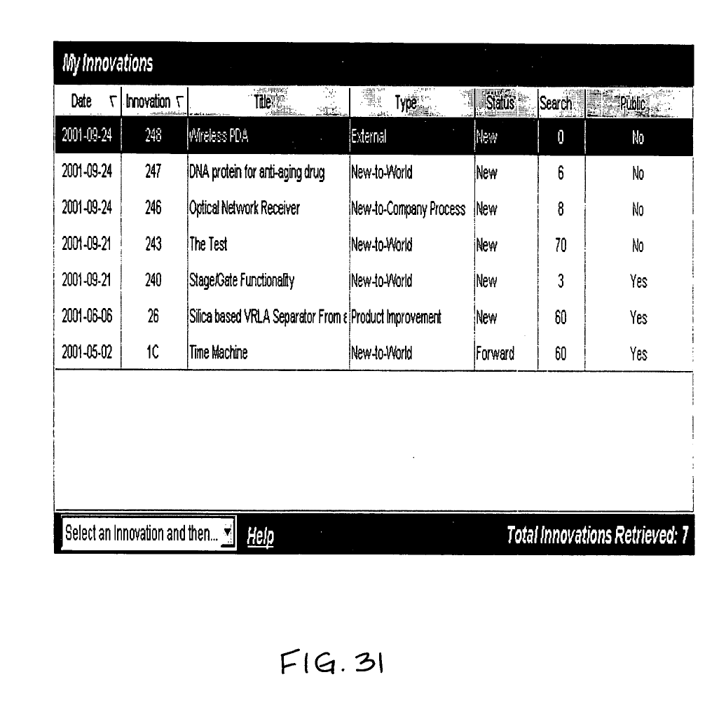

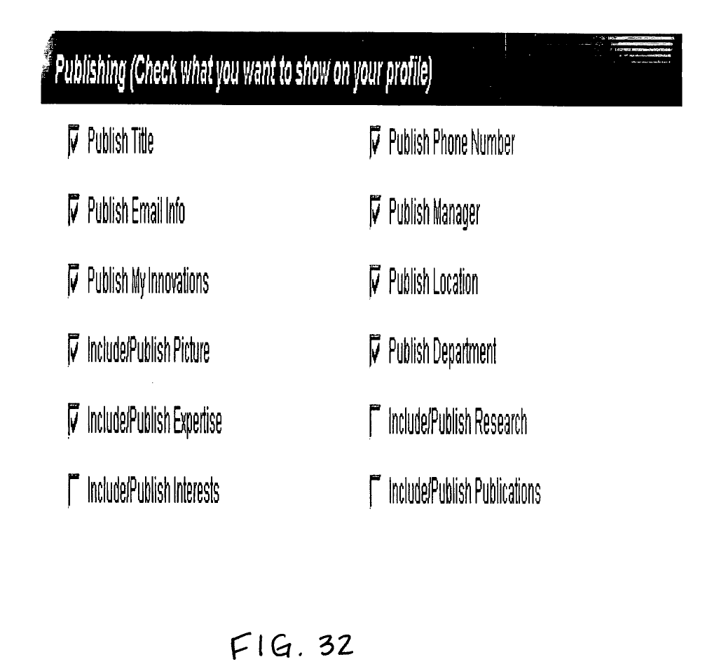

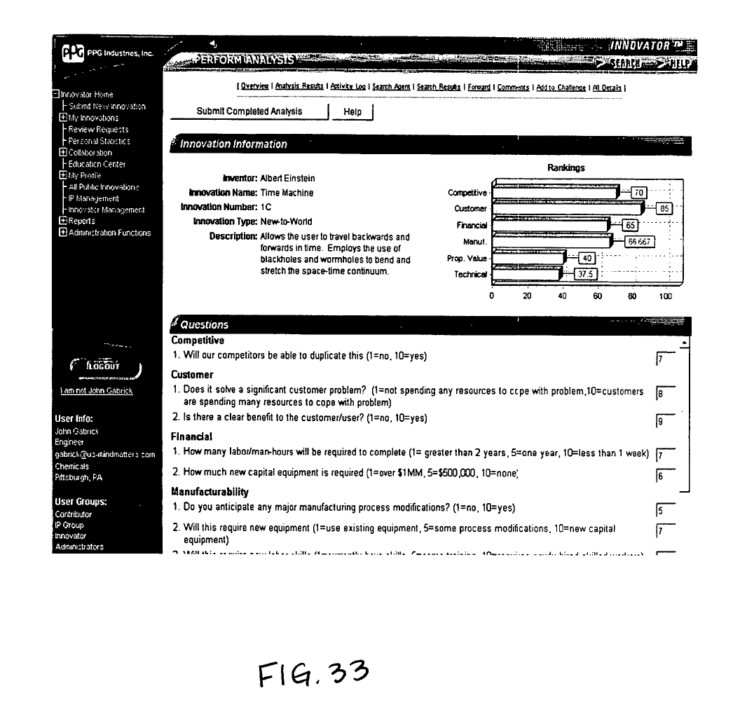

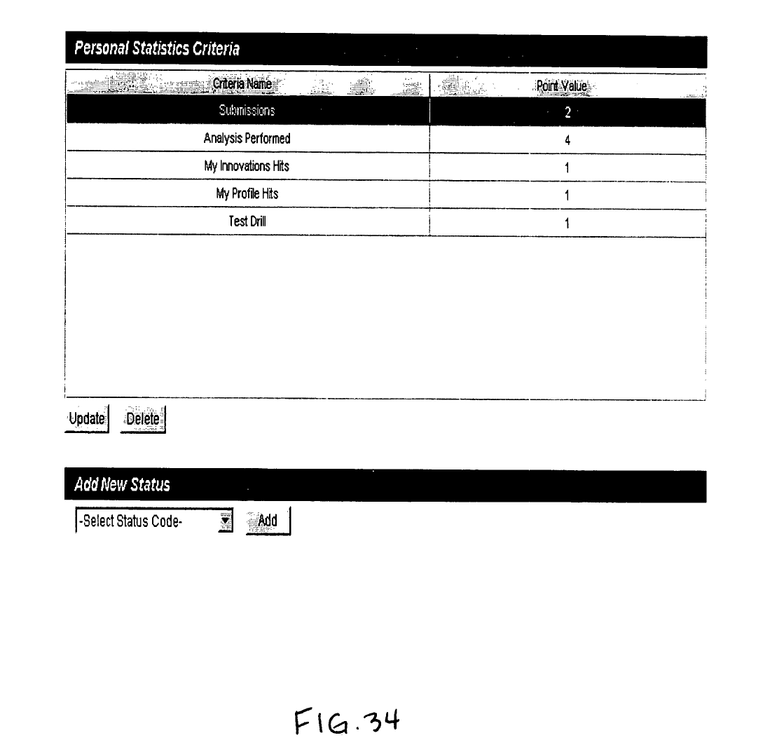

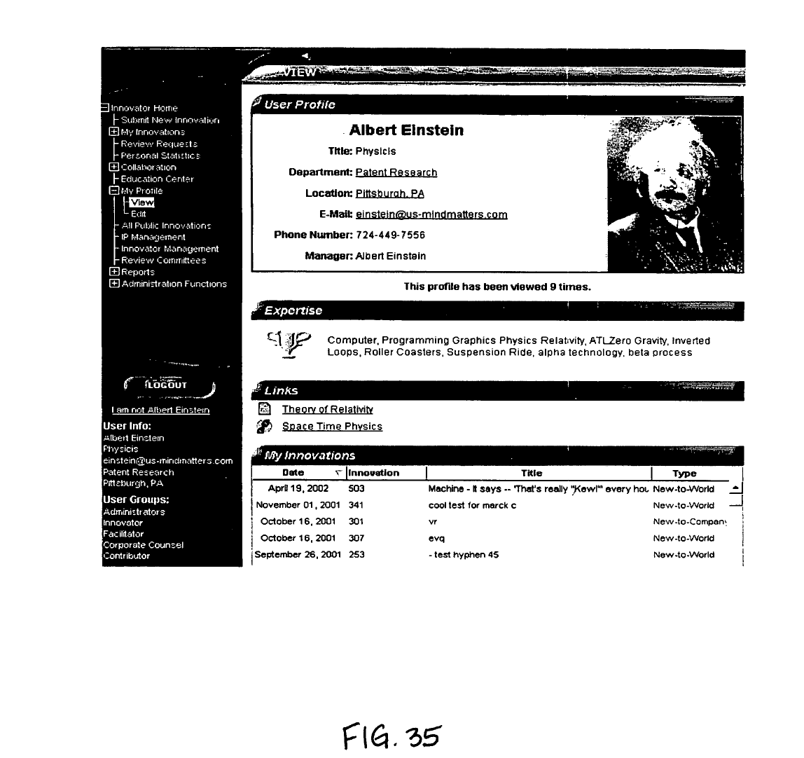

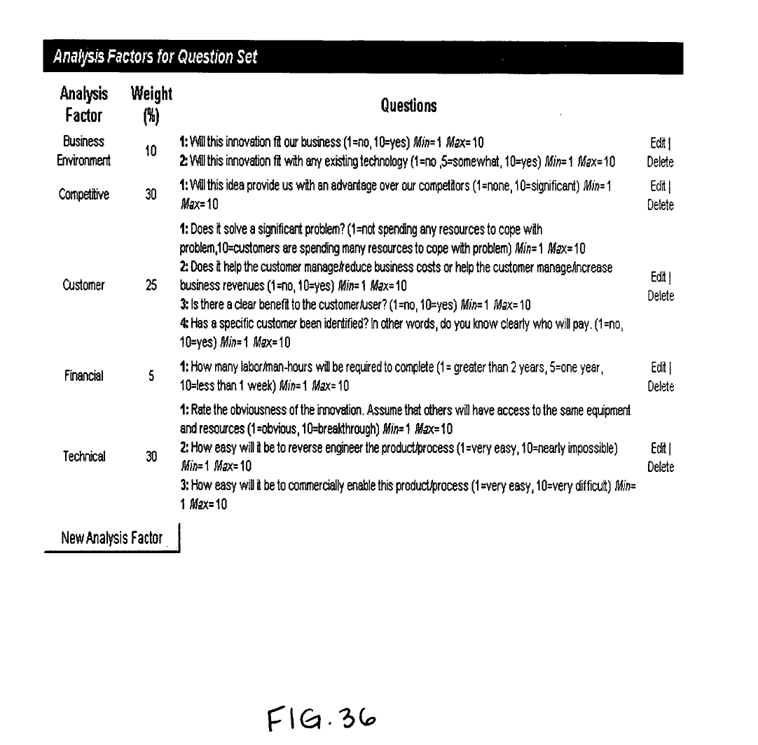

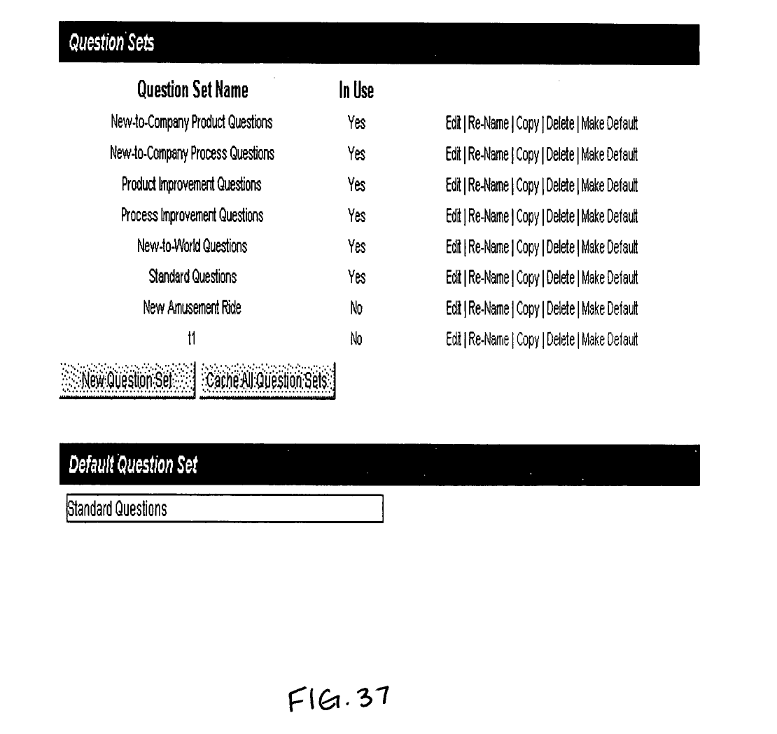

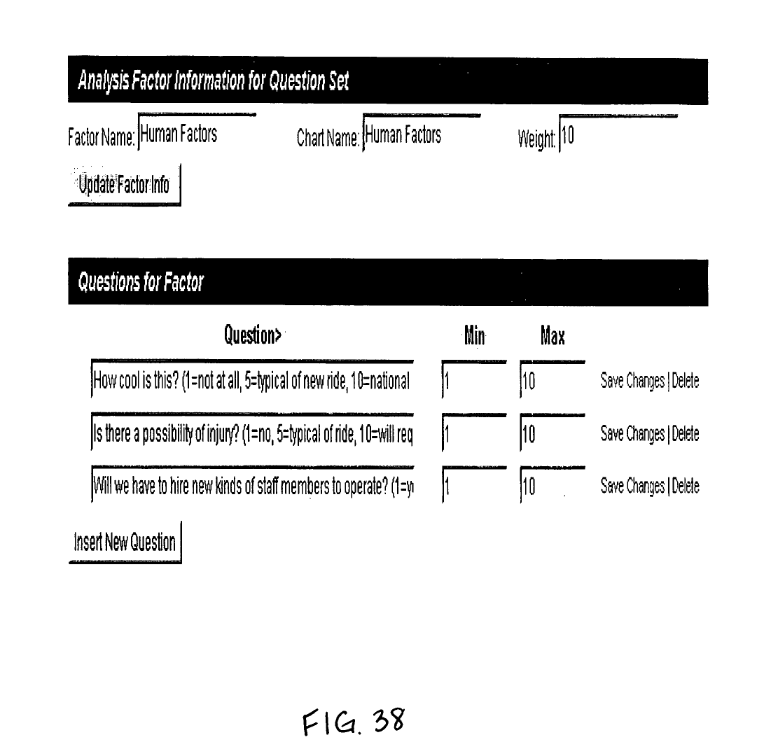

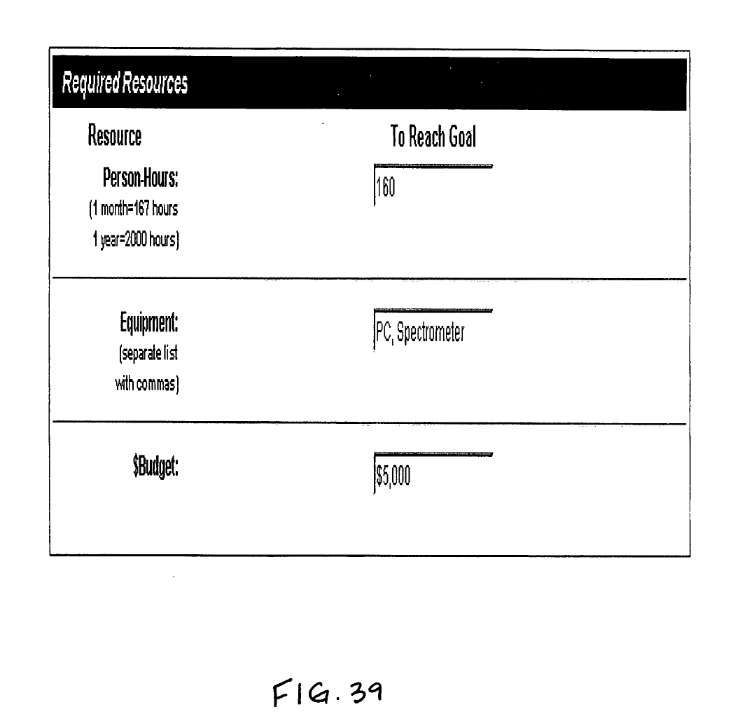

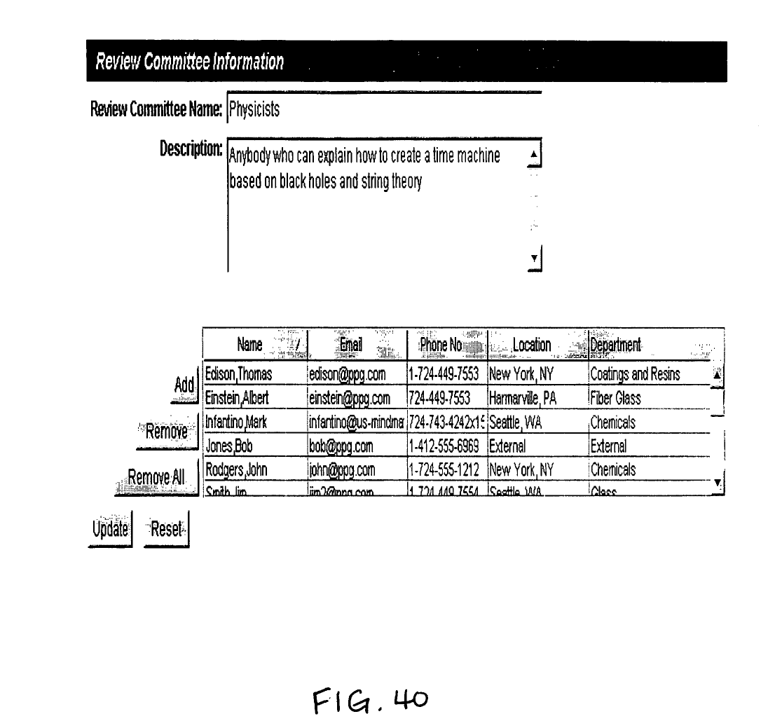

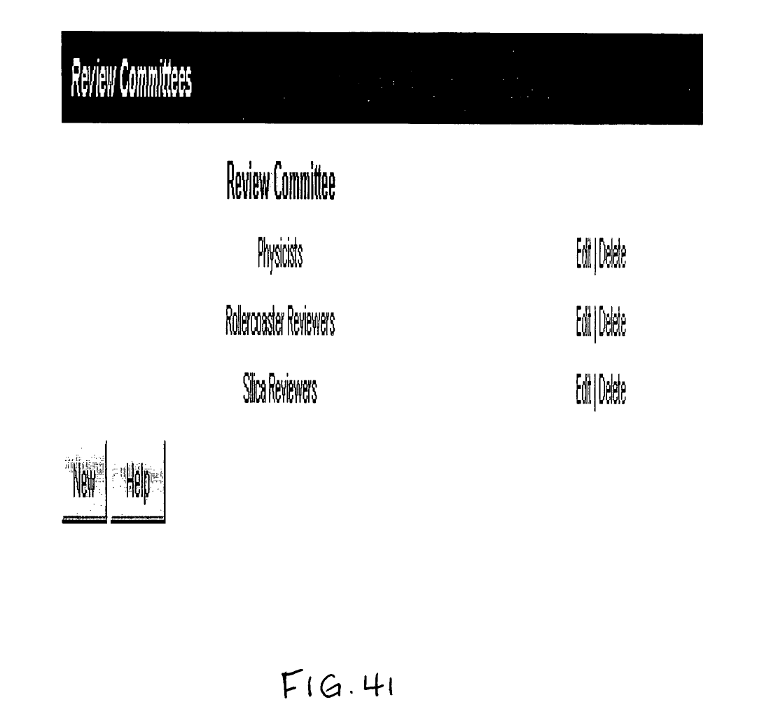

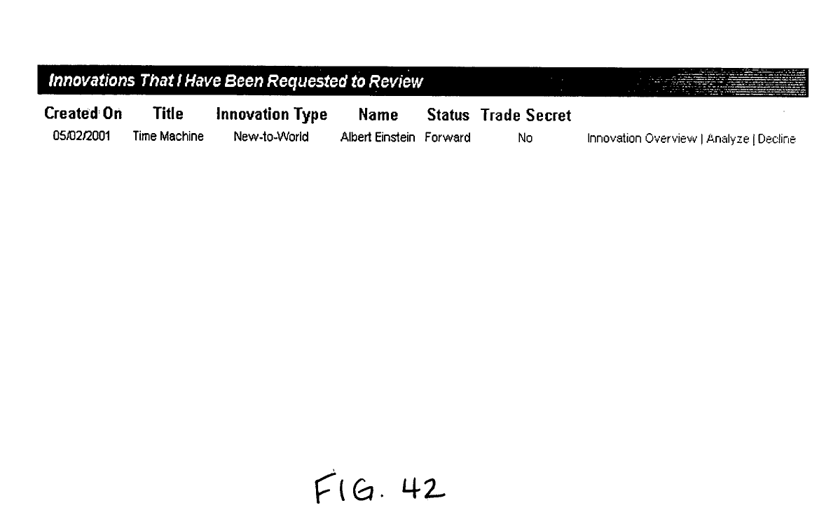

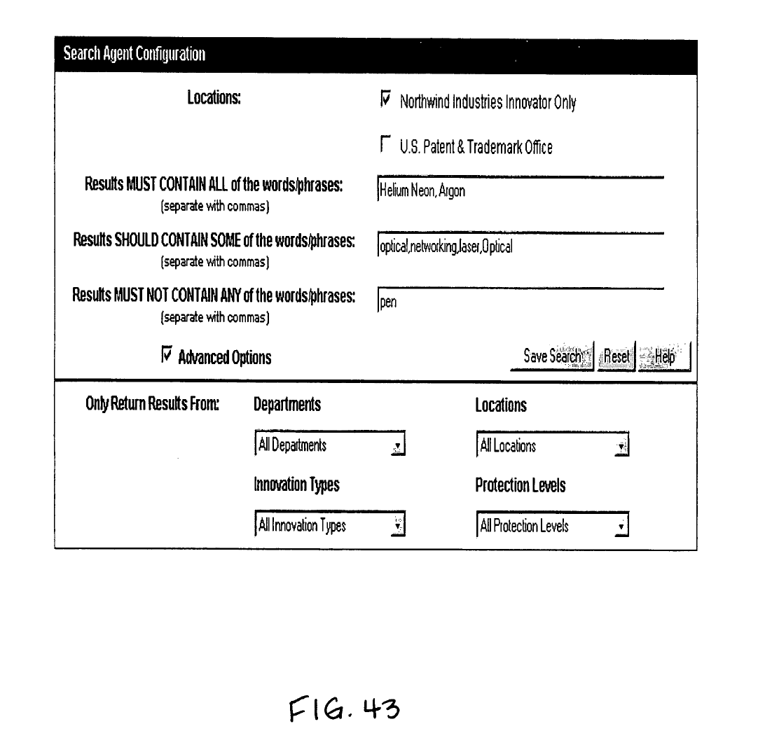

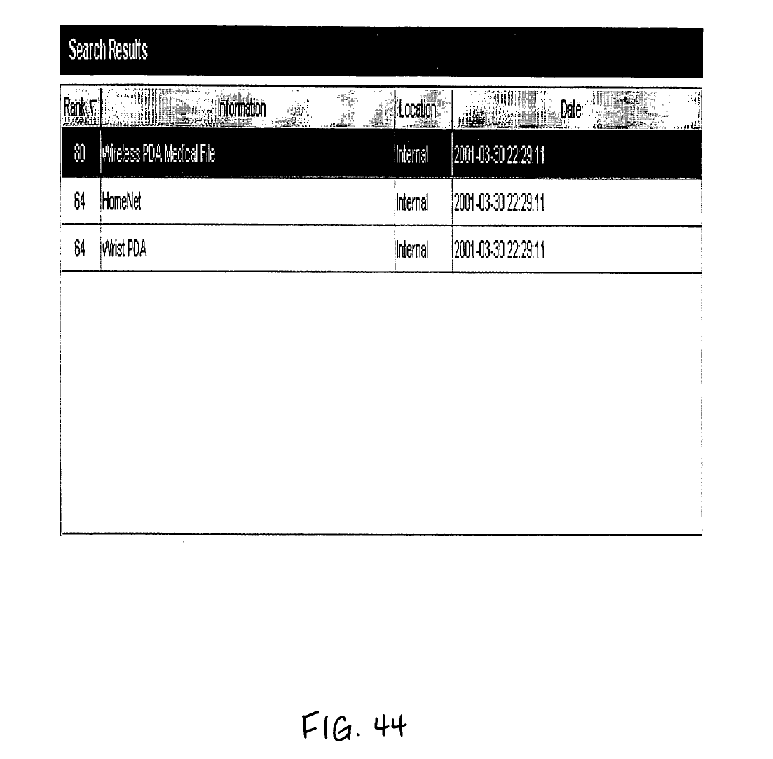

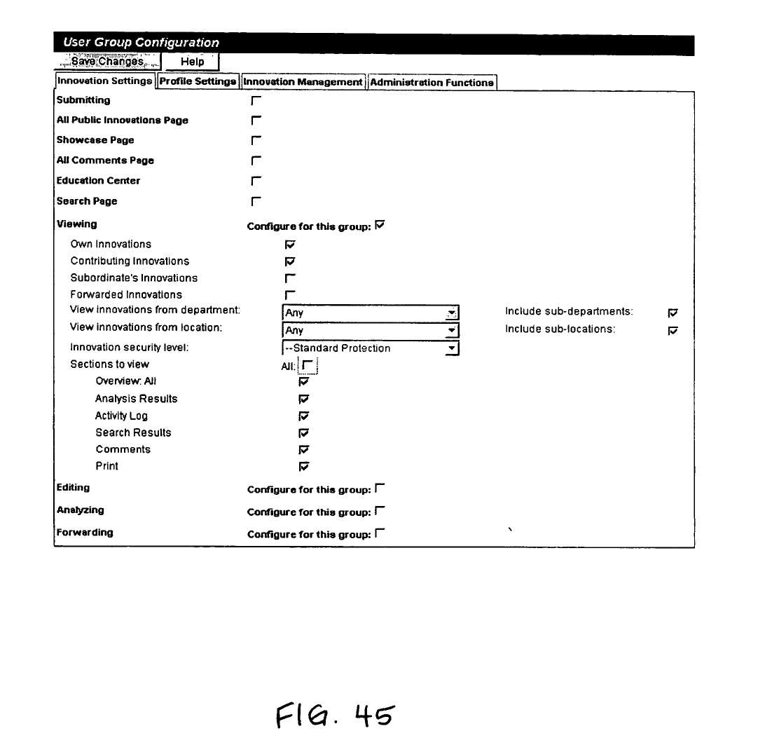

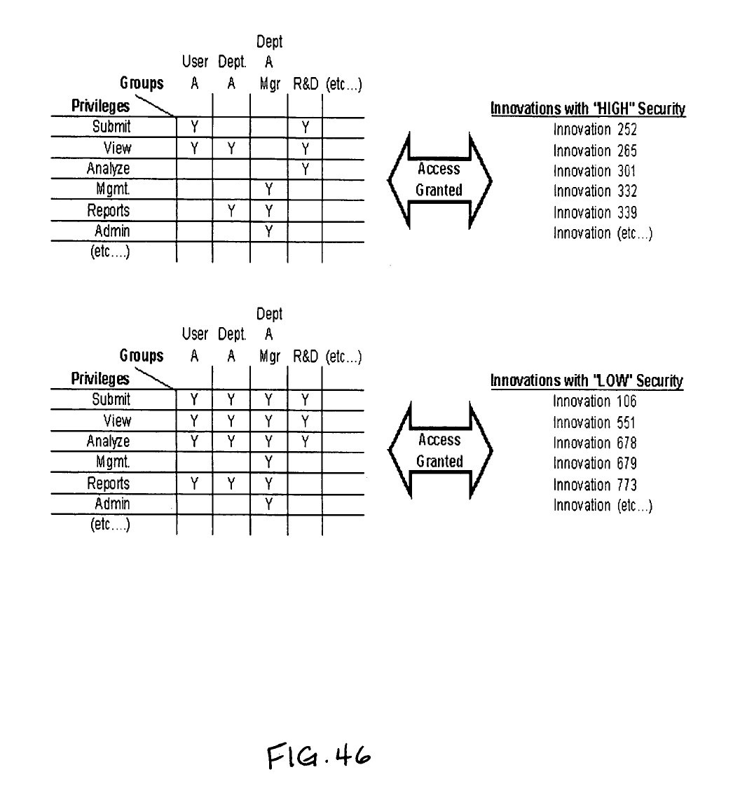

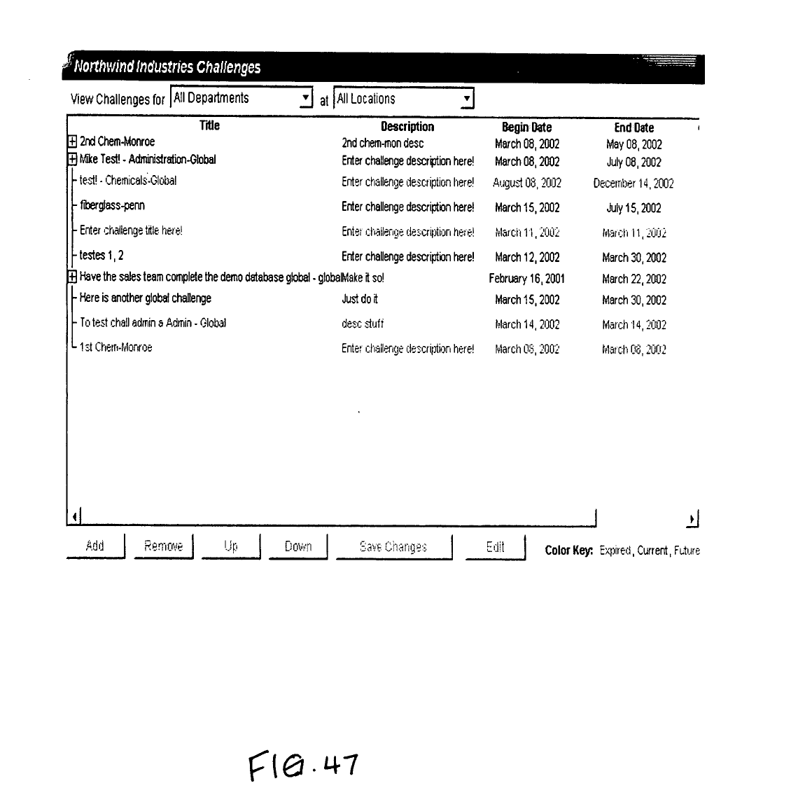

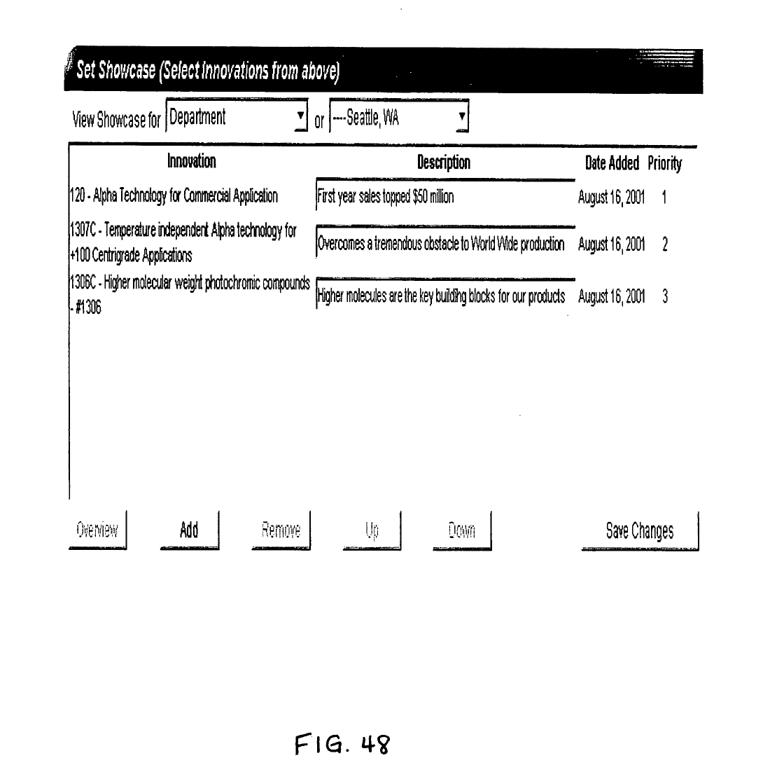

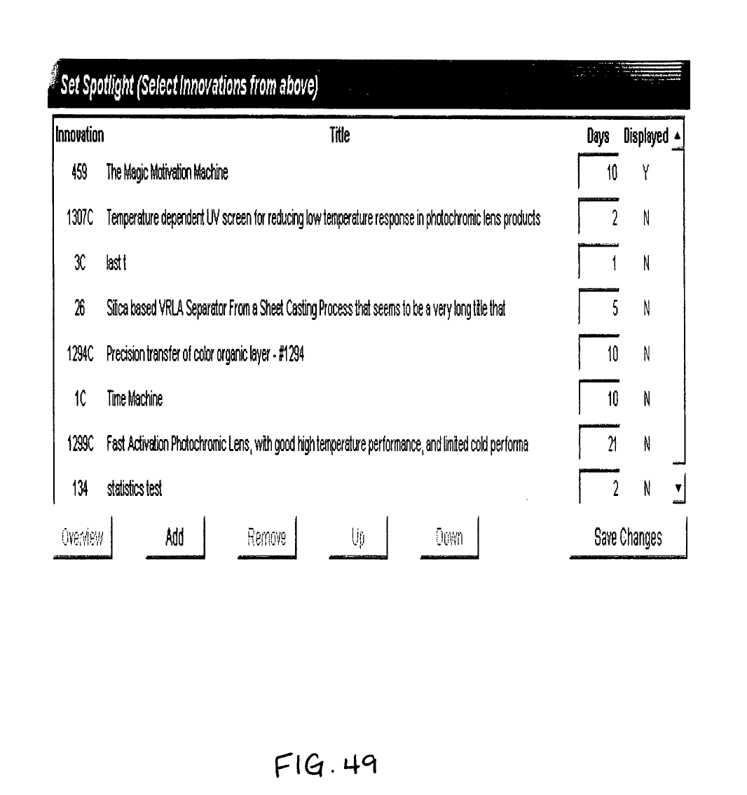

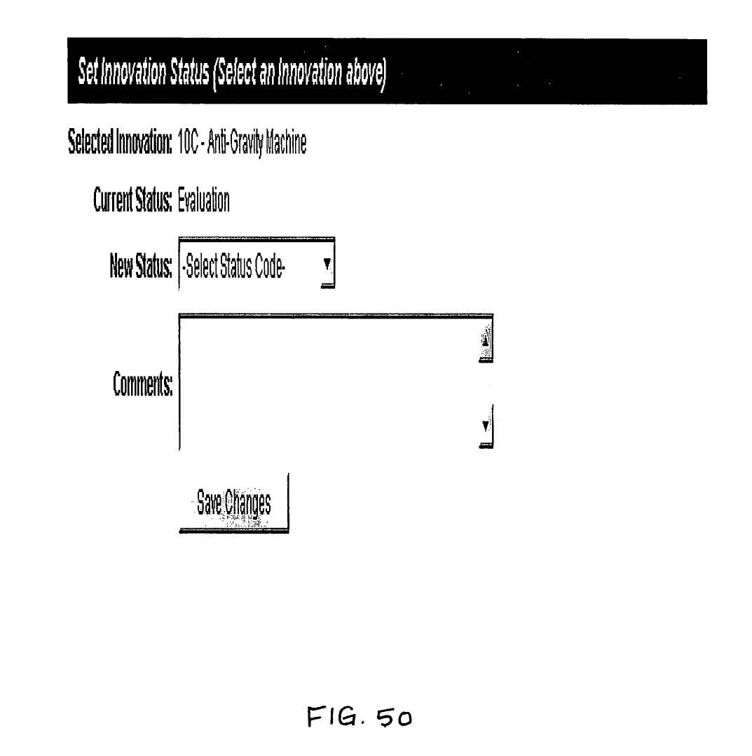

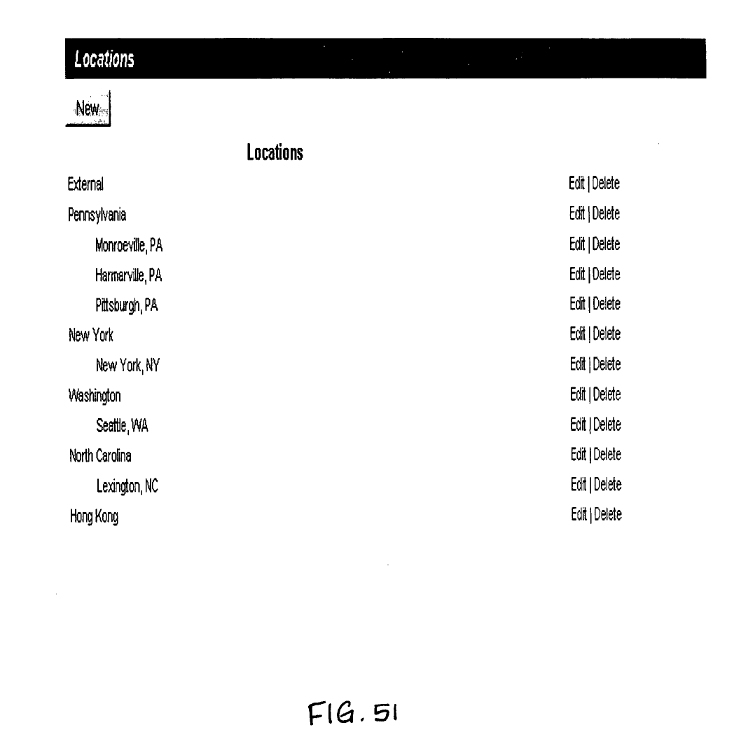

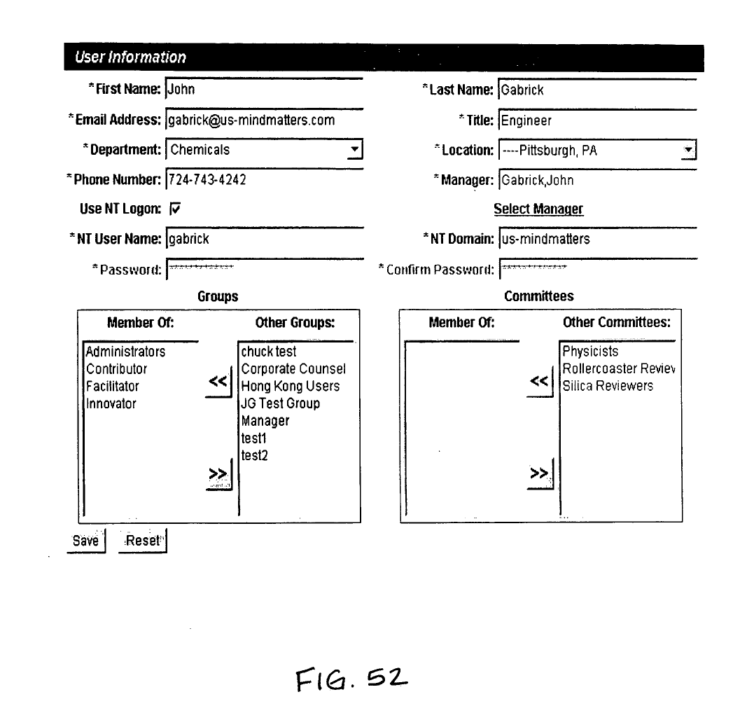

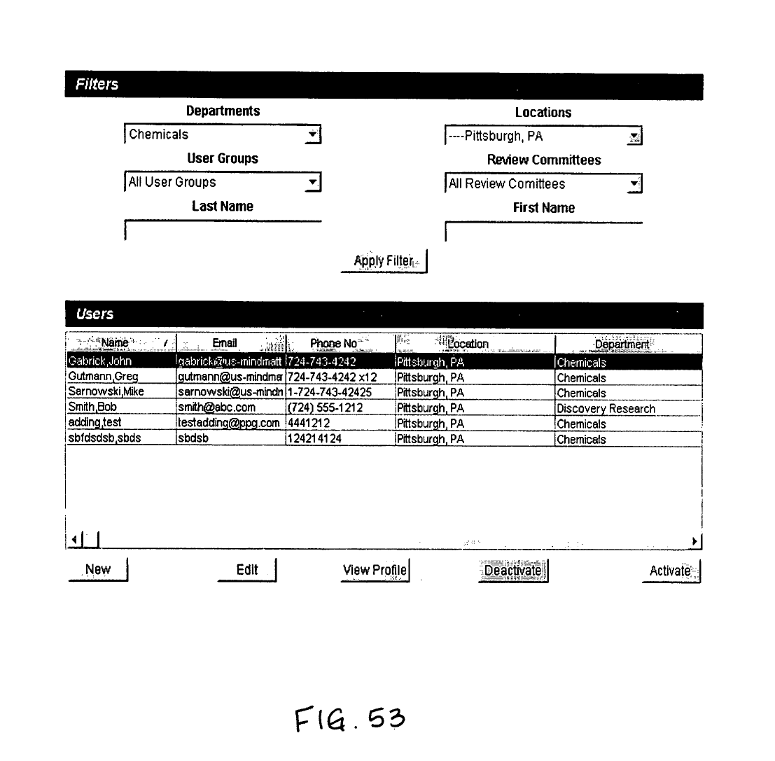

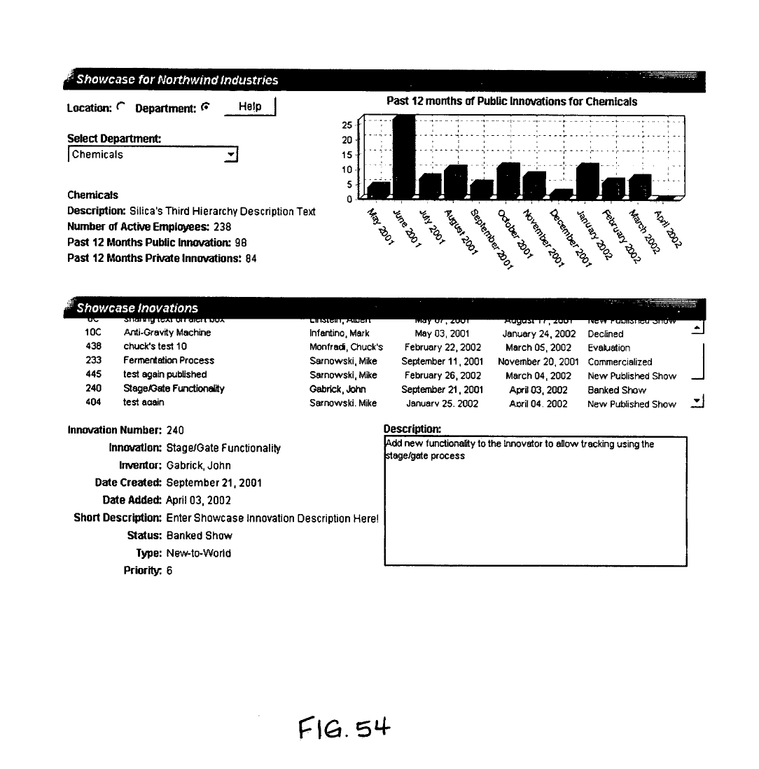

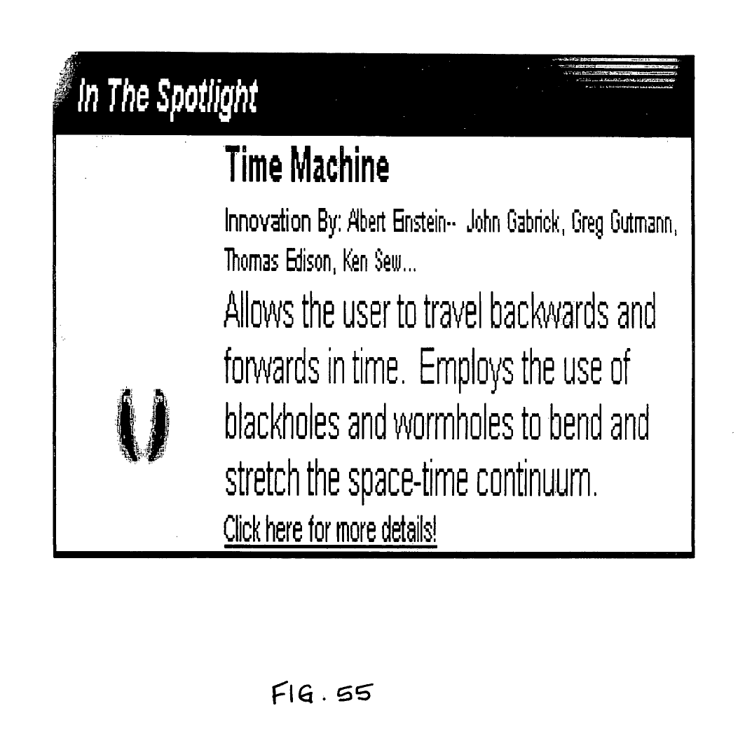

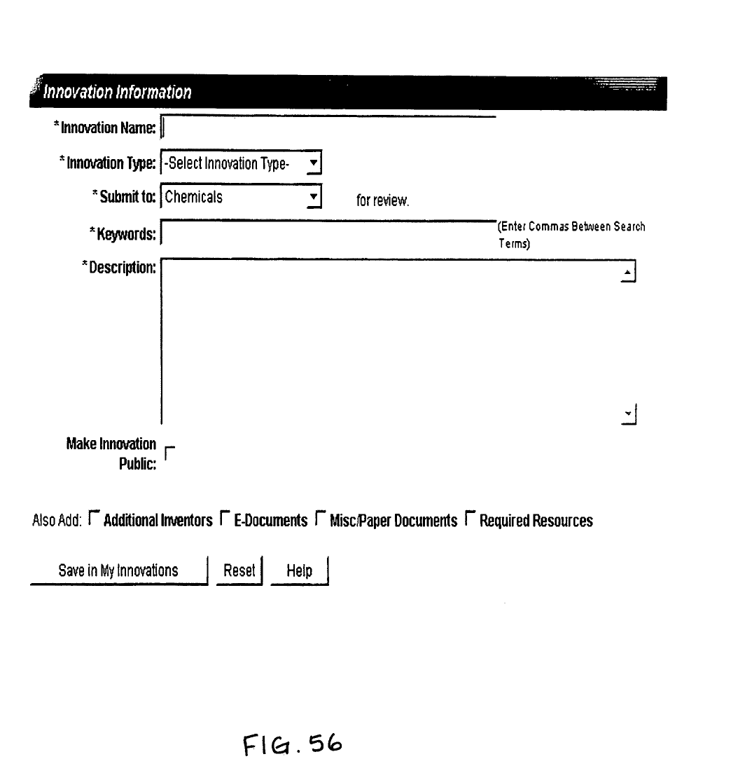

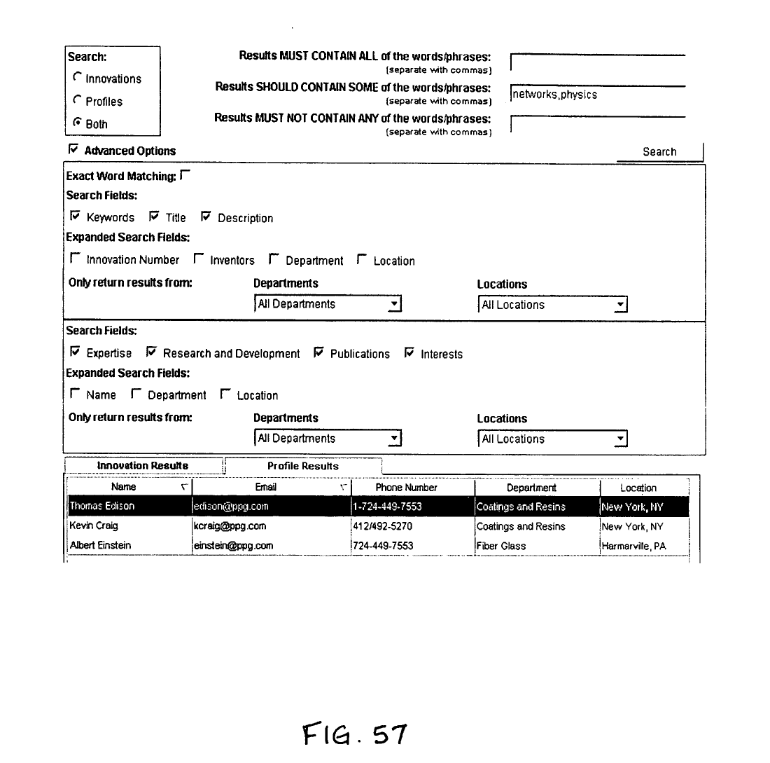

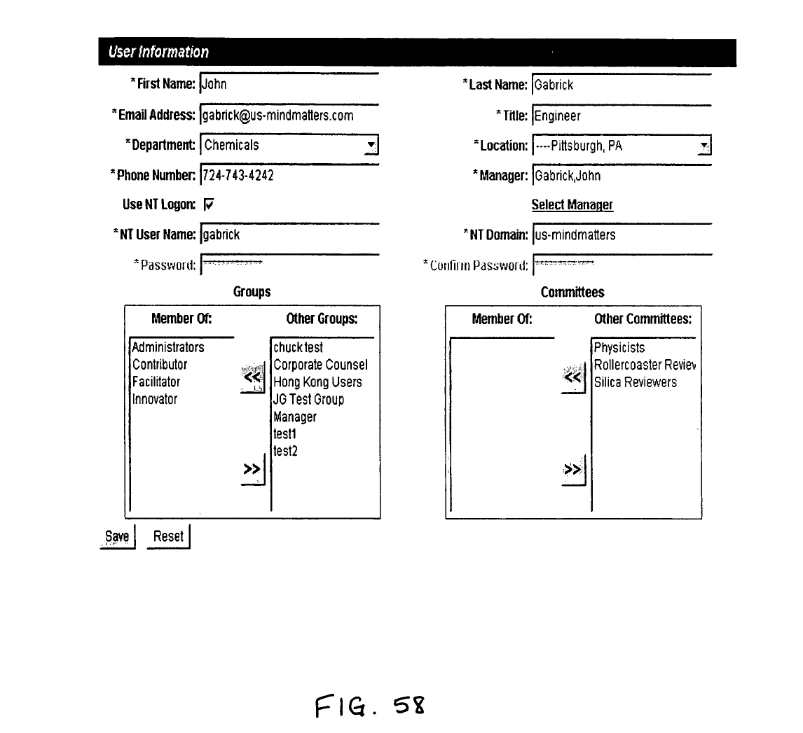

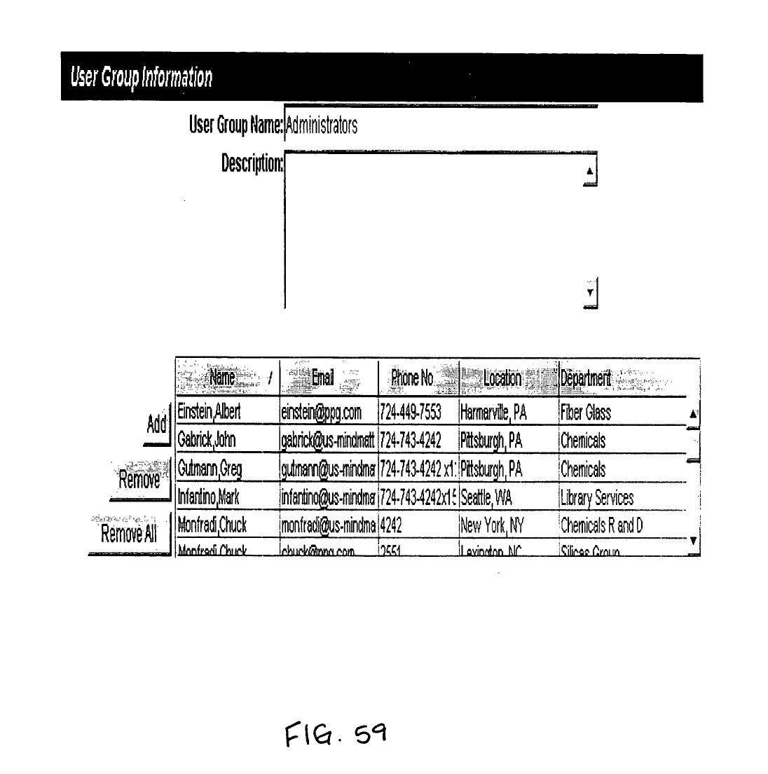

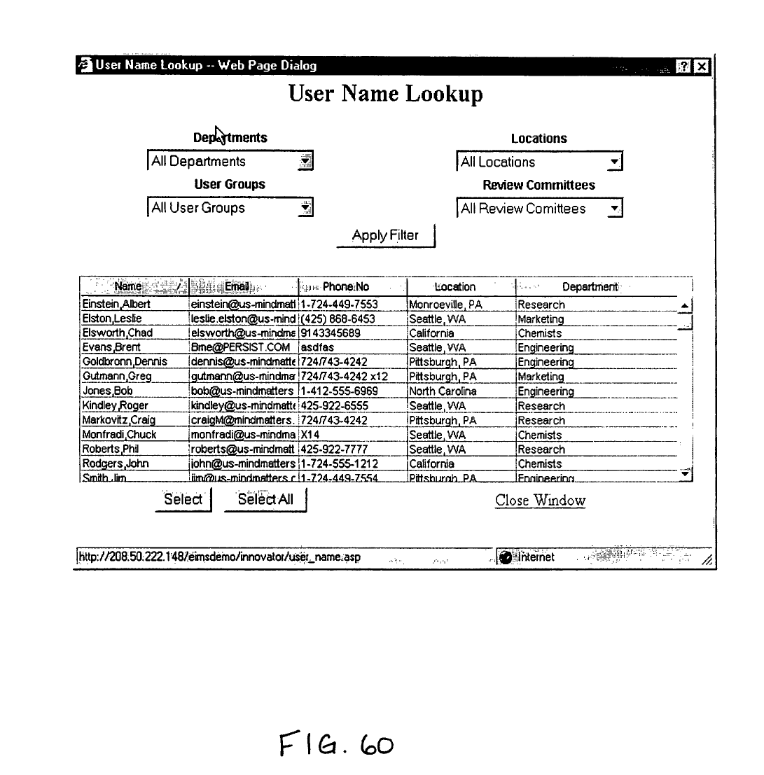

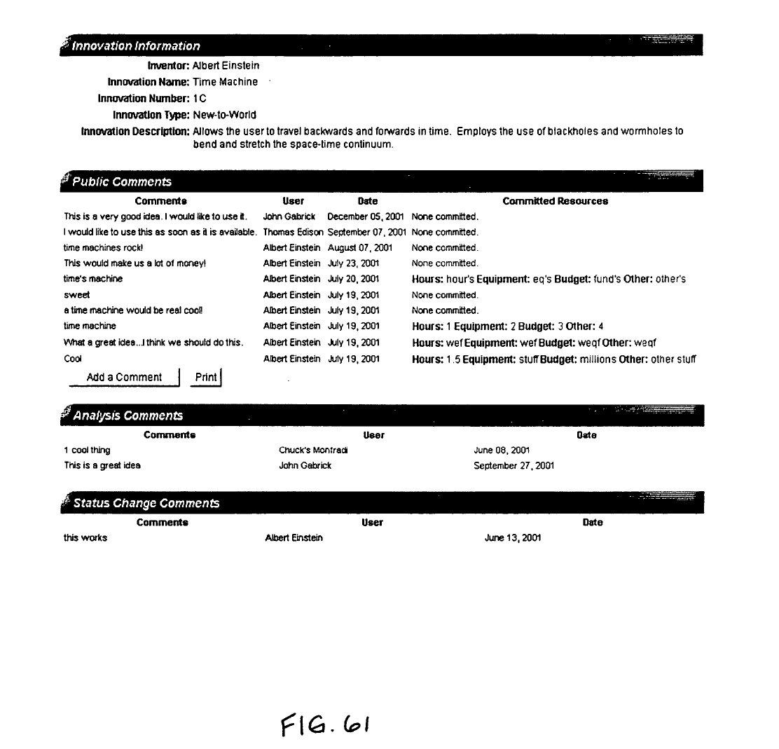

This application is a continuation-in-part of Ser. No. 09/709,900 filed Nov. 10, 2000; and also claims priority to Provisional Ser. No. 60/387,770 filed Jun. 10, 2002.

### TECHNICAL FIELD

The invention relates to knowledge management systems; more particularly it relates to systems for automating and managing an enterprise IP environment, with global communications network capabilities.

### BACKGROUND OF THE INVENTION

The significance of intellectual property (IP) is growing daily. More and more, corporations realize the importance of preserving and protecting these vital assets, and a select few even appreciate how to capitalize on them. However, the real underlying issue that has not been addressed, up until now, is that in today's digital enterprise there is a tremendous need for a reliable, real-time system for creating, preserving and building value from corporate IP assets. This model must be in synch with today's digital world and enterprise environment and operate on a continuous, real time basis. It must work transparently with the way in which employees work and innovate. It must be a useful productivity tool for IP attorneys and corporate counselors. And it must safeguard and protect the most valuable assets a company owns, its intellectual capital.

Many companies are only now recognizing the rise in significance of IP as a core asset. However, even with heightened awareness, most continue to operate in antiquated ways, relying on “defensive mechanisms,” such as legalistic paperwork and cumbersome procedures. These techniques are expensive, time-intensive, and inadequately suited for today's digital environment, since they fail to operate in real time.

Today, very few companies Use the potential of information technology to streamline processes, promote new innovation, and document and protect their assets. Often, their employees at just about every level are undereducated and unaware of the risks of inadvertent disclosure or competitive loss-setting the stage for future disputes and often leading to litigation, or even worse, the permanent loss of valuable trade secrets.

Most significantly, virtually all corporations underestimate the strategic value of their IP, and therefore, fail to capitalize on the full potential of it. And even while recognizing the growing significance of IP assets, there are essentially no companies that do an effective job at providing the knowledge-connectivity™ and incentive for new innovations.

In today's job market, employees are more mobile than ever before. Mergers, acquisitions, and downsizing are just a few of the reasons. The result is a constantly changing workforce, and the constant creation, disclosure, and turnover of corporate intellectual property. And whereas it is perfectly legal for a highly skilled employee to leave and go to work with a competitor, taking with him or her his own skills and experience, it is not lawful to leave with proprietary company information.

These trends of higher worker mobility and the increasing value of digital assets have converged to create a tremendous opportunity for a new solution. Companies certainly want to avoid additional litigation nightmares, when even a single trade secret dispute or patent infringement suit can cost well over $1 million in legal fees. Douglas Brotz, principle scientist at Adobe Systems, commenting on a patent infringement suit described how it had cost the company more than $4.5 million in legal fees and expenses alone, not to mention over 3,500 hours of his time—the equivalent of two, full years of working time. Most remarkably, this was a case that Adobe had won, initially and on appeal. Clearly, an effective means for mitigating the risk of a costly lawsuit would be of great benefit to many leading technology companies.

For the most part, individual employees don't want or intend to break trade secret laws, steal proprietary assets or misappropriate secret files. They just want to pursue the opportunities afforded to them in the free marketplace. In many cases, the core issue, the one that becomes highly volatile, is that it is nearly impossible to discern between company IP assets and individual skills and knowledge. Coupled with the fact that companies do a very poor job of identifying their IP assets in the first place—62% of companies have no procedures for reporting information loss. This tension becomes the catalyst for another wasteful lawsuit, pitting the company against ex-employee. The company, quite self-righteously, stakes a claim to a broad range of trade secrets; and the employee, defends by pleading that the information is in the public domain, or part of his general skills and knowledge. In another high profile suit that illustrates this growing problem, Motorola, Inc. sued Intel for hiring away a number of its key employees. An Intel spokesperson said the action was taken solely to protect Motorola's intellectual property, which it characterized as its “lifeblood.”

As a further example of the seriousness of this issue, in 1998 the American Society for Industrial Security (ASIS) reported that IP losses for U.S. companies might exceed $250 billion annually. Furthermore, five times more companies feel the issue of intellectual property loss is increasing. With the nation's competitiveness riding on our ability to maintain technological superiority, losing trade secrets can be devastating. What makes matters worse is that most companies don't know, nor have they taken action to find out what their specific trade secrets are, and whether or not they are legally protected. This only adds to the potential of a future lawsuit, since only a lengthy hearing of the facts can ultimately determine the “right and wrong.”

Slow, expensive and outmoded legal precautions, and time-consuming audits are not the answer in this day and age of rapid product development. To keep their competitive edge, and to promote innovation and capitalize on knowledge assets, there is a need for a new solution—an innovative way of managing IP property.

In the past, intellectual property was not as pressing an issue as it has now become. The connection between an idea and the creation of wealth was less direct, and the road from the one to the other was traveled at a more leisurely pace. By contrast, in today's information-intensive economy, that connection is immediate and intense. Knowledge is now the driving force behind innovation and the creation of new wealth.

Within many of today's companies, innovation fuels high market caps, not tangible assets as in the past. The trends of higher worker mobility and widespread litigation, coupled with the increasing value of digital assets have converged to create a tremendous opportunity for a new solution.

Need for an Innovation Management System

The preponderance of adjectives such as “monitoring,” “protection,” “litigation,” and “security” immediately conjures up images of “Big Brother.” And while proper oversight cannot and should not be ignored, this functionality in and of itself fails to address an even more important issue: How effectively do companies promote innovation? After all, if you accept the fact that IP is becoming more and more critical, then shouldn't companies treat it like their corporate lives depend upon it?

Most companies do very little to tap into the vast resources of knowledge that exist inside their own organizations. One Fortune 100 Company offers a $100 dinner-for-two award for new ideas submitted by email to the corporate counselor. That's not much of an incentive, when you consider the other options available to today's employees, especially those with an entrepreneurial drive, and the ready supply of venture capital that exists.

Many of these companies rely on a perceived underlying expectation that their employees will automatically produce new innovations, as if obligated merely by the fact that they receive a paycheck and benefits. And most companies employ legal covenants that dictate the assignment of new ideas to the company, if developed on company time, with company resources, or which relate to the company's business. That mind set may have worked a generation ago, but it doesn't meet today's needs, or work for today's dynamic job market. After all, who gets to decide where one idea starts and ends? Who owns an idea that may not have been reduced to practice by the employee while he worked for the company? Ownership issues can destroy the potential of a new concept before it gets off the blocks.

It just does not appear that legal pressure is the best way to promote the creation of new ideas. Nor does it appear that employees, particularly the most savvy ones, will naively turn over their best and brightest ideas without some reasonable incentive or recognition, especially as they become more aware of the potential value. Considering that the ideas that gave birth to over 70% of the country's 100 fastest growing companies came from previous employment, it is easy to appreciate the significance of this issue. Today, most companies fail to recognize this, and consequently, they wonder why some of their best talent leaves to pursue other opportunities—including business ideas that they originated while working for their previous employer.

A survey published in the Harvard Business Review reported that “71% of entrepreneurs responsible for starting the country's 100 fastest growing companies developed their ideas through their former employment—either by recognizing an opportunity that the former employer didn't appreciate or even know about, or by improving upon some aspect of the company's products or services.”

Overall, the existing corporate infrastructure and antiquated operating methods are poorly designed to deal with today's climate. In this fiercely competitive world just providing a job doesn't do nearly enough to promote innovation—the ultimate goal for progressive companies. What is needed is an Innovation Management System.

Existing Technology in the Knowledge Management Field

The Knowledge Management industry is quickly consuming the myriad fragmented and disparate niche industries that have evolved over the past two decades, including document management, search and retrieval, repositories, object technology, workflow, and most recently the intranet. According to Delphi Consulting Group, buying trends for IT will revolve around this central theme for the next decade.

The most significant aspect of this industry is the growing awareness of the increasing amount of useless data—in other words, no information—in a typical company. Strategically, companies are realizing that knowledge is the key driving force in the next decade, and systems which help manage documents, search, and aid collaboration are desperately needed. In one survey, nearly half (43%) of the survey population regarded knowledge management as an opportunity to add value to information inside and outside the organization. But nearly as many respondents (37%) viewed knowledge management in a very different light—as a “major new strategic initiative for staying competitive.” Overall, 80% view knowledge management as providing an important contribution to business practice, and 46% of that group views knowledge management as strategic.

The data however clearly show that while employees are the primary sources of information in the company, all of the current solutions have focused on the remaining items: paper documents, electronic documents, and databases.

The data also reveals that the biggest obstacle is culture. The current business climate simply does not address the needs and wants of the typical knowledge “goldcollar” worker. These employees typically don't trust the “system.” Highly skilled workers know they can leave the corporate environment and get better returns, higher salaries, stock options, and greater opportunities than by simply handing over important innovations. Employees are even heard to say “why should I give ABC company my ideas, I'm going to start my own company.”

Accounting and valuation begin with documentation. A company with an expensive piece of capital equipment is sure to be aware of it. But most companies have valuable intellectual capital that they do not fully recognize. Many technology companies, for example, with dozens, hundreds or thousands of patents do not have a coherent catalogue of their patents, let alone an analysis of how their patents might be useful and how they might be exploited for economic and competitive gain.

These trends don't just apply to a limited number of high technology companies. Even companies not directly involved in high tech must realize that a substantial portion of their overall assets relate to intellectual property or capital. For instance, a small manufacturer may possess unique mechanical know-how, process knowledge, or techniques that create competitive space. Service companies use proprietary calculations and customer lists to their advantage. The implications of managing IP reach just about every industry classification and category.

The following needs can be identified among companies that produce IP. They need to organize intellectual property so that it can be quickly retrieved, filtered, and sorted by multiple criteria; they need to create an environment conducive to innovation by inspiring IP creation, sharing IP across the corporation, and promoting the intellectual output of individuals within the firm; they need to increase the value of corporate IP assets; they need to slow employee turnover and keep key employees from moving outside the company to start new enterprises; they need to communicate to employees, joint venture partners, and others that it is serious about protecting it's IP, and want to be sure that these same people have acknowledged this; and they need efficient and centralized access to disparate IP-related information, such as legal contracts, signed documents, IP, and usage patterns for making decisions about departing personnel, potential patent infringement, or partnership negotiations.

A brief look at the trade secret laws in the context of a buyer of IP assets provides further illustration of the need for an Innovation Management System. Today, there is no effective way for companies to accomplish this level of analysis, cost-effectively and efficiently.

### DISCLOSURE OF THE INVENTION

A three-tiered, scalable, web-based architecture (“the system”) is disclosed to dynamically and cost-effectively promote innovation, foster learning, encourage preservation, and allow the management and maximization of corporate IP assets; a solution for automating and managing the modern-day enterprise IP environment. This system works efficiently within the legal parameters of any company environment, regardless of industry, and works in cooperation with In-house Counsel. With real-time access to key information, IP Counsel can focus on higher level, strategic issues, and not mundane documentation tasks.

A reliable, real-time system for creating, preserving and building value from corporate IP assets is disclosed. The system is in synch with today's digital world and enterprise environment and operates on a continuous, real time basis. It works transparently with the way in which employees work and innovate, it is a useful productivity tool for IP attorneys and corporate counselors, and it safeguards and protects the most valuable assets a company owns, its intellectual capital. It uses the potential of information technology to streamline processes, promote new innovation, and document and protect a company's assets. It does a very effective job of providing the Knowledge-connectivity™ and incentive for new innovations.

The system meets all of the needs identified above. Using the system, companies can organize intellectual property so that it can be quickly retrieved, filtered, and sorted by multiple criteria; create an environment conducive to innovation by inspiring IP creation, sharing IP across the corporation, and promoting the intellectual output of individuals within the firm; increase the value of corporate IP assets; slow employee turnover and motivate key employees from moving outside the company to start new enterprises; communicate to employees, joint venture partners, and others that they are serious about protecting their IP, with assurance that these same people have acknowledged this serious view; and achieve efficient and centralized access to disparate IP-related information, such as legal contracts, signed documents, IP, and usage patterns for making decisions about departing personnel, potential patent infringement, or partnership negotiations. With the system companies can accomplish a cost effective and efficient level of analysis as to their trade secrets or any other IP assets.

An Innovation Management System (IMS) is disclosed. This preferably web-based GUI encourages innovation, providing valuable benefits to both employees and employers. It allows employees to enter their intellectual creations (documents, ideas, schematics, etc.) and receive an immediate, time/date certification. In many instances, one of the greatest reservations employees have against providing ideas to upper management or other departments is the lack of control, authorship, and credit they associate with typical corporate environments. At one time or another, we have all been victims of intellectual theft-perhaps a design sketch given to your boss concerning a product improvement that appears months later in a corporate document without your name on it. In addition to certification and registration, the system can provide automatic e-mail notifications to an immediate supervisor and the corporate IP department (all configurable), as well as entry and logging into the company-wide recognition database. Others in your company, with appropriate privilege levels, can search (by key words, project descriptions, PTO classifications, author, date, etc.) and instantly access archived innovations, increasing the level of inter-company collaboration. The company can create more effective incentives and “innovation awards” tightly coupled to strategic goals.

Users of the IMS can link to more details on each submission, email comments and suggestions directly to the author (for improved collaboration and knowledge management), or even submit their own improvements as a new or supplemental innovation.

The IMS database becomes an efficient tool for HR departments, and can be used for evaluating employee performance, measuring overall corporate innovation levels, and identifying qualified and motivated employees to join a special R&D team.

The Corporate Legal Department will benefit because the IMS provides extensive documentation in a wide-range of beneficial areas. For instance, IP Counsel can monitor for new patentable ideas in real time, since they are directly linked into the system. This efficiency can reduce the time necessary to prepare and prosecute new patents. It also frees up Patent Attorneys to higher-level activities, instead of mundane data collection work. The IMS will enable attorneys to provide improved oversight for new trade secrets before they are lost through inadvertent disclosure. The system archives the documentation trail from the outset, invaluable for assignment issues and establishing firm priority dates.

IMS Web Site

The IMS also provides an interface to the external Internet (optional and configurable). Ideas and submissions can be published and linked to an external (i.e. MindMatters.com) web site. The site serves as an innovation access link to companies all over the world. It is possible for interested buyers and sellers to initiate exploratory communications via embedded links, as well as conduct negotiations on available licensable technologies. There is an appropriate legal framework to streamline the exchange of information for the site, assuming that at a certain level, the materials may contain proprietary information.

The site also provides an optimum way for companies to initially view “unsolicited ideas” without the threat of legal reprisal or the burden of lengthy, internal approval processes. Today, many companies are extremely cautious about looking at unsolicited ideas, even potentially valuable ones, because of the potential threat of future litigation. There have been a multitude of cases in recent years involving the purported misappropriation of inventions and ideas resulting from even casual discussions. In response, many companies have established cumbersome, paper-intensive procedures to deal with unsolicited ideas. Some have prohibited them altogether. Needless to say, this constricts the flow of innovation. The site solves this problem as well by building in a protective legal barrier and managing the information exchange. The site acts as a safe and efficient conduit between the parties.

The IMS identifies innovations by key words, categories, PTO Classifications, dates, industries (SIC Codes), and identification/tracking numbers. Interested parties search the web site for innovations applicable to their own businesses or use “search agents” which automatically notify them if something meets their criteria. If they find ideas that merit further investigation, clicking on an e-mail link automatically connects them to the author or representative. By aggregating innovations at the web site, we are actively promoting innovation and knowledge sharing on a broader scale, while simultaneously building a meaningful intellectual property resource. This site becomes the first link in establishing meaningful relationships for future licensing and royalty agreements.

A nominal fee is charged for creating the direct link between subscribers and new ideas. When a subscriber chooses to contact the source of the innovation, i.e., by email, a different small fee will be charged. This fee may be negligible in the early stages, in an attempt to drive usage and minimize nuisance requests (such as $0.33). A membership subscription is also contemplated. Other interaction, including submitting ideas, searching for ideas, or configuring “search agents” are free of charge.

Simple Installation

Today's MIS manager has less time than ever to fiddle with finicky programs or configure endless mazes of menus. The system is designed to plug quickly into the network and instantly begin collecting information in its basic configuration. The system simply needs to have an IP (xxx.xxx.xxx.xxx Internet Protocol) address for the network, and a physical connection to the network. IT managers can remotely configure the system via a web interface, and independent systems can be hierarchically managed, along with reporting, back to a central monitor. Communication takes places in encrypted channels. Installation of web components is even simpler as the applications/date are easily installed into an existing web server.

The system is a scalable, modular system that can be implemented incrementally over time. Network solutions are implemented and designed around standard Microsoft DNA components.

An important benchmark industry to compare disclosed products and services with is the field of Knowledge Management. As stated above, there is growing awareness of the increasing amount of useless data—in other words, no information—in a typical company.

Increasing the value of corporate information is important; however, rather than just designing tools to plod through piles of data, the system is an accounting framework that values (using legal standards as a model), helps protect, and most importantly creates information. But where the Knowledge Management industry has focused on only paper documents, electronic documents, and databases, not employees. The system focuses on all four elements, realizing that employees are the most critical, through the Innovation Management System (IMS). IMS makes itself the employee's “best friend,” as this is the key starting point in the innovation process. If employees trust and use the IMS to help them accomplish their personal goals (while simultaneously satisfying the corporate goals), then the flow of new innovations will be substantial.

The data also reveals that the biggest obstacle is culture. The system addresses the needs and wants of the typical knowledge “gold-collar” worker. The IMS overcomes the cultural disinclination of such workers by allowing innovators to share in the glory and financial success of their ideas. The System will also set the bar for what is required for companies to prove that they did in fact take reasonable measures to protect their assets.

The system is designed to provide an appropriate interface to previous systems that attempt to meet customer needs, such as patent/IP software, and knowledge management software.

The disclosed system is a comprehensive, supervisory system that functions seamlessly on top of existing architectures, and which efficiently monitors and promotes innovation. Innovation is the core focus. The system is unique in that it is designed from the bottom up to be extremely easy to install and integrate with existing systems. Administrators will be able to install it incrementally in a modular fashion, as the needs and demands of the system grow over time. IP and Innovation managers will be able to progressively configure the system for customized applications, producing additional revenue streams from added licenses and services.

The disclosed system is superior to existing knowledge management consulting approaches, with or without Web enablement, at least in the critical area of IP tracking and management. The innovation content that a company provides under the disclosed system offers a much more compelling site to its users, both company users and the internet population. For example the system includes not only a web-trading interface, but also a mechanism for capturing innovation directly from the sources, transferring it through the organization, and protecting it from inadvertent loss. One of the key factors for success will be making it easy for participants in the web experience to upload information on a continuous basis. This keeps the information fresh and frees corporations from the laborious task of entering data repeatedly.

It is a further objective of the Enterprise Innovation Management System (EIMS) to provide a system that promotes and tracks innovations, fosters learning about intellectual assets, encourages preservation of intellectual assets, and monitors and tracks these assets from inception through analysis/ranking and licensing until the asset is retired or completely depreciated. A global environmental model for the EIMS is presented

The term “Innovation” is used to represent any contribution by an individual or team that seeks to positively enhance some product/process/system within an organization. The term “Idea” is sometimes used interchangeably with Innovation.

The EIMS (or System) consists of four independent applications that function together in an enterprise-wide solution. Together the System streamlines the process of fostering idea creation, educating and rewarding employees who create valuable intellectual property (IP), analyzing and prioritizing IP according to company-defined rating factors, sharing information both externally (if desired) and internally to facilitate licensing and increased productivity, and preserving and protecting proprietary assets.

A. Innovation Management System™

The ETMS is a web-based GUT that encourages innovation, providing valuable benefits to both employees and employers. It allows employees to enter their intellectual creations (documents, ideas, schematics, etc.) and receive an immediate, time/date certification to discourage “borrowing” by unethical employees. In addition to certification and registration, the System can provide automatic e-mail notifications to an immediate supervisor and the corporate IP department (all configurable), as well as entry and logging into the company-wide intranet. Others in a user company, with appropriate privilege levels, can search (by key words, project descriptions, PTO classifications, author, date, etc.) and instantly access archived innovations, increasing the level of inter-company collaboration. The company can create more effective incentives and “innovation awards” tightly coupled to strategic goals.

B. Analysis/Ranking Module

This set of tools allows peer groups, IP counsel, or other trusted sources to rank and prioritize innovations that are entered (either through the Innovator or manually) into the system. The power of these tools is highlighted in their ability to quantify both objective and subjective measurement criteria. The rankings are aggregated and weighed relative to the company's strategic objectives, that is, a company can decide that financial factors such as development expense or ROT are more/less important than customer-relationship factors such as new product introductions or quality. Once ranked, innovations can then be compared against each other and scientific judgments can be made regarding level of investment.

C. Licensing Web Site & Intra-Organization Sharing

The System also provides an interface to both the corporate intranet and/or external Internet (optional and configurable). Tools provided through this application allow the company to quickly publish innovations that the company either does not want or would like to co-license to other companies. In addition, ideas and submissions can be published and linked to the MMT web site. The MMT site serves as an innovation access link to companies all over the world. There are numerous benefits, including the potential to create licensing agreements, streamline product development, find strategic partners, etc. MMT also explores full scale licensing opportunities, i.e., business-to-business eCommerce, via the website. It is possible for interested buyers and sellers to initiate exploratory communications via embedded links, as well as conduct negotiations on available licensable technologies. MMT creates the appropriate legal framework to streamline the exchange of information, assuming that at a certain level, the materials may contain proprietary information.

D. Network Monitoring & Protection System (NMPS)

NMPS identifies, classifies, compiles, tracks and routes real-time data automatically on a continuous basis. It provides instant access to stored database information, such as trade secret archives, patent filings, computed valuations, user information and a variety of detailed reports. A client has instant access to their latest innovations and proprietary materials, and constant supervision over them as the monitoring process can start as soon as the ideas are submitted into the System through the Innovator. They know precisely the status of their property, and can quickly view summary reports and valuation data. This information is extremely beneficial in linking IP to the company's strategic objectives.

You instantly know who has accessed your key IP files, and who has downloaded them, viewed or copied them. This level of data acquisition can be invaluable in the case of employee ownership disputes, determining level of disclosure, or commercial licensing negotiations. And even more importantly, all of this data is essential to proving that your company took the necessary preventative precautions to protect the secrecy of your trade secrets-invaluable in the face of future litigation.

Scope

The EIMS preferably has external interfaces to other third-party software and services. These may include any of the following:

Independent Market Makers: These are services/companies that take finished, licensable intellectual property, i.e., software for license, patents, technologies, and make them available to either general or specific groups of potential customers. They require detailed information about the property for sale and provide leads from interested parties to the EIMS.

Time/Date Authority: This service provides a legal time and date stamp for submitted intellectual property. The certificate is capable of withstanding legal scrutiny and is stored with the idea's descriptive information in the EIMS.

Marketing Leads Databases: Based on the potential applications of the property and the technologies employed, these services provide qualified leads for marketing back into the EIMS. Many of these services are based on industry segments.

Independent Search Agents: This service is composed of two different components: MMT services and independent services. The MMT services provides specific competitive information to MMT users based on search criteria for a particular idea. Independent services scan the Internet or other proprietary databases for relevant information. In both cases, the EIMS sends search criteria, verifies access and then returns results back to the user for review.

Docket System: This is an interface to a docket management system for patents, trademarks, copyrights and other property. Once an idea is determined to be patentable, the docket system handles all of the legal, date, and filing requirements. The EIMS sends the packet of information to the docket system and the docket system communicates with the EIMS via status reports. These status reports are available to be shown to the users.

Third Party Analysis Reviewer: This is an interface to a trusted third-party for the purposes of soliciting feedback on a particular idea. The reviewer has basic information about the idea and provides feedback in the areas designated by the EIMS. The EIMS verifies that the information came from the correct source and then collects and aggregates the data.

An apparatus is disclosed for registering access to data (paper, electronic, formulae, etc) recorded on storage media as a means to determine history of use whereby a Client/User requests data from a server, the server wraps it with a protection agent and sends it to a Client/User. The protection agent is attached to the specific data (paper, electronic, formulae, etc.) which determines the degree of use allowed by user (reading, deleting, modifying, printing, etc), and is based on type of data, file type, date/time, location, etc., and also on user level, group, etc., and optionally on pre-determined method for establishing rules used to register access to data recorded on storage media. The server records access to the data, and managers get reports that detail accesses to the data.

An apparatus is disclosed for registering access to data (paper, electronic, formulae, etc) recorded on storage media as a means to determine history of use where registration means the recording of file block system read/writes/updates, recording file name read/writes/updates, or the recording of physical data segment read/writes/updates.

An apparatus is disclosed for wrapping designated trade secret(s) with rules for access into an binary form executable only by the intended recipient(s).

A method is disclosed for determining the relative protection level of an entity's intellectual property (trade secrets, patents, trademarks, copyrights) using Spider graph and associated questions, etc. A method of pair-wise comparison is used for determining relative priority of key factors (accountability, awareness, secrecy, and security), and also using benchmark comparisons against the data entity.

An intelligent IP Accumulator/Agent Monitoring System is disclosed having methodology for searching, finding, identifying, wrapping, safeguarding, classifying/declassifying, shredding and deleting, and encrypting potential IP assets on a continuous, real time basis. This system charts IP assets from origination onward.

Other Embodiments Disclosed are:

Auto-protect Assets: Methods for automatically generating an appropriate class of confidentiality marking/wrapper based on preset configuration parameters. Selfgenerate internal icon set to coincide with protection level. S/W agents that autoreport and track key assets.

MMT System-level functionality: Defines specifically what data is considered secret; the relative class of the secrets; the software protection methods utilized to actively protect (i.e. encryption), and the imputed value of creating the secrets (based upon accumulated man-hours, market studies, projected earnings, etc.)

IP Event Trigger: Based upon preset parameters, the system automatically monitors for specific behavior on the network that indicates a possible IP event. Ex: large data transfers or downloads. Increase in access rates of identified TS's. Extensive access beyond/outside pertinent class. Time-based events: employee departures; audits, etc.

IP Database: Methodology for collecting specific IP data on a unique server, updated periodically or continuously based upon preset parameters; with the capability to request status inputs from individual IP wrappers or objects.

IP Audit/Due Diligence: Computer methodology for triggering an instantaneous IP audit-dynamic update on all priority IP assets. Accumulate most current asset information, usage, risk exposure, licensing status, etc. (Departing employee situation). Generate reports based on access, usage, class, employee, type, etc.

IP Incentive: Automated methodology for promoting and tracking innovation based upon pre-selected configuration parameters. (See IMS)

IP Access: Methodology for tracking the usage/distribution of IP assets. Relate to risk exposure and safeguarding proprietary information policies. Auto-generate warnings prior to use of trade secrets.

In addition the following are also claimed:

An online registration ‘engine’ for ideas, innovations where the engine comprises one or more computer terminals with access to a storage device and connected to at least on other terminal by a networking protocol, either Internet TCP/IP or local or wide area network. The engine also comprises a database resident on the storage device with software operable to receive into the database details of the idea and details identifying the submitting user, and creating a relationship therebetween that together comprise the registration. A certified time stamp is optionally applied to the registration. The idea registration is then made available, according to selectable permissions and rules, to selected other users on the network.

Optionally, the same or different storage device accommodates a database for documents relating to the registered ideas etc (where documents can be anything stored electronically and/or digitally), and the database is the same as the idea registration database or is a different but operably connected database that provides an associative, recallable, and searchable relationship between the registration and any document that refers to it or is developed from it.

Optionally, a tracking engine is provided for the does to track them and record access to them and improvements to them and derivatives from them, the engine also recording such ‘set’ relationships among the various does as may be generated by common denominators such as identity of author or other major contributor, same or similar or related idea, keywords, and the like.

Also provided is an intelligent means to drive routing of does and ideas to colleagues, selected peers, and selected or selectably automatically identified experts in the same area as the idea, for evaluation and/or analysis of docs and their ideas and for possible mutual collaboration. Optional automatic valuation and business prioritization of ideas is contemplated as well.

Optionally, means is provided by which parties made aware of the idea and or docs and any resource needs expressly contained therein may respond with commitments toward meeting all or part of the expressed resource needs, optionally joining in the enterprise which is the furtherance of the idea.

As an alternate and further disclosure the following is provided:

A system for web based development and exploitation of IP, with an innovator attraction module, a developer attraction module, a registration module, and a match module is disclosed. The registration module is adapted to accept and store dated related to an innovator and the innovator's innovation in an innovation database, and the match module is adapted to match a registered innovation and innovator with a developer having stated requirements and resources for development.

A method of web based development and exploitation of IP with the following steps is disclosed:

a. attracting a plurality of innovators, each having at least one innovation;

b. attracting at least one developer, the developer having stated requirements and verifiable resources for development of IP;

c. registering innovation data related to an innovation in a database on a storage medium connected to an information network;

d. registering developer data related to the developer's stated requirements and verifiable resources for development of IP in a database on a storage medium connected to the information network;

e. making innovation data available to a developer and developer data available to at least one innovator.

A number of different kinds of users are contemplated for the system and methods disclosed. Users may be innovators or developers; users may also belong to the general public, or specific demographic segment of the public such as youth under 18, or seniors over 55.

In preferred embodiments of the invention a web site is contemplated for housing the user interface aspects of the modules disclosed as part of the system, and for effecting the steps of the disclosed methods. This web site, or a plurality of such sites, are anticipated to be owned and/or operated by a variety of interested parties. For example a company develops such a site to foster and encourage and track and reward innovation amongst its own employees and contractors; or an industry segment jointly effects such a site to encourage innovation within the segment; or a public body such as local, state or federal government, or agencies or departments of such bodies, or institutions of such bodies (libraries and universities) effects an innovation site such as that disclosed. Special interest groups such as environmentalists, global health or ecological concerns, or more local community concerns will also sponsor or operate such sites. Any given site may be an intranet and relatively closed to access by general public users; or it may be an extranet, or it may be fully open to the entire internet, or anywhere in between, limited only by its owners to effectuate its particular purposes.

Innovators can be attracted to such a site for a number of reasons and in a number of ways. Some desire to be validated in an evaluation and/or reward process; others wish to learn more about their craft of innovation and about how to more effectively and profitably exploit the fruits of their creativity; still others wish to see and perhaps compare their innovations with the innovations of others, and all come to be encouraged. The preferred site offers evaluation, prize and other financial reward opportunities, invited professional expertise in innovation and exploitation skills and resources, a database of other innovations, categorized into industries and fields of creative endeavor, and the like, and by keyword, and such other indicia as will be appreciated by those skilled in the art. But especially, the preferred site offers encouragement to all users who visit.

Developers (which is to say all those individuals and companies that bring commitment and resources to the task of perfecting, marketing and otherwise exploiting IP to mutual profit and global benefit) can also be attracted to such a site for a number of reasons and in a number of ways. Some will be attracted to a pool of raw innovation (‘raw’ in the sense that, depending on the origin and sponsorship of the particular site of course, most innovators will typically not be pre-tied to a research institution or corporate research apparatus—except in sites run by just such organizations, but as to those innovators, they are typically not pre-tied to any outside interests); others to the intrinsic and extrinsic of sponsorship, desiring to build goodwill in the community, especially in Community Corner and Kids Corner type sites or subsites, as well as to the more tangible benefits of branding and brand identification to the innovator pool and other users and visitors to the site; others will be attracted by the opportunity to run infomercial and other marketing on the site, and still others will be eager to have a finger on a grass roots technology pulse.

The preferred site offers the pool of raw innovation and eager innovators; it provides a variety of opportunities for highly visible sponsorship, from banner ads to contest prizes; it provides a platform for infomercialization that is a true win/win by educating users as it also markets to them; and the pulse of innovation available by searches of the site database will provide valuable background to other data more usually watched by technology development executives.

The site provides a ready vehicle and means to get ideas registered and transformed into searchable and trackable data. Ideas and innovations and their related data can preferably be tracked both before and after any match ups with developers, and innovation data updates and developer resources and match outcome updates can be tracked as well. All innovator users have the option of specifying levels of permission for the dissemination and/or sharing of their innovation data. Recurrent innovator input is encouraged, as is recurrent follow up by developers with their innovator prospects, generating in preferred embodiments a kind of interactive and iterative feedback between the develop and innovator, all to the positive in further developing the innovation and bringing it to successful exploitation. This extra- or post-match interaction is preferably tracked as well, and all data tracked is preferably stored in a database for retrieval and analysis.

Throughout the disclosure, where single databases are referred to, or multiple or connected databases are referred to, it is intended that each shall optionally have the meaning of the other, so that one database may be the equivalent of several others and a network of databases may be the equivalent, for disclosure purposes, of a single database. All matches referred to in the disclosure may be understood to refer to one to one matches, or one to many, or many to one, or many to many, as makes best sense in any particular embodiment.

### BRIEF DESCRIPTION OF THE DRAWINGS

The following 61 figures are appended to this application, in the following order, as sometimes referred to herein.

1. activity_log.bmp

2. add_comment.bmp

3. all_public_innovations.bmp

4. allcomments.bmp

5. alllnnovations.bmp

6. analysis_results.bmp

7. chgDept.bmp

8. collab_agent_advanced.bmp

9. collab_agent_edit.bmp

10. collab_agent_list.bmp

11. emailConfig.bmp

12. findexperts.bmp

13. Flow.bmp

14. forward_multiple.bmp

15. forward_to_users.bmp

16. IMG00131.bmp

17. IMG00135.bmp

18. IMG00136.bmp

19. IMG00148.bmp

20. IMG00149.bmp

21. IMG00150.bmp

22. innovation_details.bmp

23. innovation_highlights.bmp

24. InnovationProtection_edit.bmp

25. InnovationProtection_list.bmp

26. innovator_notices.bmp

27. InnProtectEdit.bmp

28. inventors.bmp

29. menu.bmp

30. multipart.bmp

31. myjnnovations.bmp

32. my_profile_boxes.bmp

33. perform_analysis.bmp

34. personal_stats.bmp

35. profile.bmp

36. Questionset_factor.bmp

37. Questionset_list.bmp

38. Questionset_question.bmp

39. required_resources.bmp

40. review_committee_edit.bmp

41. review_committee_list.bmp

42. review_request.bmp

43. search_agent.bmp

44. search_results.bmp

45. Security_config.bmp

46. security_overview.bmp

47. set_challenges.bmp

48. set_showcase.bmp

49. set_spotlight.bmp

50. set_status.bmp

51. setup_locations.bmp

52. setup_users_details.bmp

53. setup_users_list.bmp

54. showcase.bmp

55. spotlight.bmp

56. submit.bmp

57. top_search_results.bmp

58. user_group_details.bmp

59. user_group_edit.bmp

60. user_name_lookup.bmp

61. view_comments.bmp

### BEST MODE OF CARRYING OUT THE INVENTION

A. Innovation Management System (IMS)

A.1. Innovation Quick Overview: This subsystem is the primary idea input system for the end-user. The main purpose is for the end-user to enter ideas into the system so that they can be “recorded” for other purposes. As an idea is entered, the date/time is automatically entered as well, and the user has the comfort of knowing that his/her idea has been officially recorded. Along with recording the actual idea (via spreadsheet, word processor document, etc), the user also enters pertinent information such as key words, descriptions, supporting references, pictures, department number, employee id, protection level, other authors, etc. Users are also able to search through previously recorded ideas (theirs or other peoples') before submitting an idea to see if their innovation is unique, or view the number of times other people have viewed their submissions. Users are also able to view educational news stories concerning corporate IP (or other configurable source; this is configured by the user).

A.1.1. Configuration: This allows the Innovator to be customized by the user. The user can pick colors, skins, and java applets to personalize their space. Configuration also occurs dynamically, i.e., the user can change the placement of various tables and graphs.

A.2. Innovation Submission: This is the main submission functionality. It includes methods for attaching documents, entering ancillary data (dept. number, key words, etc.), the amount of time spent generating the idea, and references. After an idea is submitted, an e-mail message is automatically sent to the user (as verification) and to the user's immediately supervisor. The system can be configured to send e-mail messages (or hard copy printouts) to any number of peers, groups, or managers. E-mail verification is an important step in the trade secret process. By sending an e-mail to the manager and/or IP department, a determination can be made as to whether the innovation is to be classified as a trade secret or patent protected, or whether it should be deleted. The user is notified of any change in status via e-mail so that any discrepancies can be challenged. Ideas that are successfully submitted are available for viewing in the user's file cabinet.

A.2.1. Paper-Based Submission: For ideas that may need to have paper-based documents submitted, this functionality addresses the situation. The user makes a notation in the system, i.e., title, date of the paper document, then the system generates a unique barcode to affix to the document for tracking. From them on, the document is associated with the idea and is tracked by barcode.

A.2.2. Collaborative Document Submission: This duplicates the functionality of an innovation submission, but allows the user to submit “other documents” that might be useful for collaboration or sharing. The idea is that the more people are willing to share (if they get credit), the better off is the organization.

A.3. Innovation Tracking: This records the date, number of times an idea is accessed and downloaded, and by whom it is accessed (including external viewing on via an unprotected location, see C. 1). Data stored in other databases is managed via the FMS. As ideas are viewed, the AMS in conjunction with the FMS determine the level of protection afforded, i.e., encryption, visual warning, etc. This function also records the results of key word searches as described in the D3.3 and D3.4.

A.4. Innovation Searching: This function allows users to search the idea database for similar innovations or authors with similar ideas for collaboration. Searching can be based on key words, authors, dates, abstracts, or descriptive classifications. An important element of this search mechanism is that it allows searching in the internal corporate network (LAN/Intranet) as well as through external sources. Internal searches are augmented by searching network servers and repositories as well as through interfaces to document management/knowledge management systems. Internal results return the relevant matches as well as the person/team responsible for the match. External searches can be handled in two different ways, either directly by the innovator system through the company's network or via an external source, such as MindMatters. The importance is that a third party can perform a search without disclosing the identity of the entity requesting the information, this is particularly important when competitive searches are made.

A.5. Innovation Statistics: This function allows the user to view statistics on any ideas in the database. Statistics include: author, key words, date submitted, number of times viewed, number of contributions by the author, and viewing rank (the higher the number of times other people viewed the idea, the higher the ranking). If the idea has been submitted for peer review or the status of a review are also possible to see. If the company has an award program, statistics on this are shown as well. For example, if the a particular idea won “best new computer software”, then this accolade is shown.

A.5.1. Personal Statistics: This function allows the user to see his/her personal innovation statistics. This includes: personal home page hits, file cabinet hits, citations, downloads, collaboration agent hits, submissions, analyses performed, NDA citations, patents, Internet publications, licenses, and accepted submissions among other things.

A.6. Innovation Reporting: This function presents all of the ideas in a summary manner. Managers are able to view the number of ideas submitted per individual, department, or division; the frequency of ideas submitted by day, week, month, etc.; the types of ideas by key word, area, etc.

A.7. Publish Biographical Information: Generates an automatic home page based on previously entered data, network user information, file cabinet data, and user input.

A.8. Relationship Manager: This is a mechanism for increasing person-to-person communication and networking within large networks, i.e., corporate, Internet, intranet. With a large number of people in a network (physical or electronic), it can be very difficult to locate people within the network who others can collaborate with in various development and marketing initiatives. When locating others within a particular network, a person may be trying to find complementary skills/experiences or similar skills/experiences. For example, in some large corporations, it is nearly impossible to locate all of the pockets of work associated with Java, pervasive computing, or semiconductor research. Although many of these environments have various internal stratifications, countless organization charts, re-organization efforts, and databases, the most common method employed is word-of-mouth or random hitand-miss calls using one of the aforementioned information sources. Most of the titles and job responsibilities are either out-of-date or meaningless. There are several observations of the current situation:

People “network connectivity” is based on seniority in the corporate environment and on submission of data to search portals, not skill, capability, or interest.

Organizational turnover creates people-network gaps.

Duplicated effort results from uncoordinated pockets of activity, such as sales people from different departments talking to the same customer.

Lost productivity spent meeting with the wrong people, a critical misstep since today's marketplace demands increasingly faster speed of execution.

There is no “trust” factor. It is difficult to assess whether a person is credible, honest, or representing themselves properly, particularly on the Internet, but also to some extent in corporate environments.

People need a motivating mechanism in order to keep personal data updated

A.8.1. Collaboration: This function allows the user to submit new collaborative agents, check on the status of “hits” to his/her file cabinet, and check on the status of “hits” to his/her home page. It is important to note that this collects metrics that are used to determine the “value” of an idea. For example, if a particular person's innovation has received many “hits” from other users, then that is a good indication that the innovation has created value for the company.

A.8.2. Agent: Users can enter search agents into the system. Each agent, which can be terms that are either related or unrelated to the user's innovations, scans the systems new submissions and home pages for key words. If located results are posted for later viewing. The agent searches both current and archived innovations, document management systems and home pages.

8.2.1. Automatic: This function builds a relationship profile based on the user's department, title, and file cabinet. This is supplemented by the user and available to the search engine.

8.2.2. Custom: This function allows the user to build their own profile. It includes fields of interest, title, department, research areas, etc.

A.8.3. Home Page Hits: This tells the user what other agents have found his/her home page as a source. So, if another user's agent finds my home page, then I am notified for follow-up as well.

A.8.4. File Cabinet Hits: Similar to above. If another agent finds used my file cabinet submission as a source, then I am notified.

A.9. NDA Tracker: This module allows the user to enter and track NDAs. Users enter time/date, attendees, document number, and company name as well as any IP that was disclosed. The system can generate an automatic NDA if necessary. These NDAs are linked back to existing IP.

B. Analysis/Ranking Module

This set of tools allows peer groups, IP counsel, or other trusted sources to rank and prioritize innovations that are entered (either through the Innovator or manually) into the system. The power of these tools is highlighted in their ability to quantify both objective and subjective measurement criteria. The rankings are aggregated and weighed relative to the company's strategic objectives, that is, a company can decide that financial factors such as development expense or ROI are more/less important than customer-relationship factors such as new product introductions or quality. Once ranked, innovations can then be compared against each other and scientific judgments can be made regarding level of investment.

B.1. Collaboration: This functionality allows external/internal users to be automatically notified that they need to add their analysis of a particular idea. Notification can be automatically configured based on users' preferences, i.e., if I am an expert on neural networks, then I get notified automatically should any ideas in this topic area become available. Optionally, notification can be manual, where a link is sent to the desire person. The link is active and allows them to instantly access the analysis/ranking functions for that particular innovation.

B.2. Innovation Rating/Analysis: This functionality allows for the rating and prioritization of ideas/innovations in addition to files. This functionality includes entering idea descriptive information, rating the ideas according to the method defined below, and comparing the ratings of all ideas to determine the best places to make investments. As part of the analysis process, analysis requests are sent to independent people for valuation.

B.2.1. Rating

2.1.1. Rating Factors: this allows the user to enter the rating factor categories. After all categories are entered, the user can determine the relative importance of each factor with respect to goals, costs, or benefits, etc. The relative importance is determined by using the pair-wise comparison technique. Different importance ratings can be saved, for example, one set of ratings might be used for healthcare ideas/innovations whereas another might be used for semiconductor innovations.

2.1.2. Rating Factors Variables: For each rating factor category, multiple questions/variables can be entered for evaluation. For example, for a rating factor of technical merit, the variables might be 1) difficulty to reproduce and 2) cost to reproduce. Variables are structured such that a numerical value can be entered or that a numerical value can be inferred, i.e., 1=bad, 10=good, or little=1 and large=10. Initially, these variables each receive equal weight, however, functionality to rate the relative importance of each of these variables is optionally contemplated.

2.1.3. Calculate Index: Based on the ratings of the individual variables, the index is calculated as follows: sum each category on a base of 100, then multiple that answer by the rating factor relative importance.

2.1.4. Comparative Analysis: In addition to rating innovations by absolute factors, they can also be ranked comparatively. In this manner, innovations are ranked relative to other user-selected innovations, i.e., Idea A versus Idea B. Even though ideas are ranked relatively, they are stilled assigned a numerical score based on the difference between the two ideas. In this case, a score of 5, for any particular factor indicates no difference between Idea A and Idea B, a score of 1 ranks Idea B much worse compared to Idea A, and a score of 10 indicates that Idea B is much better than Idea A.

2.1.5. Qualitative: As another ranking/analysis alternative, the user is given the option of adding non-quantitative measures as well. This is preferably manifested as a simple comment field, or a discussion of the relative merits versus competitors among others.

B.2.2. Routing: After the author has performed his/her analysis, links to the analysis web page can be sent to people for independent analysis. The author has the ability to pick from an IMS-generated list of people with the expertise required to send the analysis request to.

2.2.1. Analysis Valuation Points: People who are selected for an analysis request are awarded valuation points.

B.3. Valuation Manager:

B.3.1. Citations: Capability to relate new documents to previously generated documents. When a new innovation is submitted, there is an opportunity to list references. These references generate valuation points for the original author(s).

B.3.2. Searches/Hits: When a database search or collaboration search returns hits, these hits generate valuation points for the original author(s). The hits must be from unique users and the valuation is based on the relevance of the hit, i.e., if the hit is 65 out of 100, the valuation is lower than if the relevance was 3 out of 100.

B.3.3. Downloads: When a person actually downloads or views a returned “hit” then the original author receives valuation points.

B.3.4. NDA Tracker: IP that is listed within the context of an NDA also receives valuation points.

B.3.5. Analysis: The results of the analysis in B.2 above is another component in determining the overall valuation. Optionally, the people who perform the individual analysis are scored according to their total relevancy points. For example, if a person is recognized as the premier expert in a discipline, then that person's valuation has more impact on the overall score.

B.3.6. External: This assigns valuation points for Internet publications, hits on the Internet, and licensing of an innovation.

3.6.1. Internet Publication

3.6.2. Licensing

B.4. Accounting Analysis: This function accommodates the financial analysis of an innovation.

B.5. Innovation Marketing: This function provides marketing information to the user. Since information on innovations/ideas has already been enter through other parts of this system, this information can be properly formatted and then sent to third party databases for marketing leads. At these third party sites, marketing leads are automatically generated based on the input from the MMT system. Additionally, the user can add/modify information associated with an idea before it is sent so that a more complete marketing framework can be constructed. When the leads are returned to the system, this function automatically aggregates them and presents them to the user so that they can be used for follow-up, i.e., direct mail, phone, e-mail. Leads are annotated and tracked and can be exported to third-party contact managers.

C. Licensing Web Site & Intra-Organization Sharing

C.1. Innovation Exchanger: This function allows certain classes, key words, etc. of ideas to be published to an externally (unprotected) viewable location. The purpose of external publishing is to foster the development or use of ideas by other entities. By publishing basic information such as brief abstract, application area, and key words, along with a unique id, external viewers can read the briefs and determine whether a particular idea is worth following up. If an external viewer was interested in gathering more information, he/she can click a button that automatically sends the ID number in an e-mail to the corporate IP (or other) department for consideration. This function records the exchange of e-mails concerning the innovation.

C.1.1. Internet Publisher: This function allows the user (providing they have correct access) to submit an idea for publication on the Internet. This is either on the organizations external Internet connected site or to the MMT Internet site. Users are able to select one or both, the date to publish, the duration to publish, expiration, contact point, and what types of information are to be made available, i.e., inventor's name, potential applications, category, score, etc.

C.1.2. Organization Intranet Publisher: This function is identical to C. 1.1, however, it allows a separate configuration for internal viewing. Whereas a company may not want to have the inventor's name published to an external website, they may want it published internally.

D. Network Monitoring and Protection System

This Network Monitoring and Protection System preferably comprises some or all of three functional components: Agent Monitoring System (AMS), File Management Server (FMS), and a Trade Secret System (TSS). The system provides complete protection of trade secrets by defining what data is considered a secret, who is allowed access to the secrets, what type of access is permitted, and by enforcing policies for accountability, awareness, and security.

The system can be used in at least two different modes: either with or without the Agent Monitoring System running. In the former, the client PC makes a request through the AMS, and the file is returned from the File Management Server into this process. In this case, the AMS and the FMS communicate with each other and the File Management Server provides trade secrets based on all of the available rules. In the latter mode, any client can be used to access files on the protected server. In this case, the AMS and the FMS do not communicate with each other, instead the File Management Server monitors the trade secrets and applies the protections based on the rules which do not include the user. Other modes include:

Full Protection Mode: The AMS along with the FMS and TSS are all running. This provides the ultimate level of protection as the trade secrets are fully wrapped and are monitored on the PC/client.

Medium Protection: The AMS is not running, but the FMS is actively monitoring the trade secrets and is wrapping them with protections that can be employed when the AMS is not running. For example, the display of a visual warning, encryption, and password protection is available without the AMS.

D.1. Agent Monitoring System (AMS): The AMS resides on the client hardware, usually a PC, and monitors the user actions on the trade secret files. The AMS acts as a permissions agent, giving the ability to read, print, mail, etc the trade secret by the user. In some cases, the AMS communicates with the File Management Server concerning the use of the trade secret. These communications can either be batched or transmitted continuously.

D.1.1. Trade Secret Viewer: This is the central controlling process on the agent machine. It is the vehicle by which the user makes the request for the trade secret, it handles the incoming approved trade secret storage, launches any applications that are necessary to process the trade secret (for example, the user wants to print the trade secret out, then this process starts the word processor application), and this process sends activities it performs to the Trade Secret Monitor.

D.1.2. Event Manager: This function reads the wrapper on the trade secret and then schedules any events that are necessary, i.e., deleting or changing the trade secret after a certain number of days. This process also sends all activities to the TSS.

D.1.3. Trade Secret Monitor: The Trade Secret Monitor records all activities performed on a trade secret, and sends the events to the File Management Server. It can also watch for activities from any launched applications dealing with the trade secret, send reports, or watch a certain data area on the disk.

D.2. File Management Server (FMS): The FMS handles all requests for trade secrets from the AMS (user). The FMS checks the user name against a password list (network, asked via browser, employee id, etc) and verify the user before allowing a file request to be made. Once the user is verified, the trade secret requested file is matched with the rules associated with that particular trade secret, encrypted, wrapped with a monitoring agent, logged and sent back to the AMS. The File Management Server maintains information about trade secrets such as: artwork, designs, blue prints, tools, methods, patents, trademarks, copyrights, maskwork, computer files, databases, business logic (computer code and methods) and other proprietary information that may be defined from time to time. With respect to each type of intellectual property, the FMS maintains information on dates (last update, when added, when deleted, various stages of property (patent pending, patent, etc), a description of the property, title, ownership, coverage, inventor/author, licensing, and supporting documents. The FMS contains all of the functionality to select files/directories/servers as trade secrets, create classes of trade secrets, create classes of users, apply permissions (encryption, visual notice, etc) to trade secrets, classes of trade secrets, users, or users of trade secrets, and to create rules by mapping trade secrets (or classes of trade secrets) to users (or users of trade secrets).

D.2.1. Request Handler: This process handles incoming trade secret requests, verifies the user from the network password list, initiates the request, and eventually sends back the requested file or a deny. This function can either be called directly such as the case with the AMS makes a specific request, or in “sniffer” mode it can watch the network traffic for files/transactions that have been designated as trade secrets.

D.2.2. Trade Secret Management: This function allows administrators to select/deselect files, directories, or servers/workstations, locations, etc to be used as trade secrets. The administrator selects by clicking a check box next to each file/directory/server/location. (Similar implementation as a Windows Backup program). Additional functions within this group allow for specific types of intellectual property to be described in more detail. For example, drawings may contain references to authors, creation dates, or products that incorporate the features described. Each type of intellectual property has its own set of attributes that can be tracked.

D.2.3. Rules Management: This function allows the administrator to create rules. Rules are the mapping of trade secrets and trade secret classes to users and user classes. The administrator is allowed to add, change, or delete rules by rule number, class name, or user. The rule consists of a mapping (either one to many, one to one, many to many, or many to one) which describes the relationship between the intellectual property and the user(s).

D.2.4. Class Management: This function sets up classes of trade secrets and users for the rules. The purpose is to make rule definition faster. By setting entire classes of files as trade secrets, either by server, location, etc. then the rules can be set up once for the entire class instead of one file at a time.

D.2.4.1. Trade Secret Classes: This function consists of a listing of directories, servers, or grouping of files that consist of a class, the class name, and the permissions for the class. The list also contains previously selected files/directories/servers as well, so that the administrator can select them and put them into a class. Administrators have the ability to add, delete, or modify classes. Trade secret classes can be viewed/sorted by trade secret, class, or permissions.

D.2.4.2. User Classes: This function consists of a list of network users, their class, and the permissions of the for the class. The list also contains all network users as well, so that the administrator can select them and put them into a class. Administrators have the ability to add, delete, or modify classes. User classes can be viewed/sorted by user name, class, or permissions.

D.2.4.3. Permission Management: This function assigns permissions to user and trade secret classes. For example, this allows the trade secret class “research” to have the permissions as designated in the Security Manager (D3.4). A permission can consist of the following attributes in any combination:

D.2.4.3.1. None: In this instance, no tracking is performed. In most cases, this deactivates existing rules.

D.2.4.3.2. Visual Warning: This presents a “blue screen” or some type of visual display on the client PC. This is displayed each time the trade secret is accessed, informing the user of the trade secret that the information is confidential (or some other messages entered by the administrators)

D.2.4.3.3. Password: This rule demands a password to access the trade secret each time it is accessed by the user. This can either be a password that is made up by the user when they initially download the trade secret, or it can be their normal network password, or a completely different password set by the administrator.

D.2.4.3.4. Encryption: This rule encrypts the trade secret by one of the commonly available methods set by the administrator.

D.2.4.3.5. Agent: This type of rule allows the trade secret to be monitored by tracking any modifications to the file (or alternatively the physical data), and monitoring key strokes. It also allows the trade secret to be deleted after a certain number of days automatically by the Agent Monitoring System residing on the PC. It can be further refined to perform NSA or other data segment erasing methods to ensure complete removal from the system. The agent also gives the option of sending tracking information back to the File Management Server for analysis by the administrator, or “insisting” that the agent be allowed to communicate with the FMS before any further actions are allowed on the trade secret.

D.2.5. File Wrapper System: This process is extremely complex as it grabs the file/data and performs the functions required in the rules, including encryption, setting expiration dates, translating the file to an executable image, called a wrapper (file+rules+agent), etc. The wrapper can also contain the Agent Monitoring System. The file/data can either be a specific file/data pulled in from the network via TCP/IP sniffing, a file/data pulled from a specific location, or the file/data that is a result of an external query (database call). All of these actions are logged. The executable image is in a format that can be processed (read, print, modify, delete, etc) by the Agent Monitoring System.

D.2.6. Reporting System:This process takes information from the log files, rules, wrappers, etc. and prepares reports on usage, activity etc.

D.3. Trade Secret System (TSS): This functional process manages the accountability, awareness, secrecy, and security (four trade secret pillars) status of each trade secret. This process also allows the user to dynamic change each of the four pillars to reflect strategic changes in the business. The TSS is the primary mechanism for creating the rules.

D.3.1. Awareness Manager: This function tracks and logs a company's (or entity's) IP Policies, management oversight procedures, the dissemination of an understanding of Public Disclosure (as defined by U.S. Law), the tracking and dissemination of What a Trade Secret is (according to U.S. Law). The purpose is to show that various supervision entities have created awareness for trade secrets as prescribed by law, and that the people who use the trade secrets have a clear understanding, and hence accountability of the trade secrets that they use.

D.3.1.1. Trade Secret Finder: This function determines potential trade secrets by “reading” files on the network and comparing the text with lists of key words and phrases entered by the management. This is designed to be used periodically to maintain integrity of the system. Final decisions regarding a documents status are made by management.

D.3.1.2. Trade Secret Eliminator: This function determines which trade secrets should be demoted and removed from protection. By searching by key word, date, and usage, the function intelligently makes recommendations for removal. Final removal is determined by management.

D.3.2. Accountability Manager: This function tracks and logs a company's IP reviews, employment contracts/IP agreements. The purpose of this function is to track contracts and paper trails that provide awareness of the trade secrets. Reports from this function give the complete detail on the level of trade secret usage/disclosure by aggregating class information, trade secret information, user activities, user awareness acknowledgments, and external data to give a rating as to the protectability of the trade secret. By measuring where the trade secret is used, how it is disclosed, how it is protected, and employee awareness a rating can be generated. Intelligent search function uses key words plus SIC Code and other market-specific information to conduct a more intelligent search. This function employs “spider” graphs and the pair-wise comparison methods described elsewhere herein.

D.3.3. Secrecy Manager: This function tracks and logs confidentiality agreements, publications, press releases, and marketing collateral associated with a company's trade secrets. This process maintains access to the external networks (Internet) and conducts key-word searches to find other companies/disclosures of monitored trade secrets. There are several third-party products that can be hooked into this system to perform this function. This process provides the interface.

D.3.4. Security Manager: This function tracks and logs public access to workspaces, network security, E-mail, and demonstrations. This process is the primary interface to e-mail monitoring programs and external physical security systems (tracking ID card usage, etc.)

This section further describes some typical use of the System. Because of the nature of the System, it is not always possible to numerically delineate an exclusive sequence of events, however, each subparagraph represents at least one (sometimes many) functional aspect of the system. There are three general functional flows presented in this section: the user, the administrator, and the manager. The user is the person who wants to view/modify the trade secret, the administrator sets up rules, wrappers, and files/directories/machines as trade secrets, and the manager defines trade secret policies and runs/views reports.

User Flow, Network Monitoring and Protection

If the name and password are valid, and the trade secret is allowed to be accessed by the user, then the file is wrapped according to the rules set forth by the administrator.

Wrapping takes place in the File Management Server and creates a binary executable of the file with the wrapping contents. The wrapper can also contain the Agent Monitoring System (if the user does not have it, but it is required for file access).

The file is sent back to the user's PC.

The user double-clicks (or opens, or performs some other function which initiates access to the trade secret) on the trade secret file.

If the wrapper required encryption, then the trade secret is decrypted.

If the wrapper required a password, then the user is prompted for the password.

If the wrapper required a visual warning, then a “blue screen” is presented to the user so that the confidentiality of the trade secret is described and the responsibilities to the user are presented.

If the user types an invalid password X times, then the trade secret is rendered inoperable (either deleted or stays dormant), the appropriate logs are generated by the Agent Monitoring System, and if required the log information is sent to the File Management Server.

If the Agent Monitoring System (AMS) has been activated, then it begins recording activities defined by the administrator that occur on the trade secret document.

If the AMS receives a command from the user to view the trade secret, then the appropriate application is started (probably Adobe Acrobat with modification attributes set on startup) and the document is displayed. Depending on the user's pre-determined authorization, the application allows the user to read/write/delete/update the trade secret. Each action by the user is logged locally, and can be communicated back to the File Management Server.

If the AMS determines that the trade secret should be deleted, then the AMS deletes the file and performs the secure erasing method. This activity is logged, and communicated back to the FMS is required.

The user receives a mail message informing him/her that new IP policies are now in place and should be reviewed for compliance. The user reads the policy (on the internal web server) and responds by electronically signing the policy.

Administration Flow, Network Monitoring and Protection

The administrator sets up the File Management Server to be either in one of three modes: with the Agent Monitoring System running or without. If the Agent Monitoring System is running, this implies that the AMS software is either resident on the user's PC or the AMS software is wrapped with a requested file and sent to the user's PC to be installed before the trade secret is viewed. Using the AMS software implies that a greater level of protection is operational as the AMS records information in addition to the File Management Server that records the initial request.

The administrator further sets up the FMS by deciding whether the FMS should be set into “sniffer” mode, where it simply records requests/receipts of trade secrets, or whether it should be set to intervene between every receipt by appropriately wrapping the trade secret with protections.

The administrator sets up the FMS to the type of network(s) being monitored, such as TCP, IPX, NetBUI, etc. and the types of network packets being tracked, such as IP, HTTP, etc.

The administrator uses network services to set up the FMS server as a client in the system. This ensures that this server receives all updates about user access, including the network password list.

The administrator runs the Trade Secret Finder to locate various trade secrets. First, the administrator entered key words, projects, locations, servers, etc. and the Finder presents a list of possible machines, folders, and documents to protect. This saves the administrator time in setting up the system.

The administrator selects any combination of servers, directories, and files to be designated as trade secrets. If no other actions are performed, i.e., no rules are set up, then the, FMS goes into default mode where it simply records the access to each trade secret. Access records contain file name, file location, user, date/time, and other identification.

The administrator further designates classes of trade secrets. These classes group the trade secrets according to policy defined at the company, such as by physical location, by server, by company department, by directory, by trade secret type, etc. For example, the administrator may assigned the trade secret class “research” to the servers located in the company's research lab in Seattle, Wash. This preferably consists of the five machines and their corresponding files and directories. In another example, the administrator may define the class “project X” to include the directories labeled C:\project_x on the servers in Tampa, Fla. and Pittsburgh, Pa. The purpose of defining classes is to make the application of rules simpler.

The administrator further designates classes of users. These classes group users according to viewing restrictions. Classes can be defined by location, by job function, by current network access privileges, by department, by title, by name, etc. For example, the administrator may define all users who have the title “research assistant” to a user class called “research-assistant” and to have view-only access to any trade secrets. In another example, the administrator may define users who reside in Orlando, Fla. to have view and modify writes to any trade secrets, as well as the ability to delete trade secrets that have been downloaded to the users more than 30 days. Or simply, the administrator may select all users that live in Redmond, Wash. to a class labeled “Redmond”.

The administrator sets up rules by mapping either trade secrets or classes of trade secrets with users or classes of users, and by adding/modifying/deleting further file manipulation properties. For example, the administrator sets user class “research assistant” (which has view-only access) to trade secret class “research” (which can look at files on the Seattle, Wash. server). In addition, the administrator may elect to further refine this rule by requiring that all trade secrets are also encrypted and password protected.

If the company is managing assets loaded into third-party databases, i.e., Oracle, DB2, Access, then only classes of users can be designated.

If databases are being monitored, then in addition to user name, date/time, and other identifying information, the FMS also records the database calls.

Manager Flow, Network Monitoring and Protection

A manager decides to enter a new trade secret into the system. Since the physical file is already present on the company's network file system, the manager uses a Windows Explorer-like tool to find and select the desired file. Selection takes place by placing a check mark next to the file. Similarly, if the file is originally placed into an already protected directory, then the new file receives the same level of protection as the current files in the directory.

The manager enters information regarding the ownership, economic value, and key words to be associated with the trade secrets.

A manager decides to enter a new user. In this case, the manager uses a tool that brings up all users for the network. It is assumed that the new user has been added to the company's network file system. The manager then selects the user and either puts him/her into an existing class, creates a new class for that user, or assigns access rights to the individual user.

The manager is presented with a monthly REVIEW FOR REMOVAL report indicating files that need to be re-verified as trade secrets. This report lists the trade secrets that are “owned” by him/her, the file, date, accesses, etc. These files were either selected by the intelligent removal agent, or are generated by administrator direction in order to keep the system updated. The manager either checks or unchecks files that should be removed.

The manager enters IP policy files into the Awareness Manager.

The manager selects an IP policy or policies and a class or classes or users and requests that a notice be sent to all of the users (in the selected class) informing them of new IP policies.

The manager later views a USER AWARENESS report that indicates which employees have read and responded to the new policies.

The manager enters a new vendor contract, licensing agreement, joint venture, etc. document that includes the disclosure of certain corporate trade secrets. This document is tied to the trade secrets it covers so that trade secrets that leave the company and go into the hands of third parties can be tracked.

When this third party relationship is terminated, a THIRD PARTY DISCLOSURE report of all disclosed trade secrets is printed, and the trade secrets are either destroyed (and marked accordingly in the system), or returned (and marked accordingly). The appropriate dates and other related information are entered into the system at this time.

The manager prints out a trade secret along with a disclosure to give to a third party, this information is automatically recorded.

A new employee is hired and entered into the system. Based on the user's assigned class, a set of materials (IP policies, non-disclosure, etc) are automatically generated and printed. When the documents are signed and returned to the employee file, this information is entered into the system.

The manager prints a TRADE SECRET DISCLOSURE report that lists each trade secret, the users who have accessed it, what activities were performed on the trade secret, what the level of protection of the trade secret is, where it is located, and what third parties have the trade secret.

The manager prints a USER DISCLOSURE report that details the trade secrets accessed by the user, the types of activities performed on the trade secret, and the time and date. Any obsolete trade secrets are listed as such, but all of the information is presented.

An employee terminates their employment. Along with a USER DISCLOSURE report, a form which indicates that the user is leaving, and a notice which informs the employee about their responsibilities to keep the listed trade secrets confidential. This form is entered into the employee file.

The manager requests a PROTECTABILITY report. Based on the types of disclosures, activities, level of awareness of users, public disclosures, this report provides a rating as to the protectability of the trade secret. For example, if a trade secret has been accessed by users that have not read the IP policies, then the protectability is lower.

The manager views a SECRECY report that details suspected exposure of the trade secret outside the corporate network as well as potential external information that could render the trade secret useless. The manager reviews this information and determines the extent of exposure for each entry in the list.

The manager is presented with various reports from external IPX systems via the SECURITY report. This aggregates information about e-mail, physical security, etc., and relates it to the trade secrets. For example, e-mail scanners which have detected key words being sent to external parties might raise an alarm. Physical security which has been compromised where trade secrets are located is an indicator of trade secrets to be flagged for possible removal.

Further specification of the components of the System follows:

File Management System (FMS)

A File Management System is advantageously located on an MMT or other corporate server. LAN packet detector and decoder technology (such as from Packetboy, Australia; LinkView, www.linkview.com, US; NetSniffer, www.assert.ee/netsniffer/index.html; NetXRay, Cinco) is employed in a manner that will be known to those skilled in the art. The FMS exists in promiscuous mode, and reads the packets. Reading a packet generally means to decode packet contents, determine if it contains data (i.e. trade secret) that is being monitored by reading results of the action completed below with respect to marked selections of files being stored for monitoring. Monitored files are optionally and advantageously put into filters for the LAN detector; and positive filter results are placed into a file for use by the wrapper function described below. If the packet contains a trade secret, then it is sent to the wrapper application process

File Selection is preferably with check boxes (similar to Backup utilities). Functions are alternatively coded in VB using VTREE routines, or such like as may be known to those skilled in the art. All servers, directories, files are preferably encompassed; servers, directories, as well as files may be selected by checking a box. Marked selections are then stored for monitoring, such as discussed above.

Trade secret classes are created (via custom VB functions, or the like or equivalent as will be known to those skilled in the art, such as HTML and Java coding equivalents to VB). The marked list from above, as modified by files suggested (or alternatively deselected) by a user as part of the Agent Monitoring System (AMS) process discussed below, is displayed. From here, selection and aggregation into classes proceeds, and input of trade secret attributes, type, date, value, etc. for later reports is set up, and permissions are assigned.

User classes are also created (via custom VB functions, or the like or equivalent as will be known to those skilled in the art, such as HTML and Java coding equivalents to VB). A network list of users is displayed, from which to select and aggregate into user classes, and permissions are assigned.

A rules comprises the identification of a trade secret with a user, (via custom VB functions, or the like, and the lists of trade secret classes and user classes from above are displayed and matched to create such rules. Permission assignment changes are permitted by authorized persons however.

Wrapper functions. A file name is received from the filter results function above. A check is made to see if the file name is located in a database of rules. If not, then all classes are checked. If still not located, then default rules are assumed. The file containing trade secret and view attributes is then encrypted, compressed, and zipped (if required), into a self-extracting exe called an .MMT (DataCloak) or other desired unique file extension, whereupon it is logged and sent to the requesting user.

Agent Monitoring System (AMS)

A PC sensor agent that performs monitoring of the trade secret based on the wrapper resides on each user machine. The wrapper and contents are decoded and given to the PC sensor agent monitor. In addition, disk activity and file activity on the PC are also monitored by a well known Filemon function, and keyboard activity is optionally monitored by a well known keyboard monitor function such as PCACME. Report of all monitored activities is sent to the TSS described below.

When the user clicks on a .MMT file, a File Viewer is automatically run that decrypts the file, asks for password, shows warning, etc first, and then runs a conventional file viewer such as that provided by Adobe. The file can be displayed, printed or modified using Adobe, if Adobe is so configured on the system. All such activities are logged as described above.

Using an otherwise conventional Explorer type interface, a user may use a Make Trade Secret function as add-on to Explorer and so add check marks to a list of files to be treated as trade secrets, as discussed above. Necessary TS attributes are optionally prompted for. The file and attributes are sent in a message to an IP manager. Trade secrets may be removed in a like but reciprocal manner, where one of the prompted attributes is a reason for removal.

Trade Secret System (TSS)

All logs from the above processes are collected for Accountability and Awarenes. For Accountability, there are provided optionally a File Access report (by user, file, date, type, class, activities), a User report (by activities, file, type, class), a Value report (by trade secret type, file, user, class), a PC Agent report (by user, file, action, class, activities), and an External Publications cross-reference report. For Awareness, users and management alike can view (or enter) IP Policies, cross referenced by file and class, and a Share Policies function makes policies available on the web, to induce and promote employee compliance. Appropriate users can also view/enter IP Contracts, cross referenced by file and class.

A Secrecy Manager is provided preferably in the form of an Internet agent looking on the web for key word references that are linked to listed trade secrets that reports back with listings of suspected TS usage (in a manner like Web Ferret).

A Security Manager interfaces with workspace security and with e-mail security and logs all external activities.

The specification of U.S. patent application Ser. No. 09/709,900 is incorporated herein by this reference as if fully set forth.

Further aspects of the IMS:

Innovator Overview

[image]

See the status of the entire environment. The company can communicate needs, highlight performance and you have access to all of your own submissions. This is the “launch point” of all activity.

Key sections of the home page are described below:

My Innovations: Provides a “file cabinet” from which a user can see their submissions, edit and update the data contained in a submission, run an analysis and view the results, check statuses, generate search agents, perform searches and view the results, and forward/route submissions to an individual, group or configured committee.

In the Spotlight: Company-selected submission of high interest. Everyone sees a particular submission and recognizes the efforts of an individual or team. Links to the details of the submission are provided.

Innovation Highlights: Showcases individuals who are very active within the environment of the Innovator.

Challenges: Company-provided metrics indicating goals and challenges set by management. Submitters can track company progress against these goals.

Innovation Notices: Notices of review Requests, Collaboration Agent results, the receipt of innovation Comments and Search Agent results.

User Information: Provides the name, title, department and location of the logged-in user. Lists membership in review committees and user groups.

Navigation: Expanding menu— driven links to all of the features of the Innovator.

[image]

Populate the data fields necessary to capture, track, analyze and share a new idea submission. In many cases, this page will replace the invention disclosure document.

To enter a new submission:

Required Data:

1. Click Submit New Innovation in the menu located on the left hand side of the Innovator.

2. Enter the Innovation Name.

3. Use the drop-down list to select the Innovation Type. Click the About Innovation Types link for descriptions of the types.

4. Use the drop-down list to select the Submit To department this innovation should be sent to for review. In most cases, the innovation will be sent for review within your own department/location. However, if you have an idea for another department/location, then select a different department from the list, if available.

5. Enter all of the appropriate Keywords for this innovation. Keywords are unique words that help to identify this innovation. Separate all Keywords with commas. They will be used to set up searches, find experts and assist with collaboration throughout the system. Additional

Keywords can be added later.

6. Enter an appropriate Description for this innovation.

7. Optionally, check the Share Innovation box to share your innovation with all of the users within the Innovator and to begin your organization's review process.

8. Perform any Optional Steps as described below.

9. Click the Save In My Innovations button to save this submission as “Private” in your “file cabinet.” Private submissions cannot be seen by anyone except the submitter. NOTE: The submitter must share an innovation to start the formal review process. Optional Steps:

10. Other Inventors/Contributors: If there are users in addition to yourself who participated in the development of this innovation, click on the Add button to see a list of registered users. Select all Contributors/Inventors from this list. You can use the “standard Windows™ ” features

of <Shift> and/or <Ctrl> for multiple user selections. Use the Remove button to remove a selected (one or multiple) Contributor/Inventor from the list. Use the Remove All button to clear the entire list of Contributors/Inventors.

11. If you have Electronic Documents, Misc/Paper Documents or know of Required Resources related to this submission, click on the appropriate box to open that window.

a. Electronic Documents: After clicking on the check box for Electronic Documents, the window opens to allow you to add or remove Electronic Documents associated with this submission. To attach a new document, click on the Add button. A familiar looking Windows™ Select box will open, allowing you to browse and select the Electronic Document you wish to attach. Select all of the Electronic Documents from this window you wish to attach.

You can use the “standard windows” features of <Shift> and/or <Ctrl> for multiple user selections. Use the Remove button to remove a selected (one or multiple) Electronic Document from the list. Use the Remove All button to clear the entire list of Electronic Documents.

b. Misc/Paper Documents: After clicking on the check box for Misc/Paper Documents, the window opens to allow you to add other items associated with this submission. To associate non-electronic items (drawing, sketch, white paper, lab notebook, etc.), fill in the requested information.

i. Title: What is the Title of this Paper Document?

ii. Type: Use the drop-down list to select the type, i.e., White Paper, Lab Notebook, Sketch, etc.

iii. Location: Where is it? (File Cabinet, Safe Deposit Box, Office, etc.)

c. Required Resources: After clicking on the check box for Required Resources, the window opens to allow you to add Required Resources you believe may be required by this submission. To identify Required Resources, fill in the requested information.

i. Person— Hours: How many hours do you think this submission will require to develop to the next stage?

ii. Equipment Needed: What physical resources will this submission require (computers, test gear, floor space, etc.)?

iii. Budget: How much do you think it will cost to develop this submission?

Entering Biographical Information into My Profile

[image]

Enter information about yourself into your own biography page. Data entered here defines your interests and expertise for other users to refer to you as an “expert” for searches and routing. A number of these fields may have been populated from the initial Create New Login screen. Users have the option to associate a number of additional details to themselves.

Enter Profile Data and View:

1. Click My Profile in the menu located on the left hand side of the Innovator, then click Edit under My Profile.

2. To select which fields you want to populate and display in your profile, click the corresponding checkboxes (located at the top of the page), and the appropriate data-entry box will appear below. Checkboxes include (there may be others as well):

a. Title

b. Contact Info (Email, Phone #, Location, Department)

c. File Cabinet (My Innovations)

d. Picture

e. Expertise

f. Research

g. Publication

h. Interests

3. Complete the requested information with as much detail as possible. NOTE: You MUST fill in any text-box that you have checked, or else you will not be able to save your work. If you wish to leave the text box empty, then uncheck the corresponding Checkbox on the top of the page.

4. Click on the Save button at the top or bottom of the page. (You only need to click the Save button once for all changes.)

Public Links:

You can add links to your own computer files, computer directories, or web sites that you believe are beneficial to your profile.

1. To add a new link or file, click on Add button and a new input area will show up.

2. Using the drop-down list, select ‘URL’ for a Web site, select ‘File’ for a specific file, or select ‘File Location’ for an entire directory of files.

a. If you selected ‘URL’, then add a description of the Web site, and enter the address for the website.

b. If you selected ‘File’ or ‘File Location’, click on the Browse button to open a Windows dialog box, and the select either the file or directory you wish to share on your profile.

3. Click on the Save button at the top or bottom of the page. (You only need to click the Save button once for all changes)

[image]

Measure your submission against the standardized question set established by the company. Shared submissions can be routed to other users for a more diverse sampling. The questions are pre-selected by the System Administrator. They provide a benchmark against which all submissions are compared equally.

1. From you're my Innovations list, highlight the submission you wish to analyze, and then select Perform Analysis from the drop-down list.

2. If you are unfamiliar with the submission, take the time to read the description before answering the questions. Understand the technology, science, and process before you analyze it.

3. You can navigate to the next question by pressing the <Tab> key or by using your mouse.

4. Read carefully, and answer the questions on a scale from 1 to 5 with one (1) being lowest or “of least significance,” and with five (5) being highest or “of most significance.” (Your organization's scale could be between 1 and 10, or any other two low/high number combinations.)

5. It is best if you answer every question, as they are helping to apply a standard against all submissions. If a question either cannot be answered with your knowledge, or truly “does not apply,” simply move on to the next question.

6. Add comments, if desired, in the Comments text box.

7. Click the Submit Completed Analysis button when you have answered all of the analysis questions.

8. After submitting your Analysis you will return to the Innovation Home page. From here, you can review the graphed results of the analysis by selecting View Analysis Results from the drop-down list directly below the My Innovations folder. There you will see the graphed results and total score.

[image]

This allows your innovation to become part of the shared innovation database and “enters” your innovation into your organization's workflow and/or evaluation process. Your facilitator and/or manager will also be able to view it as well. Once you are satisfied with your innovation and want to change it from private to shared, follow this procedure:

1. Highlight the submission you wish to share from My Innovations on the home page.

2. Select Share Innovation from the drop-down list directly below the My Innovations folder. The innovation will now be available to everyone in the Innovator who has the appropriate security level. In addition, the innovation will now be visible to your facilitator/manager for review.

OR

1. Highlight the submission you wish to share from My Innovations on the home page.

2. Select Overview from the drop-down list directly below the My Innovations folder.

3. Click on the Edit button to allow changes to be made to the innovation. The Share button will be activated.

4. Click on the Share button. The innovation will now be available to everyone in the Innovator who has the appropriate security level. In addition, the innovation will now be visible to your facilitator/manager for review.

OR

While preparing a new innovation for submission, you can check the box labeled Share Innovation. This will automatically save the innovation in you're my Innovations folder on the home page and share it with other users in the system. NOTE: If you don't explicitly “Share” your innovations, no one will be able to see them.

[image]

Find experts within your organization who can help you improve and analyze your innovation. You can send your innovation to experts, specific individuals, or review committees.

As you submit your innovation, you enter keywords and a description of your innovation. Based on these keywords, experts can be found by looking for these same keywords in the other people's My Profile. Remember that users who you find as experts are not notified unless you specifically request their help.

1. Highlight the innovation that you want to forward in you're my Innovations folder, and then select Forward from the drop-down list directly below the My Innovations folder.

2. To forward an innovation for analysis:

a. In the window labeled Forward to Users/Experts for Analysis, click either the Selected Users radio button to pick specific users or the Experts radio button to have the Innovator find experts for the innovation.

i. If you pick Selected Users, then you click on the Add button to bring up a list of all users within the Innovator. Locate the individual(s) that you want by either double-clicking on the highlighted name, or by highlighting a name and then clicking the Select button.

ii. If you pick Experts, then when you click the Find button, the Innovator will search the Profiles database for people who have expertise that matches the keywords/description of the innovation.

b. Review the names and remove anyone who you would not like to send your innovation to by clicking on the Remove or Remove All button.

c. Clicking on the Forward to All button will send messages to everyone on the list.

3. To forward an innovation to a review committee:

a. In the window labeled Forward to Review Committee, select a review committee from the drop-down list.

b. Clicking on the Forward to Review Committee button will send messages to everyone on the committee.

[image]

In order to perform quick searches of innovation and profile data contained within the Innovator, click on the ‘Search’ graphic in the top right corner of the home page. In order for you to be able to conduct fast, efficient searches, new information (less than one day old) will not show up in search results. New information is automatically indexed nightly. Also note that new innovations will not show up in search results unless they have been ‘shared’ by the inventor(s).

Initially, the search is designed to automatically search all data for the keywords that you entered. If you would like to narrow the scope of your search, click on the check box labeled Advanced Options.

When you click the check box that says Advanced Options, a new form appears that allows you to further refine your search.

Search Fields: These are the fields that are searched by default, and can be deselected by un checking the appropriate field.

Expanded Search Fields: These are additional fields that can be searched. Check on the ones you want to add to your search.

Departments/Locations: Initially, the search will return results for all departments and locations. In Advance Options, you can limit the results by allowing results only in certain departments or locations. For example, if you only wanted results from one location, say, Pittsburgh, then just select ‘Pittsburgh’ from the drop-down list.

Exact Word Matching: You can also select Exact Word Matching to further limit the results. With this checked, the results will contain only the exact words you type in. For example, if you did NOT have this box checked and you entered the work ‘play’, the results would contain ‘play’, ‘plays’, ‘player’, and ‘playing’.

[image]

In order to automatically find new innovations/people as they are entered into the Innovator, set up a Collaboration Agent.

Collaboration agents are automatic (once-per-day), user-directed, searches of the entire Innovator database. The primary difference between collaboration agents and search agents is that search agents are attached to specific innovations and return results based on a particular innovation.

1. On the main menu, click on Collaboration, then click Collaboration Agents, finally click on the New Agent button.

2. Star t by entering the name for the new collaboration age nt. It is helpful to name it something that represents the type of information that you are looking for, such as “New Kitchen Appliances,” or “Stereo Speakers.”

3. Next select the type of agent you want to create. You can create agents that search exclusively in the Profiles, Innovations or both. You must pick one. Once you select the type, the appropriate form will be displayed.

4. In the column labeled Search Category, select the field that you would like to search from the drop-down list. If you would like to search through all of the fields, i.e., keywords, description, expertise, etc., then just select All. Otherwise, you can pick a particular field.

5. Once you have decided on the fields to search, enter the search terms separated with a comma. Note that you have several choices about how your search is performed:

You can require that search results contain ALL of your words/phrases by entering using the Results MUST CONTAIN ALL text box.

You can require that search results contain SOME of your words/phrases by entering using the Results SHOULD CONTAIN SOME text box.

You can require that search results NOT contain any of your words/phrases by entering using the Results MUST NOT CONTAIN ANY text box.

You can enter either words or phrases, both of which are separated by commas. Phrases do not need to include quotes (but it is OK if they do) and they can be intermixed with single words, for example: golf, PGA, Arnold Palmer. Other examples:—wooden roller coaster, swings, amusement park, city, chemicals, golf, PGA, Arnold Palmer, golf club, tee, plants, biology, plants, test tube.

6. Check the Advanced Options checkbox to include advanced search capabilities.

7. When you are finished, save your agent by clicking on the Save button.

The disclosed Innovation Management System has Been Developed to:

Inspire new ideas, inventions, intellectual capital and creative thinking amongst employees from all aspects of an organization, not just R&D and provide a company-updated forum in which future needs (inspirations for new ideas) are communicated to those employees to stimulate those “creative juices.”

Manage your intellectual assets in a database through collaboration, analysis modules, time and date stamping and an organization-driven measurement system that immediately “flags” the hot ideas and “returns” the cold ideas to the submitter; every step of the way from inspiration to commercialization.

Protect the intellectual assets of your organization from inadvertent disclosure through the Education Center, through detailed database record-access tracking, through prior-art searches, USPTO searches, time and date stamping and encryption.

The next steps cover a typical process of submitting an innovation, performing an analysis, and updating your biographical information.

Operation

Although the Innovator uses a familiar web browser interface, its underlying operation couldn't be farther from a typical web-based system. One of the primary differences is that it does not operate like a typical Intranet solution. Typically, a web-based application will use point-and-click methods whereby the user clicks on a link and then the system “retrieves” the information. Normally, this information is retrieved by making a request to the server and then repainting the page this takes precious time. Instead, while you log on to the Innovator, many of the pages you will need are automatically downloaded. When you click on a link or a menu item, the system has already retrieved the information you need and thus you are saved the time of going over the network. The result is a faster web application.

Menu System

The menu system is dynamically created based on your user rights, user preferences, and user data. For example, each time you submit an innovation, the menu is updated with your new innovation. To use it, simply click on the text, and you will be automatically brought to the appropriate place. Text items that are preceded by a “+” have additional text options, and thus when clicked will expand to provide more options. With this menu system you can easily navigate to any innovation and perform any function.

{bmct menu.bmp}

Unlike a conventional web application, instead of using your browser's Back and Forward buttons to navigate, use the two buttons in the upper left-hand corner.

Home Page Features

Spotlight

The Spotlight area is for innovations that are of particular interest to everyone using the Innovator. In general, they will be innovations that have passed through some pre-defined levels of qualification, such as a high analysis score. An Administrator determines the Spotlight innovations.

{bmct spotlight.bmp}

Innovation Highlights

This area of the home page displays the top results for the categories of Top Department, Top Location, Most Prolific and Date. Top Department and Top Location are lists of the number of submissions by either department or location. Most Prolific represents the people who have submitted the most innovations into the Innovator. Date represents the people who have most recently submitted innovations into the Innovator. Click on the links “Top Department’, ‘Top Location’, ‘Most Prolific’ or ‘Date’ to view the suitable information.

{bmct innovation_highlights.bmp}

Innovation Notices

This status window is only displayed if:

New search results have been found, Collaboration agents have returned new results, You have been requested to perform an analysis on an innovation, New comments have been added to one of your innovations. Click on the headings labeled “Requests”, “Collaboration Agents”, “Comments”, and “Search Agents” to see the details.

{bmct innovator_notices.bmp}

Breakthrough Challenges

This is a list of the challenges that your organization is currently addressing. Performance data in these areas are currently being collected to demonstrate progress toward these goals. To make a submission to challenge, you have two choices.

1. If you have a new idea to submit:

a. Click on the title of the challenge, you will be taken to a page with more details on the challenge as well as all of the submissions already made to the challenge.

b. Click the button labeled ‘Submit to this Challenge’ and fill out the usual submission form.

2. If you already have an idea located in My Innovations,

a. Highlight the innovation that you want to submit to the challenge in you're my Innovations folder, and then select ‘Add to Challenge’ from the drop-down list directly below the My Innovations folder.

User Information

The user information data in the lower left corner of the Innovator indicates the user's name, title, department, and location. It also indicates which Innovator User Groups that users have membership. This information can be updated in the My Profile section.

{bmct IMG00131.bmp}

Search

To perform quick searches of the innovation data, click on the ‘Search’ graphic in the top right corner of the home page. From there you can enter search terms, and then click the ‘Begin Search’ button to start searching. Initially, the search is designed to automatically search all data for the keywords that you entered. If you would like to narrow the scope of your search, click on the check box labeled ‘Advanced Options’

Advanced Options

When you click the check box that says ‘Advanced Options’, a new form appears that allows you to further refine your search.

Search Fields: These are the fields that are searched by default, and can be de-selected by un-checking the appropriate field. Expanded Search Fields: These are additional fields that can be searched. Check on the ones you want to add to your search. Note that the inventor's name is NOT a default field; therefore, searching for innovations by name will not return results unless this checkbox is marked. Departments/Locations: Initially, the search will return results for all departments and locations. In Advance Options, you can limit the results by allowing results only in certain departments or locations. For example, if you only wanted results from one location, say, Pittsburgh, then just select ‘Pittsburgh’ from the drop-down list. Exact Word Matching: You can also select ‘Exact Word Matching’ to further limit the results. With this checked, the results will contain only the exact words you type in. For example, if you did NOT have this box checked and you entered the work ‘play’, the results would contain ‘play’, ‘plays’, ‘player’, and ‘playing’. Return Results: Note that the search only returns 10 results by default—check 25, 100, 250, or All under the label #Results to see more. Note: You should only click ‘All’ if you are certain that your search contains more the 250 results. In this case, the computer may take a very long time to return your result set. For example, if your query results in 5,000 records, it could take several minutes to travel from the server over your network to your PC.

Submit New Innovation Overview

When you want to enter a new innovation into you're my Innovations folder, click on the Submit New Innovation text link. Since each innovation is a work-in-progress, enter as much information as you can, as you can always go back and change or delete items—even after an innovation has been submitted. Items preceded with a red asterisk are required.

{bmct submit.bmp}

Click on the ‘Reset’ button to clear all of your entries. Click on the ‘Save in My Innovations’ button to save the innovation in you're my Innovations folder—and the innovation will be saved as a private innovation.

Private/Public Innovations

One important note is that each time you submit an innovation; its status is set to “Private.” Private innovations are not viewed by anyone but you—not even managers—and are kept in you're my Innovations folder. Private innovations can be sent to anyone you choose for review. They are not returned as search results to anyone else. Conversely, everyone with the appropriate security privileges views “Public” innovations. As part of the process of submitting a “Public” innovation, it will be sent to the appropriate review committees/individuals as determined by your organization's distribution policy. To change a private innovation to public, simply select ‘Make Public’ from the drop-down list directly below the My Innovations folder. Click Make an Innovation Public to follow the step-by-step process.

To determine whether an innovation is public or not, highlight the innovation in your My Innovations folder. Under the column labeled ‘Public’, check to see whether it indicates ‘Yes’ or ‘No’. A ‘Yes’ indicates that the innovation is public.

Entering/Deleting/Changing Inventors

For any new innovation that you submit, it is assumed that you are an inventor. To add other inventors go the section titled, “Inventors/Contributors” and click on the lookup button. This will open a new window called the ‘User Name Lookup’, with a list of people.

The User Name Lookup window will automatically retrieve a list of all the users of the Innovator. In order to reduce the list to a more manageable number, you can use the drop-down lists under Departments, Locations, User Groups, and Review Committees. When you select from any of these drop down lists, the list will only include people who meet the criteria you selected. For example, if you selected ‘Pittsburgh’ from the Locations drop-down list and clicked the ‘Apply Filter’ button, then only the people who were located in Pittsburgh would be shown.

{bmct user_name_lookup.bmp}

Once you find the person you would like to add, either double-click on the name or click on the ‘Select’ button—the person will automatically be added to the inventor's list and the window will close. Repeat for multiple inventors. The ‘Select All’ button will return all of the users.

To delete a single inventor from a list of inventors, simply click the ‘Remove’ button. If you would like to clear the entire inventors list, click the ‘Remove All’ button.

{bmct inventors.bmp}

Do not be concerned if an inventor's location, e-mail, department or other descriptive information is different or has recently changed. Inventor information will automatically be changed (when updated) to reflect the new changes. So, if an inventor moves to a new department, this information will automatically be shown once changed by an Innovator Administrator or the inventor in question.

Attaching Electronic Documents

If you have already written up a description of your innovation, or if you have other electronic documents, such as spreadsheets, drawings, or source code, you can attach it with your innovation. This accomplishes several important goals. First, by attaching all documentation, you create a permanent record of the innovation with a time/date stamp. This will be important should any discrepancy arise concerning patentability or ownership. Second, the documents are securely recorded on the server, and are available should your originals be lost or destroyed.

To attach a document, simply click on the ‘Browse . . . ’ button. A selection window will open, and files can be located in exactly the same manner as with other Windows™ applications. When you have located the document, either click the file and click the ‘Open’ button, or double-click the file. In either case, the file will be selected and the window will automatically close. To remove documents, simply select the document you wish to remove and then click the ‘Remove’ button. The ‘Remove All’ button deletes all documents.

{bmct windows_dialog.bmp}

{bmct add_elec_doc.bmp}

Note that a brief description is required to make a submission. Even if your attached documents contain a more complete description, please cut and paste a brief description into the field on the submission form. Because of the sensitive nature of attached documents, searches are only performed on the description you enter, not the attached documents. In order for others to collaborate and understand your innovation, a description is crucial.

Attaching Paper Documents

If you have already written up a description of your innovation, or if you have other paper or tangible documents and/or prototypes, such as spreadsheets, drawings, or source code, you can attach it with your innovation. Type in the document's title, select an attachment type by using the drop-down list, and enter the location. When you submit your innovation, a unique barcode will be automatically created. You will be able to print the barcode and then attach it to the document and/or prototype.

{bmct addpaper.bmp}

Adding Required Resources

Your innovations are valuable. Whether they eventually end-up as multi-million dollar projects or are simply retained as “interesting,” it's important to try and assign value to them and determine resources required to bring them to fruition.

1. To fill in the row labeled Person-Hours, ask yourself the question, “How many total hours are required to bring this innovation to the next decision point?” For example, if you submitted a new innovation that will require that you spend 40 hours of laboratory work or 10 hours of marketing research enter the number of hours.

2. Second, to fill in the row labeled Equipment, ask yourself, “How much equipment is needed to bring this innovation to the next decision point?” For example, if you require a new software program, piece of laboratory equipment, or a PC, enter it under Equipment Needed.

3. Finally, to fill in the row labeled Budget, ask yourself, “What is the expected budget to bring this innovation to the next decision point?” For example, if you need $300 to purchase an information database, $10,000 for a PC, and $5,000 for outside contract work, enter $15,300 ($300+$10,000+$5,000) into the Expected Budget. This information will be viewed by others to determine the level of effort required to “test” the innovation—in other words, what do you need to make your idea work. Since the innovation is your creation, you're in the best position to help determine the answer to these questions. Additionally, other Innovator users will be able to contribute resources to your innovation.

To see what contributions others have made to your innovation, view the comments. See Comments Overview for more information.

{bmct required_resources.bmp}

My Innovations Overview

This is where all of your innovations are stored. Innovations that are “Public” are indicated with a ‘Yes’ in the column labeled Public and can be seen by everyone. Conversely, if there is a ‘No’ in the column labeled Public, then only you can see the innovation. To sort your innovations, click on any of the column titles, such as date, and the innovations are automatically sorted. Clicking on the column again sorts the column in reverse order. In addition, you can change the width of individual columns by centering your mouse in between the columns and waiting for the mouse to change to a vertical line ‘|’ then simply press the mouse button and drag the column to the desired width. Finally, column titles can be rearranged in any order by clicking and holding your mouse on a column and then moving it to the desired location.

{bmct my_jnnovations.bmp}

The date shown is the date the innovation was originally submitted. The Status column indicates the current status of your innovation. To get more detailed status information, select ‘Activity Log’ from the drop-down list directly below the My Innovations folder. The Search column indicates that your search agent has found a match. To get more details, select ‘Search Results’ from the drop-down list directly below the My Innovations folder.

Overview

When you want to view the details of a particular innovation, either highlight and double-click or select ‘Overview’ from the drop-down list directly below the My Innovations folder. You will be taken to a modified version of the submission page where you will be able view, edit, and update the information about the innovation. Click the ‘Edit’ button to begin the editing process. Note that some fields are not changeable, such as the date. Click the ‘Update’ button when you are finished editing. This will save your changes to the database. Click the ‘Print’ button to get a hardcopy of your innovation.Perform Analysis

When you want to perform an analysis on a particular innovation or if an innovation has been e-mailed to you with a request to perform an analysis, click on the ‘Perform Analysis’ button to begin the process. You will be presented with a series of questions. For more information, click Perform Analysis Overview.

View Analysis Results

This is a summary overview of all of the analyses that have been performed on a particular innovation. It includes a graphical representation of the total, along with information about the people who performed the analyses and their individual scores.

Activity Log

In order to provide a higher degree of feedback on your innovations, you can track the amount of activity as it relates to any of your innovations. The Activity Log feature tracks both automatic activities, such as when/who performed an analysis, when/who read your innovation, or manual activities such as a status change. For more information, click Activity Log.

Search Agents

Search agents are search “helpers” that look through the Innovator database to find innovations similar to those in you're my Innovations folder. Their purpose is to help you to quickly find innovations that are duplicates or where there might be areas of overlap and potential collaboration. You can quickly determine whether a search agent has located new information by checking to see if any of cells under the column Search Agent are colored red. The red color will disappear after you log out—unless new data is found. Each time you submit a new innovation, a search agent is automatically configured for you (you can delete it later if you prefer). It will automatically search for similar innovations based on the keywords and description that you entered for your innovation. After it performs its initial search, it will periodically (typically once a day) search the Innovator database for new innovations using the same criteria. In this way, you will be notified of any new information concerning your innovation, and both parties can benefit. Click Search Agent Overview for more information.

Search Results

These are the results from the search agents. Note that search agents are attached to a particular innovation, thus the search results pertain to only one innovation. To see the results for a particular innovation, highlight the innovation and select ‘Search Results’ from the home page. Lists of innovations that match your search agent criteria are displayed for review. Double-click on any of the results to view an overview of the innovation.

Forward

From time to time, it may be necessary or desirable to send an innovation to a peer, supervisor, team member, review committee, or any number of other people for their help. This feature allows the author/manager of an innovation to easily perform this task. Click Forwarding Overview for more information.

Make Innovation Public

One important note is that each time you submit an innovation; its status is set to “Private.” Private innovations are not viewed by anyone but you—not even managers or review committee members—and are kept in you're my Innovations folder. Private innovations can be sent to anyone you choose for review. They are. not returned as search results to anyone else. Conversely, everyone with the appropriate security privileges views “Public” innovations. As part of the process of submitting a “Public” innovation, it will be sent to the appropriate review committees/individuals as determined by your organization's distribution policy. To change a private innovation to public, simply highlight the innovation and select ‘Make Public’ from the drop-down list directly below the My Innovations folder. Click Make an Innovation Public to follow the step-by-step process.

Delete Private Innovation

To delete a ‘private’ innovation, simply highlight the innovation in you're my Innovations folder, and then select ‘Delete Private Innovation’ from the drop-down list directly below the My Innovations folder. The innovation will now be deleted. Note: you cannot delete innovations that have been made public. This prevents unauthorized deletion of your innovations. For more information about public/private innovations, click Private/Public Innovations

View Comments

As part of the collaboration process in the innovator, other users can add comments/resources to your innovations—provided they have the appropriate security level. To view all of the comments made on a particular innovation, highlight the innovation in you're my Innovations folder, and then select ‘View Comments’ from the drop-down list directly below the My Innovations folder. A list of all of the comments that have been made regarding this innovation will now be displayed. Click Comments Overview for more information.

Add to Challenge

Breakthrough Challenges are focused areas of innovation that your organization is currently addressing. Use this function to add/submit one of your existing innovations to a challenge. Click Breakthrough Challenges for more information.

All Details

To get all of the details associated with an innovation including, status information, other inventors, comments, complete analysis results, attached electronic documents, attached paper/misc items, and innovation details use this function. In addition to viewing the information on your computer screen, you can also print it to your default printer.

Overview Innovation

When you want to view the details of a particular innovation, select ‘Overview’ from the drop-down list directly below the My Innovations folder. You will be taken to a modified version of the submission page where you will be able view, edit, and update the information about the innovation.

Click the ‘Edit’ button to begin the editing process. Note that some fields are not changeable, such as the date. Make sure you click the ‘Update’ button when you are completed to save your work. See Attaching New Electronic Documents for information on including additional documents with your innovation. Click the ‘Update’ button when you are finished editing. This will save your changes to the database. Click the ‘Print’ button to get a hardcopy of your innovation.

Delete Innovation

To delete a “private” innovation, simply highlight the innovation in you're my Innovations folder, and then select ‘Delete Private Innovation’ from the drop-down list directly below the My Innovations folder. The innovation will now be deleted. Note: you cannot delete innovations that have been made public. This prevents unauthorized deletion of your innovations. If you have made an error talk with your system administrator, click Contact Information for more information.

See Also

Private/Public Innovations

Attaching New Electronic Documents

While in edit mode (Overview Innovation), you can add new electronic documents to your innovation. In order to preserve the integrity of your original documents, they are not changed when you make additions—even if the document name is the same. When you add new documents, click on the ‘Browse.’ button as you had done when you submitted the documents the first time. When you add documents this way, the system automatically determines if the file names are the same, and if so, automatically creates a new version-without deleting the original.

Perform Analysis Overview

When you want to perform an analysis on a particular innovation or if an innovation has been e-mailed to you with a request to perform an analysis, select ‘Perform Analysis’ from the drop-down list directly below the My Innovations folder to begin the process. You will be presented with a series of questions

See Also

Entering Analyses

Analysis Results

For a step-by-step guide, click Performing an Analysis on an Innovation

Entering Analyses

You will be presented with a series of questions, and for each you will be asked to answer with a number (usually) between 1 and 10. For each question, you can enter any number between 1 and 10 including decimals—even for questions with a yes/no answer. In all questions, the number one (1) will represent the lowest possible score to a question, and the number ten (10) will represent the highest possible score. You should read the questions carefully, as the answers for different questions can be the same, but be graded on different scales. For example, the question “Do you add chemical preservatives to your product during the manufacturing process” might have 1=no, 10=yes as answers for a product where your customers are very concerned about shelf-life and spoilage, whereas the same question might have 1=yes, 10=no as answers for a product where your customers are allergic to certain food additives.

{bmct perform_analysis.bmp}

As described above, you can also enter any number between 1 and 10, even for yes/no answers. In this case, you might think the answer is yes, but you may not strongly agree, in which case you enter a 6. Similarly, you might disagree with a question, but instead of answering 1 as a strong ‘no’, you might enter 3, because you are not completely against the question.

As you enter each answer from 1 to 10, the bar graph at the top of page records your results. It is important to note that your answers are weighted with a ‘company average’, so even if you enter the highest mark for a question, a ‘10’, the weighting might make the answer slightly lower. In the same way, the weighting could also make a ‘1’, slightly higher.

It is also important to note that your answers will be averaged with other analyses that have already been performed. For example, if you gave a particular question a ‘10’, and someone else gave the same question a ‘2’, then the average would be in between 2 and 10.

Finally, if you do not know the answer to a question, or prefer not to answer, then leave the answer blank. Questions with blank answers are not averaged, so they do not total into the final score.

Tips

For a step-by-step guide, click Performing an Analysis on an Innovation

Analysis Results

This is a summary overview of all of the analyses that have been performed on a particular innovation. It includes a graphical representation of the total, along with information about the people who performed the analyses and their individual scores. When you enter your score from ‘1’ to ‘10’, the bars shown on the chart in the Perform Analysis page are unweighted. In other words, if you enter a ‘10’, it will show up as a ‘100%’ on the bar chart. In the Analysis Results page, the scores you gave are weighted. For example, if you answered all of the questions in the TECHNICAL section of the analysis page with a ‘10’, the score is weighted according to strategic priorities. So, the questions in the TECHNICAL section may have only been given a weight of 30%. This would mean that the highest possible score would be 30% for the TECHNICAL bar on the Analysis Results page. If you answered less than ‘10’, then the bar would show a result less than 30%. The overall total score represents the summation of all of the weighted scores.

### EXAMPLE

Essentially, the analysis process comes up with a number between 1-100 based on your answers. Assume there are two Factors, Marketing and Technical, each with two questions as described below:

Marketing=30% of total score

Q1. How large is the market? (1−10)=you answer 5

Q2. Is it a good market? (1−10)=you answer 10

Technical=70% of total score

Q1. Is this a good technology? (1−10)=you answer 8

Q2. Is it easy to make? (1−10)=you answer 2

This shows that Marketing factors are weighted 30% of the total score, whereas, Technical factors are 70% of the score. So, if both marketing questions were answered 10 each, the total marketing score would be 20. In this case, the answer is (5+10)=15 out of a possible 20, or 15/20=0.75, but then you need to multiply by 30%, so 0.75*0.30=0.225. Therefore, the total weighted Marketing score is 22.5%. The technical score is ((8+2)/20)*.70=0.35, or 35%, so the overall score is 22.5%+35%=57.5%

{bmct analysis_results.bmp}

Activity Log

In order to provide a higher degree of feedback on your innovations, you can track the amount of activity as it relates to any of your innovations. The Activity Log feature tracks both automatic activities, such as when/who performed an analysis, when/who read your innovation, or manual activities such as a status change. Select ‘Activity Log’ from the drop-down list directly below the My Innovations folder to retrieve this information.

Because there can be a fairly large amount of data in the Activity Log, checkboxes are provided that allow you to select which information you want displayed. Click on the checkboxes to view data, or uncheck to remove the data. Use the Check All and Uncheck All links to either check all of the boxes or uncheck all of the boxes.

{bmet activity_log.bmp}

Search Agent Overview

Search agents are search “helpers” that look through the Innovator database to find innovations similar to those in you're my Innovations folder. Their purpose is to help you to quickly find innovations that are duplicates or where there might be areas of overlap and potential collaboration. You can quickly determine whether a search agent has located new information by checking to see if there are any results under the column labeled ‘Search Agent’. (An Innovator Notice will also appear indicating new results, see Innovator Notices for more information). Each time you submit a new innovation, a search agent is automatically configured for you (you can delete it later if you prefer). It will automatically search for similar innovations based on the keywords and description that you entered for your innovation. After it performs its initial search, it will periodically (typically once a day) search the Innovator database for new innovations using the same criteria. In this way, you will be notified of any new information concerning your innovation, and both parties can benefit. Click the ‘Save Search’ button to save any changes that you make to the search agent. Click the ‘Reset’ button to reset the search agent to its original state.

{bmct search_agent.bmp}

Advanced Options

Search Results

Search Terms

Enter search terms based on the information that you are trying to find, separated with a comma. Note that you have several choices about how your search is performed:

You can require that search results contain ALL of your words/phrases by entering using the Results MUST CONTAIN ALL text box. You can require that search results contain SOME of your words/phrases by entering using the Results SHOULD CONTAIN SOME text box. You can require that search results NOT contain any of your words/phrases by entering using the Results MUST NOT CONTAIN ANY text box. You can enter either words or phrases, both of which are separated by commas. Phrases do not need to include quotes (but it is OK if they are), and they can be intermixed with single words, for example: golf, PGA, Arnold Palmer. Other examples: wooden roller coaster, swings, amusement park, city chemicals golf, PGA, Arnold Palmer plants, biology plants, test tube. Searches are not case sensitive. All letters, regardless of how you type them, will be understood as lower case. Other things to consider:

Use commas around phrases, names or titles that appear together, for example: apple pie, will look for the phrase “apple pie” in a document, whereas apple, pie will look for “apple” and “pie” in a document Single words do not need to be included in quotes, and they can be intermixed with phrases, for example, golf, PGA, Tiger Woods, golf club, tee You must put commas between words and/or phrases.

For information on Advanced Options, click Advanced Options.

Advanced Options

When you click the check box that says ‘Advanced Options’, a new form appears that allows you to further refine your search. Initially, the search agent is configured to return results for all departments, locations, innovation types, and protection levels. In Advance Options, you can limit the results by allowing results only in certain departments, locations, innovation types, or protection levels. For example, if you only wanted results from one location, say, Pittsburgh, then just select ‘Pittsburgh’ from the drop-down list. Remember to click on the ‘Save Search’ button to save your search. Also note, that your search won't be activated until the search agents are run for your system. Typically, this happens once a day and is configured by the system administrator.

Search Results

These are the results from the search agents. Note that search agents are attached to a particular innovation, thus the search results pertain to only one innovation. To see the results for a particular innovation, highlight the innovation and select ‘Search Results’ from the home page. Lists of innovations that match your search agent criteria are displayed for review. Double-click on any of the results to view an overview of the innovation.

{bmct search_results.bmp}

Forwarding Overview

From time to time, it may be necessary or desirable to send an innovation to a peer, supervisor, team member, review committee, or any number of other people for their help. This feature allows the author/manager of an innovation to easily perform this task.

1. Highlight the innovation that you want to forward in you're my Innovations folder, and then select ‘Forward’ from the drop-down list directly below the My Innovations folder.

2. To start, select the Forward To, by picking one of ‘Selected Users’, ‘Experts’, or ‘Review Committee’ from the drop-down list. Each type displays a different type of user list as described in the next paragraphs.

a. If you pick ‘Selected Users’, then you click on the ‘Add’ button to bring up a list of all users within the Innovator. See the help under Entering/Deleting/Changing Inventors for more information on how to select users.

b. If you pick ‘Experts’, then when you click the ‘Find’ button, the Innovator will search the Profiles database for people who have expertise that matches the keywords/description of the innovation. Remove people who you don't want to send your innovation to by first removing them from the list of selections.

c. If you pick ‘Review Committee’, then you will be presented with a drop-down list of available review committees. Select your desired committee, and then click the ‘Forward to All’ button to send the innovation to all members of the committee.

3. Clicking on the ‘Forward to All’ button will send messages to everyone on the list.

See Also

For a step-by-step guide, click Finding Experts and Forwarding an Innovation

{bmct forward_to_users.bmp}

Finding Experts

If you are trying to figure out whom to send your innovation to for review, you can automatically find experts in the Innovator based on your innovation's description/key words, and the expertise entered in other people's Profiles.

There are two ways to find experts. First, you can find experts while you are forwarding an innovation. In this case, click on Forwarding Overview for more information. Second, you can select the menu item under Collaboration called Find Experts. In this case, simply enter the text/expertise that you want to use to find experts and then click on the ‘Find’ button.

{bmct findexperts.bmp}

Click the ‘Find’ button; the Innovator will search the Profiles for people who have expertise that matches the keywords/description of the innovation.

Advanced Options

When you click the check box that says ‘Advanced Options’, a new form appears that allows you to further refine your search. Initially, the search will return results for all departments and locations. In Advance Options, you can limit the results by allowing results only in certain departments or locations, or within certain fields such as Expertise, Publications, Research, or Interests. For example, if you only wanted results from one location, say, Pittsburgh, then just select ‘Pittsburgh’ from the drop-down list.

You can also select ‘Exact Word Matching’ to further limit the results. With this checked, the results will contain only the exact words you type in. For example, if you did NOT have this box checked and you entered the work ‘play’, the results would contain ‘play’, ‘plays’, ‘player’, and ‘playing’.

Review Request Overview

When other Innovator users ask you to perform an analysis of their innovation, a message is shown on your home page, and a link to the innovation is placed in Review Requests.

{bmct review_request.bmp}

To review the request, select the innovation by highlighting and then click the ‘Overview’ button. You are then shown the innovation details and can then perform an analysis. After you complete the analysis, the innovation will be cleared from My Review Requests and your home page will be updated.

If you do not wish to perform an analysis, click on the link. By declining, the innovation will be automatically cleared from My Review Requests as well as your home page and the status of the innovation will be updated.

Education Center Overview

The Education Center is a collection of information that your company/organization believes is important to a better understanding of intellectual property. It contains information on your organization's intellectual property goals and procedures, as well as links to other information sources.

Collaboration Agents Overview

Collaboration agents perform searches in the entire Innovator database looking for the keywords that you enter. The primary difference between collaboration agents and search agents are that search agents are attached to specific innovations and return results based on a particular innovation. Collaboration agents are more general, and are not associated with any particular innovation. For example, you may have a collaboration agent to look for new camping locations, bicycles, semiconductor experts, or chemical formulae. When the collaboration agent “finds” new information on bicycles, it will automatically let you know. This allows you to keep current on happenings within the Innovator database without performing daily searching.

To Create a New Agent:

On the main menu, click on Collaboration, then Collaboration Agents, finally, click on the ‘New Agent’ button. Click New Agent for step-by-step instructions.

To Edit an Agent:

To change an already configured collaboration agent, click ‘Edit.’ You can now change any of the fields or keywords. Remember to click the ‘Save’ button to save your changes. Click Edit Agent for more details.

To Delete an Agent:

To remove an agent from your list, simply highlight the entry and click ‘Delete’. You will be asked to confirm the deletion, and then the agent will be deleted.

To See Agent Search Results:

To see the results of the collaboration agents, highlight the desired agent and click ‘Results’

Tips:

If you get the error, click Common Problems for help with collaboration agent keywords.

Click Collaboration Advanced Options for information on advanced search options.

{bmct collab_agent_list.bmp}

New Agent

This is where you create new collaboration agents.

1. Start by entering the name for the new collaboration agent. It is helpful to name it something that represents the type of information that you are looking for, such as “New Kitchen Appliances,” or “Stereo Speakers.” 1. Next select the Type of agent you want to create. You can create agents that search exclusively in the Profiles, Innovations, or both. You must pick one. Once you select the type, the appropriate form will be displayed. 1. In the column labeled Search Category, select the field that you would like to search from the drop-down list. If you would like to search through all of the fields, i.e., keywords, description, expertise, etc., then just select All. Otherwise, you can pick a particular field. 1. Once you have decided on the fields to search, enter the search terms separated with a comma. Note that you have several choices about how your search is performed: You can require that search results contain ALL of your words/phrases by entering using the Results MUST CONTAIN ALL text box. You can require that search results contain SOME of your words/phrases by entering using the Results SHOULD CONTAIN SOME text box. You can require that search results NOT contain any of your words/phrases by entering using the Results MUST NOT CONTAIN ANY text box. You can enter either words or phrases, both of which are separated by commas. Phrases do not need to include quotes (but it is OK if they are), and they can be intermixed with single words, for example: golf, PGA, Arnold Palmer. Other examples: wooden roller coaster, swings, amusement park, city chemicals golf, PGA, Arnold Palmer, golf club, tee plants, biology plants, test tubel. When you are finished, save your agent by clicking on the ‘Save’ button.{bmct collab_agent_edit.bmp}

Tips:

If you get the error, click Common Problems for help with collaboration agent keywords.

Click Collaboration Advanced Options for information on advanced search options.

Edit Agent

To change an already configured collaboration agent, click ‘Edit.’ You can now change any of the fields or keywords. Remember to click the ‘Save’ button to save your changes.

1. In the column labeled Search Category, select the field that you would like to search from the drop-down list. If you would like to search through all of the fields, i.e., keywords, description, expertise, name, etc., then just select All. Otherwise, you can pick a particular field. 1. Once you have decided on the fields to search, enter the search terms separated with a comma. Note that you have several choices about how your search is performed: You can require that search results contain ALL of your words/phrases by entering using the Results MUST CONTAIN ALL text box. You can require that search results contain SOME of your words/phrases by entering using the Results SHOULD CONTAIN SOME text box. You can require that search results NOT contain any of your words/phrases by entering using the Results MUST NOT CONTAIN ANY text box. You can enter either words or phrases, both of which are separated by commas. Phrases do not need to include quotes (but it is OK if they are), and they can be intermixed with single words, for example: golf, PGA, Arnold Palmer.

### OTHER EXAMPLES

wooden roller coaster, swings, amusement park, city chemicals golf, PGA, Arnold Palmer, golf club, tee plants, biology plants, test tubel. When you are finished, save your agent by clicking on the ‘Save’.

Click Collaboration Advanced Options for information on advanced search options.

Collaboration Advanced Options

When you click the check box that says ‘Advanced Options’, a new form appears that allows you to further refine your search.

You can continue to add additional fields/search text by following steps in Edit Agent above. Simply select a field from the drop-down list and then enter search phrases as detailed above. In addition, you can decide whether to include additional search phrases with either ‘AND’ or ‘OR’. If you select ‘AND’, then all of the search phrases must be met in order to return results. If you select ‘OR’, then either search phrase will return results. For example, if you had: Search Category Search Text

Keywords golf, PGA

OR Description links

OR Description Arnold Palmer

This would return any innovations that contained ANY of the following: golf, PGA, links, Arnold Palmer. Whereas, if you had this example:

Search Category Search Text

Keywords golf, PGA

AND Description links

AND Description Arnold Palmer

This would return any innovations that contained ALL of the following: golf, PGA, links, Arnold Palmer

Initially, the agent is configured to return results for all departments and locations. In Advance Options, you can limit the results by allowing results only in certain departments or locations. For example, if you only wanted results from one location, say, Pittsburgh, then just select ‘Pittsburgh’ from the drop-down list. Remember to click on the ‘Save’ button to save your search. Tips

Note, that your search won't be activated until the search agents are run for your system. Typically, this happens once a day and is configured by the system administrator.

{bmct collab_agent_advanced.bmp}

Comments Overview

Users can view discussion/comments on all of the innovations in the Innovator as well as view and add comments to any particular innovation. Comments are multi-faceted and contain more than just the musings of interested parties. In addition to comments, other innovators can add “resources” to the innovation to contribute toward their eventual success. The resources required to “test” the innovation—in other words, what do you need to make your idea work—were initially entered by the inventor(s). For more discussion on what “resources” are all about, click on Adding Required Resources. Now, others can begin to contribute towards the goal. To this end, users can:

Find an innovation, or view all the comments for all the innovations. View the comments for the innovation. Add comments/resources to the innovation.

To begin,

1. Click on the ‘All Comments’ menu item under the Collaboration menu. This page initially displays the most recent comments made on any of the innovations during the past week. To display more innovation comments, click on any of the choices, i.e., 1 month, 3 months, and then click on the ‘Apply Filter’ button to refresh the list.

2. To view a comment, double-click on any comment in the list.

3. To add a new comment, click on the ‘Comment on this Innovation’ button.

4. To view all of the comments for the current innovation, click on the ‘All Comments on this Innovation’ button.

Adding Comments

Users can add free form comments to any of the innovations in the Innovator. For more discussion on what “resources” are all about, click onAdding Required Resources.

To add comments to a particular innovation:

1. Find the innovation by using the Search button in the top right hand corner, or reviewing the list of all the public innovation by clicking the ‘All Public Innovations’ menu item.

2. Once you have located the innovation, either highlight and select or double-click to view the overview.

3. Click on the comments link at the top of the page, you will see a page listing all of the comments made on that particular innovation.

{bmct view_comments.bmp}

4. Click on the ‘Add a Comment’ button on the bottom of the page, you will see a page with a text input section.

{bmct add_comment.bmp}

5. Add your comment in the text box. If you would like to contribute time, money, equipment, or other resources to see the innovation towards its goal, then add the contribution that YOU CAN PERSONALLY MAKE to the innovation. These resources will be listed along with your comments for everyone to see.

Viewing Comments

There are three types of comments that are available, public comments, analysis comments, and status change comments. Public comments can be made by anyone in the system (who has security permissions to view your innovations). Analysis comments can optionally be made when someone performs an analysis on your innovation, such as a review committee member. Status Change comments can be optionally made when someone (typically a manager or review committee member) changes the status of your innovation. To view the comments for a particular innovation, there are two methods.

1. If you are the inventor of the innovation:

a. Highlight the innovation you wish to view comments on from My Innovations on the home page.

b. Select ‘Add Comment’ from the drop-down list directly below the My Innovations folder, you will be taken to the Comments page.

2. If you are NOT the inventor of the innovation:

a. Find the innovation by using the Search button in the top right hand corner, or reviewing the list of all the public innovation by clicking the ‘All Public Innovations’ menu item.

b. Once you have located the innovation, either highlight and select or double-click to view the overview.

c. Click on the comments link at the top of the page, you will see a page listing all of the comments made on that particular innovation.

Showcase

The Showcase is an area where different departments and/or locations can “showcase” their most promising, most interesting, or more important innovations. The Showcase allows departments/locations to pick innovations from their own pool of ideas to display prominently. For users, it provides a quick demographic overview of the department/location and insight into what innovations they feel are the most important to show “outsiders.”

This section is located under the Collaboration menu item. To use this section, click either the department or location radio button, and then select a department of location from the drop-down list. The information will then be displayed.

My Profile Overview

My Profile is your customizable place for biographical data. Information that you enter in this area will be available to anyone using the Innovator to find experts or perform keyword searches. In general, you should not try to limit the descriptions in this area, but rather be as detailed as possible. Even if you are “not an expert”, enter the information anyway. Remember, that Innovator users will be able to review your information before they collaborate/talk with you. If they don't think you're the right match, they probably won't pick you. If you don't enter anything, you'll be possibly missing out on new opportunities.

See Also

Learn how to enter Expertise and other searchable Profile information in a step-by-step guide, click Entering Biographical Information into My Profile

Edit Profile

Review Profile

Edit Profile

This is where you enter information about yourself into My Profile. The first thing to notice is that you can select the information that you do/don't want to show to others. By clicking on the check boxes, you activate text areas where you can enter information. For example, if you would like to enter information about your interests, click on the check box marked ‘Include/Publish Interests’. An area for you to enter your interests will be displayed and you can enter whatever interest areas you like. Remember to click the ‘Update’ button to save your changes. To change information such as your title, department, or e-mail, simply select the data with your mouse and then modify as you would in any other application. Remember to click the ‘Update’ button to save your changes.

Review Profile

This is the information from you're my Profile that will be visible to others in the Innovator. Make changes in Edit.

All Public Innovations Overview

This area lets you view all of the public innovations currently in the Innovator (subject to your protection level and security). Other than more columns and details, this section behaves identically to My Innovations. To reduce the number of innovations displayed, you can restrict the innovations by selecting a Department and/or Location to view from the two drop-down lists. For example, if you only wanted to see innovations in the Pittsburgh location, simply select ‘Pittsburgh’ from the drop-down list and then click on the ‘Apply Filter’ button.

Logging into the System

This screen authenticates and sets up your access into the system as determined by the Administrator. There are two basic methods that might be implemented—both of which are setup by the Administrator: Automatic Network Login, and System Login.

Automatic Network Login (NT Authentication)

In this method, login will occur automatically, as the Innovator will validate you as a user using the password that you have already used to enter into your organization's network.

If you are automatically logged in, and you determine that you have been logged in as the wrong user, for example, you are John Smith, but you have been automatically logged on as Bill Miller, then click on the ‘I am not Bill Miller’ link under the Logout button on the left-hand side of your screen. You will then be prompted to enter your correct name and submit this information. This will then be sent via e-mail to your system administrator for correction. In this case, please contact that person for more details. See also Contact Information for more information.

If you are NOT logged in automatically, it usually indicates that you are not a user in the Innovator, and the Innovator was unable to determine your identity via your organization's network. In this case, click on the “Click here to create a new login” link. You will be directed to a form that asks you to fill out certain information about yourself. All fields marked with a red asterisk—with the exception of Expertise—are required to be completed. Please check to make sure your E-mail Address is correct, if not, correct your E-mail Address, before you move to the next field. Note that all of these fields can be changed in My Profile once you are logged in.

{bmct login_createnew.bmp}

The first time that you use the Innovator, you will be asked to download software in order for the system to operate properly. You will be presented with a series of pop-up windows that look similar to this one:

Submitting a New Innovation

Populate the data fields necessary to capture, track, analyze and share a new idea submission. In many cases, this page will replace the invention disclosure document. See also Submitting a New Innovation Overview. To enter new ideas:

Required Data:

1. Enter the Innovation Name. 1. Use the drop-down list to select the Innovation Type. 1. Use the drop-down list to select the Submit To department this innovation should be sent to for review. In most cases, the innovation will be sent for review within your own department/location. However, if you have an idea for another department/location, then select a different department from the list, if available. 1. Enter all of the appropriate Keywords for this innovation. Keywords are unique words that help to identify this innovation. Separate all Keywords with commas. They will be used to set up searches, find experts and assist with collaboration throughout the system. Additional Keywords can be added later. 1. Enter an appropriate Description for this innovation. 1. Check the Publish This Innovation Now box to share your innovation with all of the users within the Innovator. 1. If you are not the only inventor/contributor, then perform step #10 below. 1. Perform any Optional Step as described below. 1. Click the Save In My Innovations button to log this submission as “Private” in your “file cabinet”. Private submissions cannot be seen by anyone except the submitter. The submitter must make a submission “Public” to enable sharing and start the formal review process.

{bmct submit.bmp}

Optional Steps:

1. Other Inventors/Contributors: If there are users in addition to yourself who participated in the development of this innovation, click on the Add button to see a list of registered users. Select all Contributors/Inventors from this list. You can use the “standard windows” features of <Shift> and/or <Ctrl> for multiple user selections. Use the Remove button to remove a selected (one or multiple) Contributor/Inventor from the list. Use the Remove All button to clear the entire list of Contributors/Inventors. See more information in Entering/Deleting/Changing Inventors. 1. If you have Electronic Documents, Misc/Paper Documents or know of Required Resources related to this submission, click on the appropriate box to open that window.

a. Electronic Documents: After clicking on the check box for Electronic Documents, the window opens to allow you to add or remove Electronic Documents associated with this submission. To attach a new document, click on the Add button. A familiar-looking Windows™ Select box will open, allowing you to browse and select the Electronic Document you wish to attach. Select all of the Electronic Documents from this window you wish to attach. You can use the “standard windows” features of <Shift> and/or <Ctrl> for multiple user selections. Use the Remove button to remove a selected (one or multiple) Electronic Document from the list. Use the Remove All button to clear the entire list of Electronic Documents.

a. Misc/Paper Documents: After clicking on the check box for Misc/Paper Documents, the window opens to allow you to add other items associated with this submission. To associate a non-electronic items (drawing, sketch, white paper, lab notebook, etc.), fill in the requested information.

i. Title: What is the Title of this Paper Document?

i. Type: Use the drop-down list to select the type, i.e., White Paper, Lab Notebook, Sketch, etc.

i. Location: Where is it? (File Cabinet, Safe Deposit Box, Office, etc.)

a. Required Resources: After clicking on the check box for Required Resources, the window opens to allow you to add Required Resources you believe may be required by this submission. To identify Required Resources, fill in the requested information.

i. Person-Hours: How many hours do you think this submission will require to develop to the next stage?

i. Equipment Needed: What physical resources will this submission require? (computers, test gear, floor space, etc.)

i. Budget: How much do you think it will cost to develop this submission? When you complete this step, proceed to Step 2: Performing an Analysis on an Innovation.

Entering Biographical Information into My Profile

Enter information about yourself into your own biographical information page. Data entered here defines your interests and expertise for other users to refer to you as an “expert” for searches and routing. Many of these fields may have been populated from the initial Create New Login Screen. (if this was configured by your administrator). However, users have the option to enter additional details to complete their profile. See also My Profile.

Publishing/Layout: Select which fields you want to populate and display within your View Profile page. Click the checkboxes you want in order for the corresponding data-entry box to appear.

{bmct my_profile_boxes.bmp}

Enter Profile Data and View:

1. Click the checkbox for which you want to enter data. 1. Complete the requested information with as much detail as possible. 1. Click on the Save button at the top or bottom of the page. (You only need to click the Save button once for all changes)

Biographical Information:

1. You can edit any of the Biographical Information that came from the Create New Login page and is displayed here. Note: The Create New Login page is not displayed for all users. The System Administrator can initially set it up for you. 1. You must select a Manager.

a. Click on “Select Manager” below the Manager box in the Biographical Information window.

a. If your Manager is not in the pop-up User Select box, you may select yourself as a manager. Highlight your name and click the Select button.

a. If your Manager is in the pop-up User Select box, highlight his/her name and click the Select button. 1.Click on the Save button at the top or bottom of the page. (You only need to click the Save button once for all changes)

When you complete this step, proceed to Step 6: Creating a Collaboration Agent.

Performing an Analysis on an Innovation

Measure your submission against the standardized question set established by the company. Public submissions can be forwarded to other users for a more diverse sampling. The questions are pre-selected by the Innovator Administrator. It provides a standard against which all submissions are equally compared. See also Perform Analysis Overview.

1. From you're my Innovations list, highlight the submission you wish to analyze, then select ‘Perform Analysis’ from the drop-down list. 1. If you are unfamiliar with the submission, take the time to read the description before answering the questions. Understand the technology, science, and process-before you analyze it. 1. You can navigate to the next question by pressing the <Tab> key or by using your mouse. 1. READ CAREFULLY, and answer the questions on a scale from 1 to 10 with one (1) being lowest or “of least significance,” and with ten (10) being highest or “of most significance.” (Your organization's scale could be between 1 and 5, or any other two low/high number combinations.) 1. It is best if you answer every question, as they are helping to apply a standard against all submissions. If a question either cannot be answered with your knowledge, or truly “does not apply”, simply move on to the next question. 1. Add comments, if desired, into the comments text box. 1. Click the Submit Completed Analysis button when you have answered all of the analysis questions. 1. After submitting your Analysis you will return to the Innovation Home page. From here, you can review the graphed results of the analysis by selecting ‘View Analysis Results’ from the drop-down list directly below the My Innovations folder. There you will see the graphed results and total score. The highest score is 100. When you complete this step, proceed to Step 3: Finding experts and forwarding an innovation.

Make an Innovation Public

This allows your innovation to become part of the public innovation database. Your facilitator and/or manager will also be able to view it as well. Once you are satisfied with our innovation and want to change it from private to public, follow this procedure. See also Private/Public Innovations.

1. Highlight the submission you wish to make public from My Innovations on the home page 1. Select ‘Make Innovation Public’ from the drop-down list directly below the My Innovations folder. The innovation will now be available to everyone in the Innovator who has the appropriate security level. In addition, the innovation will now be visible to your facilitator/manager for review.

OR

1. Highlight the submission you wish to make public from My Innovations on the home page 1. Select ‘Overview’ from the drop-down list directly below the My Innovations folder. 1. Click on the Edit button to allow changes to be made to the innovation. The Make Public button will be activated. 1. Click on the Make Public button. The innovation will now be available to everyone in the Innovator who has the appropriate security level. In addition, the innovation will now be visible to your facilitator/manager for review.

OR

While preparing a new innovation for submission, you can check the box labeled Publish Innovation Now. This will automatically save the innovation in you're my Innovations on the home page and share it with other users in the system.

If you don't explicitly ‘Make Public’ your innovations, no one will be able to see them.

When you complete this step, proceed to Step 5: Entering Biographical Information into My Profile.

Finding Experts and Forwarding an Innovation

Find experts within your organization who can help you improve and analyze your innovation. You can send your innovation to experts, specific individuals, or review committees. As you submit your innovation, you enter keywords and a description of your innovation. Based on these keywords, experts can be found by looking for these same keywords in the other people's My Profile. Remember that people who you find as experts, are not notified unless you specifically request their help. See also Forwarding Overview and Finding Experts.

{bmct forward_to_users.bmp}

To find and forward your innovation to an expert, follow these steps:

1. Highlight the submission you wish to send to someone from My Innovations on the home page. 1. Select ‘Forward’ from the drop-down list directly below the My Innovations folder, you will be taken to the Forward Innovation page. 1. Select from one of the choices below and follow the directions.

To Find an Expert

a. in the drop-down list labeled Forward To, select Experts.

a. Click on the Find button and a search will be automatically using the keywords you entered for your innovation. If you are not finding the right kind of experts, go back and change the keywords on your innovation. (Click Overview from My Innovations, then click Edit)—OR, you can click on the Collaboration menu item and then select ‘Find Experts’ for a more advanced searching tool.

a. The names of the experts will be placed in the table. Review the names and remove anyone who you would not like to send you innovation to by clicking on the Remove button.

To Find an Individual

a. in the drop-down list labeled Forward To, select Selected Users.

a. Click on the Add button and a pop up window will be displayed with a list of Innovator users. Locate the individual(s) that you want by either double-clicking on the highlighted name, or by highlighting a name and then clicking the Select button.

a. Use the drop-down lists labeled Departments, Locations, User Groups, and Review Committees to reduce the number of people show in the list. For example, to list only the people in New York, select ‘New York’ from the Location drop-down list and then click the Apply Filter button. Now only people from New York will be listed. Continue to select names as described above.

a. The names of the people you selected will be placed in the table. Review the names and remove anyone who you would not like to send your innovation to by clicking on the Remove button.

1. After you have removed anyone from the table that you DO NOT want to send your innovation to, click on the Forward to All button, and each of those individuals will receive an E-mail message indicating that your innovation was sent to them for review. When you complete this step, proceed to Step 4: Make an Innovation Public.

Creating a Collaboration Agent

In order to automatically find new innovations/people as they are entered into the Innovator, set up a Collaboration Agent. Collaboration agents perform searches in the entire Innovator database looking for the keywords that you enter. The primary difference between collaboration agents and search agents are that search agents are attached to specific innovations and return results based on a particular innovation. Collaboration agents are more general, and are not associated with any particular innovation. See also Collaboration Agent Overview.

To Create a New Collaboration Agent

1. On the main menu, click on Collaboration, then click Collaboration Agents, finally click on the New Agent button. 1. Start by entering the name for the new collaboration agent. It is helpful to name it something that represents the type of information that you are looking for, such as “New Kitchen Appliances,” or “Stereo Speakers.”1. Next select the type of agent you want to create. You can create agents that search exclusively in the Profiles, Innovations, or both. You must pick one. Once you select the type, the appropriate form will be displayed. 1. In the column labeled Search Category, select the field that you would like to search from the drop-down list. If you would like to search through all of the fields, i.e., keywords, description, expertise, etc., then just select All. Otherwise, you can pick a particular field. 1. Once you have decided on the fields to search, enter the search terms separated with a comma. Note that you have several choices about how your search is performed: You can require that search results contain ALL of your words/phrases by entering using the Results MUST CONTAIN ALL text box. You can require that search results contain SOME of your words/phrases by entering using the Results SHOULD CONTAIN SOME text box. You can require that search results NOT contain any of your words/phrases by entering using the Results MUST NOT CONTAIN ANY text box. You can enter either words or phrases, both of which are separated by commas. Phrases do not need to include quotes (but it is OK if they are), and they can be intermixed with single words, for example: golf, PGA, Arnold Palmer. Other examples: wooden roller coaster, swings, amusement park, city chemicals golf, PGA, Arnold Palmer, golf club, tee plants, biology plants, test tube 1. Check the Advanced Options checkbox to include advanced search capabilities. 1. When you are finished, save your agent by clicking on the ‘Save’ button.{bmct collab_agent_edit.bmp}

Tips:

If you get the error, click Common Problems for help with collaboration agent keywords.

Click Collaboration Advanced Options for information on advanced search options.

Typical Innovation Flow

This is the typical sequence of steps that you would go through to log into the Innovator, create a new innovation and submit it to you're my Innovations folder, perform an analysis, forward the innovation, and share it publicly. It also includes descriptions of the home page, entering your biographical information, and creating a collaboration agent. If you are having trouble logging into the Innovator, click Logging into the System, otherwise, start with Step 1.

Within this Help system, you can get help on specific subjects by clicking on the Index or Search tab and entering a keyword to get help on that subject. If the Index/Search tabs are not shown, then click on the ‘Show’ button (will be displayed in the upper right hand corner of this help screen) to display the table of contents/index/search tabs.

Step 1: Submitting a New Innovation

Step 2: Performing an Analysis on an Innovation

Step 3: Finding experts and forwarding an innovation

Step 4: Make an Innovation Public

Step 5: Entering Biographical Information into My Profile

Step 6: Creating a Collaboration Agent

Innovator Home Page Features

Common Problems

Contact Information

Common Terms

Downloading Software

The first time that you use the Innovator, you will be asked to download software in order for the system to operate properly. You will be presented with a series of pop-up windows that look similar to this one:

{bmct actXinstall.bmp}

For each pop-up window, click on the ‘Yes’ button to download the software. Each download may take up to several minutes. Do not cancel during this process, as you will not be able to start the Innovator until the downloads are completed. If you inadvertently stop or cancel this process, it will automatically resume when you try to log into the Innovator the next time.

Common Terms

Analysis

Rate an innovation based on a standard set of questions.

Collaboration Agents

Help you find other people and/or innovations within the Innovator. You can set up an “automatic” collaboration agent based on keywords that searches the entire Innovator database for new items that match your interests. The primary difference between collaboration agents and search agents are that search agents are attached to specific innovations and return results based on a particular innovation. Collaboration agents are more general, and are not associated with any particular innovation.

Education Center

Location to get answers to questions on innovation questions such as patenting, searching, and other topics.

Forward

This allows you to send you innovation to other users for review and/or analysis.

My Innovations

Your personal, private storage area for all of the innovations that you are either the author or contributor.

Search Agents

Help you find duplicate/similar innovations within the Innovator. Search agents are automatically created when you enter an innovation. Their primary purpose is to alert you when it finds an innovation that may be similar to one that you have in you're my Innovations. The primary difference between collaboration agents and search agents are that search agents are attached to specific innovations and return results based on a particular innovation.

Review Request

Another user has requested that you review his/her innovation. See Forward.

### Manager Functions

Set Status

To change or update the status of an innovation use this function.

1. Select the desired innovation, then select ‘Set Status’ from the drop-down list in the Innovator Management's All Innovations list, a new window will appear below.

2. Select the new status from the New Status drop-down list.

3. Click the ‘Save Changes’ button to save your work.

{bmct set_status.bmp}

Set Spotlight

Use this function to change the innovation that is displayed in the Spotlight of each user's Innovator home page. When you add a new Spotlight innovation, it is added to the end of a list of previously added Spotlight innovations. When you add the new innovation, you will be given the opportunity to determine the number of days the innovation should be displayed, as well as the order amongst other innovations. You can also remove previously displayed innovations.

As an added convenience, you can locate the currently spotlighted innovation by clicking on the ‘Locate’ button. This is used when you are trying to find the spotlighted innovation in a long list of innovations.

To add a new Spotlight innovation:

1. Select ‘Set Spotlight’ from the drop-down list in the Innovator Management's All Innovations list, and a new window will appear below.

2. To add new innovations to the spotlight list, select an innovation from the Innovator Management's All Innovations list, and then click the ‘Add’ button.

3. To remove innovations from the showcase list, select an innovation from the Setup Spotlight list and then click the ‘Remove’ button.

4. To change the order of the innovations within the spotlight list, select an innovation from the Setup Spotlight list and then click either the ‘Up’ or ‘Down’ button to move the innovation.

5. Use the ‘Overview’ button to see the details for a particular innovation.

6. Click the ‘Save Changes’ button to save your work.

{bmct set_spotlight.bmp}

Reports

In order to get more detailed information on innovations, managers can click on a variety of reports under the Reports menu item.

Management Overview

This is a summary report that displays: Innovations By Year, Innovations By Type, Public vs. Private Innovations, Innovations By Status, Innovations By Location, and Top Inventors. You can select the reports that you wish to display by checking the appropriate checkbox, and the clicking the ‘Save Chart Configuration’ button to save your preferences.

Department Innovations

This report displays the current department hierarchy along with the number of innovations in each department. Click on a department on the left-hand side to see the corresponding chart.

Submissions

A summarization of innovations by department and status. Initially shows innovations for all departments and all statuses, can be changed to display more specific information. Also has an option for displaying data as a bar chart, line chart, or area chart.

Status Track

A summarization of the length of time that innovations have been in various statuses. Initially shows innovations for all department and all statuses, but can be changed to display more specific information. Also has an option for displaying data as a bar chart, line chart, or area chart.

Top Statistics

A listing of the top 10 innovations by viewing (by other users), and the top 10 innovators by successful commercialization.

Key Metrics

Detailed management report that shows the overall activity within the system. Includes statistics about submissions, users, current statuses, productivity indices, and execution times.

Multi-Part Detailed

Note that only ONE button can be clicked in each column!

To use this function, click on one of buttons under the Primary Sort column, and configure appropriately. For example, if you wanted to return on NEW ideas, click on the button next to Statuses, then select NEW from the drop-down list. Optionally, click on one of the buttons under the Secondary sort column and configure appropriately as above. When finished, click on the button labeled ‘Run Report’. When the report is finished, you have the option of saving the report in either Rich Text Format (RTF) suitable for most word processing applications or Comma Separated Values (CSV) suitable for most spreadsheet applications. There is also an option to print as it is displayed by clicking the ‘Print’ button.

{bmct multipart.bmp}

User Data

A detailed report by user that displays 5 Most Recent Innovations, Innovations Updated, Comments Made, Analyzed Innovations, Innovations that an Analysis was declined, Forwarded Innovations, Viewed Innovations, and Trade Secrets Viewed. The run the report, you must select a user by click on the “Select User” link and entering beginning and ending dates.

Collaboration

A summary report that provides an overview of how much collaboration is occurring within the Innovator. Results include information on the number of users who have filled out their profiles, the number of search agents and collaboration agents, how many find experts searches were performed, and the results of various searches/agents.

# $ K @ All Innovations

This area lets you view all of the public innovations currently in the Innovator (subject to your protection level and security). Other than more columns and details, this section behaves identically to My Innovations in the user area.

To reduce the number of innovations displayed, you can restrict the innovations by selecting a Department, Location, Status and/or date to view from the drop-down lists. For example, if you only wanted to see innovations in the Pittsburgh location, simply select ‘Pittsburgh’ from the drop-down list and then click on the ‘Apply Filters’ button. To sort the innovations, click on any of the column titles, such as date, and the innovations are automatically sorted. Clicking on the column again sorts the column in reverse order. In addition, you can change the width of individual columns by centering your mouse in between the columns and waiting for the mouse to change to a vertical line ‘|’ then simply press the mouse button and drag the column to the desired width. Finally, column titles can be rearranged in any order by clicking and holding your mouse on a column and then moving it to the desired location.

{bmct alllnnovations.bmp}

[Management Only Function] Set Status

To change the status of an innovation, use this function. When you change the status, you will also be permitted to add comments associated with the status change, such as next steps, reason for status change, etc. For more information, click Set Status.

[Management Only Function] Edit Protection Information

Use this function to change the protection level of an innovation, e.g., from—Standard Protection—to—High Protection—, make an innovation a Trade Secret, or edit the text displayed for a Trade Secret. This function will be used when there is a desire to “remove” an innovation from general viewing. For example, when you change the protection level from standard to high, normal users will be prevented from viewing/modifying the innovation. For more information, click Innovation Protection Edit

[Management Only Function] Send to Other Department/Change Department

When ideas are initially submitted, they are assigned to a review department based on the user's own department. The assumption is that a user will submit innovations primarily of concern to their own department's priorities. In the case where the innovation is not germane to the originally entered department, use this function to change the department where the idea will be reviewed. Click Change Department for more information.

[Management Only Function] Set Spotlight

To change the innovation currently displayed in the Spotlight on the home page, use this function. Ideas displayed in this space are entered into a queue, and are rotated in sequence based on when it was entered and how long the previous idea is set to display. Click on Set Spotlight for more information.

[Management Only Function] Set Showcase

In order to for each department and/or location to advertise more about itself, the Showcase is available to users from their Collaboration menu. Use this function to add innovations to either a department and/or location. When you enter a new showcase innovation, you can determine where in the list it is displayed. You can also remove previously displayed innovations. For more information, click Set Showcase.

[Management Only Function] Set Challenges

In the interest of spurring focused innovation, the Breakthrough Challenges section presents a list of strategic problems/areas that management would like solved by the general user community. To create a new challenge use this function to enter the name, description, start and end dates. See Set Challenges for more information.

[Management Only Function] Forward Multiple Innovations

From time to time, it may be necessary or desirable to send an innovation to a peer, supervisor, team member, review committee, or any number of other people for their help. This feature allows the manager to easily forward one or multiple innovations. To forward multiple innovations, select the desired innovations from the list. The drop-down list will then include an extra function, ‘Forward Multiple Innovations’. For more information, click Forward Multiple Innovations

Overview

When you want to view the details of a particular innovation, either highlight and double-click or select ‘Overview’ from the drop-down list directly below the My Innovations folder. You will be taken to a modified version of the submission page where you will be able view, edit, and update the information about the innovation.

Click the ‘Edit’ button to begin the editing process. Note that some fields are not changeable, such as the date.

Click the ‘Update’ button when you are finished editing. This will save your changes to the database.

Click the ‘Print’ button to get a hardcopy of your innovation.

Perform Analysis

When you want to perform an analysis on a particular innovation or if an innovation has been e-mailed to you with a request to perform an analysis, click on the ‘Perform Analysis’ button to begin the process. You will be presented with a series of questions

View Analysis Results

This is a summary overview of all of the analyses that have been performed on a particular innovation. It includes a graphical representation of the total, along with information about the people who performed the analyses and their individual scores.

Activity Log

In order to provide a higher degree of feedback on your innovations, you can track the amount of activity as it relates to any of your innovations. The Activity Log feature tracks both automatic activities, such as when/who performed an analysis, when/who read your innovation, or manual activities such as a status change.

Search Agents

Search agents are search “helpers” that look through the Innovator database to find innovations similar to those in the My Innovations folder. Their purpose is to help you to quickly find innovations that are duplicates or where there might be areas of overlap and potential collaboration. You can quickly determine whether a search agent has located new information by checking to see if any of cells under the column Search Agent are colored red. The red color will disappear after you log out—unless new data is found. Each time you submit a new innovation, a search agent is automatically configured for you (you can delete it later if you prefer). It will automatically search for similar innovations based on the keywords and description that you entered for your innovation. After it performs its initial search, it will periodically (typically once a day) search the Innovator database for new innovations using the same criteria. In this way, you will be notified of any new information concerning your innovation, and both parties can benefit.

Search Results

These are the results from the search agents. Note that search agents are attached to a particular innovation, thus the search results pertain to only one innovation. To see the results for a particular innovation, highlight the innovation and select ‘Search Results’ from the home page. Lists of innovations that match your search agent criteria are displayed for review. Double-click on any of the results to view an overview of the innovation.

Forward

From time to time, it may be necessary or desirable to send an innovation to a peer, supervisor, team member, review committee, or any number of other people for their help. This feature allows the author/manager of an innovation to easily perform this task.

Make Innovation Public

One important note is that each time you submit an innovation; its status is set to “Private.” Private innovations are not viewed by anyone but you—not even managers—and are kept in the My Innovations folder. Private innovations can be sent to anyone you choose for review. They are not returned as search results to anyone else. Conversely, everyone with the appropriate security privileges views “Public” innovations. As part of the process of submitting a “Public” innovation, it will be sent to the appropriate review committees/individuals as determined by your organization's distribution policy. To change a private innovation to public, simply highlight the innovation and select ‘Make Innovation Public’ from the drop-down list directly below the My Innovations folder.

Delete Private Innovation

To delete a ‘private’ innovation, simply highlight the innovation in you're my Innovations folder, and then select ‘Delete Private Innovation’ from the drop-down list directly below the My Innovations folder. The innovation will now be deleted. Note: you cannot delete innovations that have been made public. This prevents unauthorized deletion of your innovations.

View Comments

As part of the collaboration process in the innovator, other users can add comments/resources to your innovations—provided they have the appropriate security level. To view all of the comments made on a particular innovation, highlight the innovation in you're my Innovations folder, and then select ‘View Comments’ from the drop-down list directly below the My Innovations folder. A list of all of the comments that have been made regarding this innovation will now be displayed.

Add to Challenge

Breakthrough Challenges are focused areas of innovation that your organization is currently addressing. Use this function to add/submit one of your existing innovations to a challenge.

All Details

To get all of the details associated with an innovation including, status information, other inventors, comments, complete analysis results, attached electronic documents, attached paper/misc items, and innovation details use this function. In addition to viewing the information on your computer screen, you can also print it to your default printer.

Change Department

Innovations have two department designations:

the department of the user who submitted the innovation and,

the department that the innovation is submitted to for review.

When a user submits an innovation, the user's department is assigned (unless the user specifically changes it) to the innovation as the department that will be performing a review. If necessary, managers now change the department where an idea is evaluated by selecting ‘Send to Other Department’ in the drop-down list located under Innovator Management menu. Note you cannot change the user's department, only the department where an innovation is evaluated.

1. Select the innovation to change by highlighting it with your cursor. To reduce the number of innovations displayed, select a Department, Location, Status and/or Date to view from the drop-down lists, and then click on the ‘Apply Filter’ button.

2. Select the department that you want to change the innovation using the drop-down list under New Department.

3. Click on the ‘Change Department’ button to save your work.

{bmct chgDept.bmp}

Innovation Protection Edit

When innovations are submitted, they are automatically given a default security protection. You can use this function to change the protection level, assign the innovation “trade secret” status, change the encryption for viewing, or set the message to display when the innovation is viewed.

1. Select the desired innovation by highlighting it with your mouse.

2. Click the ‘Edit’ button.

3. Select any/all of the items below:

Potential Trade Secret

By selecting this checkbox, the innovation will be changed to a Trade Secret. The Trade Secret indicator will change from ‘N’ to ‘Y’. Once this is checked, the innovation will be indicate that it is a trade secret every time a user performs any action on it, such as read, edit, etc. Trade Secrets carry a specific legal definition.

Current Protection Level

The current specific set of privileges applied to the innovation.

New Protection Level

By selecting a protection level from the drop-down list, you assign a new set of privileges to an innovation. These privileges are determined by the Administrator, and in general, do not need to be changed.

Message to Display When Viewed

This is the text message that will be displayed each time an innovation that is designated as a Trade Secret is viewed, read, etc. The message is displayed at the top of each page.

4. Click the ‘Update’ button to save your changes, click ‘Cancel’ to exit without changing.

{bmct InnProtectEdit.bmp}

Set Showcase

In order to for each department and/or location to advertise more about itself, the Showcase is available to users from their Collaboration menu. When users view a showcase, they select either a department or location to view. The showcase is a display of innovations and comments that either a manager or administrator have entered to describe more about a department/location. Use this function to add innovations and associated comments to either a department and/or location. When you enter a new showcase innovation, you can determine where in the list it is displayed. You can also remove previously displayed innovations.

1. Select ‘Set Showcase’ from the drop-down list in the Innovator Management's All Innovations list, a new window will appear below.

To add new innovations to the showcase list, select an innovation from the Innovator Management's All Innovations list, and then click the ‘Add’ button. Enter any relevant comments.

To remove innovations from the showcase list, select an innovation from the Setup Showcase list and then click the ‘Remove’ button.

To change the order of the innovations within the showcase list, select an innovation from the Setup Showcase list and then click either the ‘Up’ or ‘Down’ button to move the innovation.

2. Click the ‘Save Changes’ button to save your work.

{bmct set_showcase.bmp}

Set Challenges

In the interest of spurring focused innovation, the Breakthrough Challenges section presents a list of strategic problems/areas that management would like solved by the general user community. To create a new challenge use this function to enter the name, description, start and end dates.

1. Select ‘Challenges’ from the ‘Innovator Configuration’ menu within the Administration Functions. Challenges are color-coded based on date: red is used for challenges that are expired, black is used for current challenges, and green for future challenges.

To add a new challenge, click the ‘Add’ button. NOTE: You cannot Add a new challenge if the drop-down lists show ‘All Departments’ and ‘All Locations’. This simply lists all of the challenges in the system.

a. Select a department and/or location from the drop-down lists to indicate where a challenge should be shown. For a challenge that should be viewed by every department and every location, select ‘Global’ and ‘Global’. If you want a challenge to show up under a particular department, select that department, for example ‘Manufacturing’. If that challenge should be shown to all Manufacturing departments in every location, then select ‘Global’ for the location. If instead, you only want the Manufacturing department for a particular location, then select that location from the drop-down list.

b. Enter a title, description, start date, and end date into the appropriate fields.

c. Decide whether to include sub-departments and sub-locations by clicking the Hierarchy checkbox. If you do NOT check this box, then the challenge will only be viewable by users whose department/location matches exactly with what you selected.

To remove challenges from the list, select a challenge from the list and then click the ‘Remove’ button.

To change the order of the challenges within the list, select a challenge from the list and then click either the ‘Up’ or ‘Down’ button to move the challenge.

To view the submissions that have been made to a particular challenge, click on the [+] and a list will appear beneath the challenge. Click on the title of the innovation for an overview or click on ‘Remove Innovation From Challenge’ to delete.

2. Click the ‘Save Changes’ button to save your work.

{bmct set_challenges.bmp}

Add/Edit/Delete Review Committees

Review Committees are groups of users to whom innovations can be forwarded. With Review Committees, a user can send their innovation to a pre-configured group just by selecting the name of the committee.

To Add a New Review Committee:

1. Click on Administrator, then Review Committees, a list of review committees will be displayed.

2. Click on the button labeled ‘New’, enter the name of the new review committee, and then click ‘OK’. You will be taken back to the page with the list of Review Committees.

3. Click the ‘Edit’ button next to the name of the review committee you just entered.

4. Enter a description.

5. Add new members to the review committee by clicking the ‘Add’ button, and then selecting the appropriate names from the list. For help entering/deleting names, click User Name Lookup.

6. Click the button labeled ‘Update’ when you are finished in order to save your work.

To Edit a Review Committee:

1. Click on Administrator, then Review Committees, a list of review committees will be displayed.

2. Click the ‘Edit’ button next to the name of the review committee you want to edit.

3. Add users from the review committee by clicking the ‘Add’, and then selecting the appropriate names from the list. To remove users, click on either the ‘Remove’ or ‘Remove All’ buttons to delete either one or all members. For help entering/deleting names, click User Name Lookup.

4. Click the button labeled ‘Update’ when you are finished in order to save your work.

To Delete a Review Committee:

1. Click on Administrator, then Review Committees, a list of review committees will be displayed.

2. Click the ‘Delete’ button next to the name of the review committee you want to delete.

3. When prompted to delete, click ‘OK’.

User Name Lookup

The User Name Lookup window will automatically retrieve a list of all the users of the Innovator. In order to reduce the list to a more manageable number, you can use the drop-down lists under Departments, Locations, User Groups, and Review Committees. When you select from any of these drop down lists, the list will only include people who meet the criteria you selected. For example, if you selected ‘Pittsburgh’ from the Locations drop-down list and clicked the ‘Apply Filter’ button, then only the people who were located in Pittsburgh would be shown.

{bmct user_name_lookup.bmp}

Once you find the person you would like to add, either double-click on the name or click on the ‘Select’ button—the person will automatically be added to the inventor's list and the window will close. Repeat for multiple inventors. The ‘Select All’ button will return all of the users.

To delete a single inventor from a list of inventors, simply click the ‘Remove’ button. If you would like to clear the entire inventors list, click the ‘Remove All’ button.

{bmct inventors.bmp}

Trade Secret

According to the UTSA (Uniform Trade Secret Act), “Trade secret” means information, including a formula, pattern, compilation, program device, method, technique, or process, that: (i) derives independent economic value, actual or potential, from no being generally known to, and not being readily ascertainable by proper means by, other persons who can obtain economic value from its disclosure or use, and (ii) is the subject of efforts that are reasonable under the circumstances to maintain its secrecy.

Forward Multiple Innovations

From time to time, it may be necessary or desirable to send an innovation to a peer, supervisor, team member, review committee, or any number of other people for their help. This feature allows the manager to easily forward multiple innovations. To forward multiple innovations:

1. Select the desired innovations from the Manager's All Innovations list.

a. To select a block of innovations from the list, first click the first innovation you want with your left mouse button. Next, hold the Shift key down on your keyboard, and then select the last innovation with your left mouse button. The entire block will be selected.

b. To select multiple innovations from the list (that are not in a block), click on each innovation you want while continually holding the Ctrl key on your keyboard. Each time you click on your mouse, a new innovation will be selected. To unselect an innovation, just click on it again.

2. Select ‘Forward Multiple Innovations’ from the drop-down list and the Forward page will be displayed.

3. On the forwarding page, select the Forward To, by picking one of ‘Selected Users’, ‘Experts’, or ‘Review Committee’ from the drop-down list. Each type displays a different type of user list as described in the next paragraphs.

a. If you pick ‘Selected Users’, then you click on the ‘Add’ button to bring up a list of all users within the Innovator.

b. If you pick ‘Experts’, then when you click the ‘Find’ button, the Innovator will search the Profiles database for people who have expertise that matches the keywords/description of the innovation. Remove people who you don't want to send your innovation to by first removing them from the list of selections.

c. If you pick ‘Review Committee’, then you will be presented with a drop-down list of available review committees. Select your desired committee, and then click the ‘Forward to All’ button to send the innovation to all members of the committee.

4. Clicking on the ‘Forward to All’ button will send messages to everyone on the list.

### Administrator Functions

Add/Edit/Delete Review Committees

To add, edit, or delete review committees, click on Administrator, then Review Committees. You will see a list of the current review committee names. Note: You can determine which Review Committees that a user belongs to by selecting ‘Users’ under ‘Company Configuration’ in the Administration Functions menu. Select the user from the list and double-click the user's name to see details, including the Review Committees.

Add New Review Committee

1. Click on the ‘New’ button, a pop-up window asking for the name of the new review committee will be displayed. Type in the name of the new review committee, and click the ‘OK’ button. The name will be saved and displayed on the list of all current review committees.

2. Select the name of the new review committee from the list and click the ‘Edit’ button. A new page will be displayed.

3. Enter a description (optional) of the review committee. You can also edit the name.

4. Enter review committee members by clicking the ‘Add’ button. The User Name Lookup window will automatically retrieve a list of all users. Select names from the list to add to the review committee. See Entering/Deleting/Changing Inventors for more information on this process.

5. Click the ‘Update’ button to save your changes.

Edit Review Committee

1. Select the name of the review committee you wish to edit from the list and click the ‘Edit’ button. A new page will be displayed.

2. Edit the description or name.

3. Enter review committee members by clicking the ‘Add’ button. Remove review committee members by clicking either the ‘Remove’ button or the ‘Remove All’ button. See Entering/Deleting/Changing Inventors for more information on this process.

4. Click the ‘Update’ button to save your changes.

Delete Review Committee

Select the name of the review committee you wish to delete from the list and click the ‘Delete’ button. The system will prompt you to make sure you really want to delete the review committee, click ‘OK’ to confirm.

Entering/Deleting/Changing Inventors

To add users click on the ‘Add’ button. This will open a new window called the ‘User Name Lookup’, with a list of people.

The User Name Lookup window will automatically retrieve a list of all the users of the Innovator. In order to reduce the list to a more manageable number, you can use the drop-down lists under Departments, Locations, User Groups, and Review Committees. When you select from any of these drop down lists, the list will only include people who meet the criteria you selected. For example, if you selected ‘Pittsburgh’ from the Locations drop-down list and clicked the ‘Apply Filter’ button, then only the people who were located in Pittsburgh would be shown.

{bmct IMG00135.bmp}

Once you find the person you would like to add, either double-click on the name or click on the ‘Select’ button—the person will automatically be added to the inventor's list and the window will close. Repeat for multiple inventors. The ‘Select All’ button will return all of the users.

To delete a single inventor from a list of inventors, simply click the ‘Remove’ button. If you would like to clear the entire inventors list, click the ‘Remove All’ button.

{bmct IMG00136.bmp}

Question Sets

This is an overview of Question Sets, you should read this first before attempting to create/edit question sets. For step-by-step guidelines, click Create New Question Set. Question sets are a powerful feature of the Innovator that have several characteristics. First, each question set contains one or more “Analysis Factors.” Analysis Factors are descriptive categories for questions, such as, Marketing, or Technical. Each Analysis Factor has a percentage weight. Within each Analysis Factor, there are one or more questions. For example,

New-to-World (Question Set)

contains Marketing (Analysis Factor)

contains 1. How large is the market? (Question#1)

contains 2. Is it a good market? (Question#2)

contains Technical (Analysis Factor)

contains 1. Is this a good technology? (Question#1)

contains 2. Is it easy to make? (Question#2)

### EXAMPLE

Essentially, the analysis process comes up with a number between 1-100 based on your answers. Assume there are two Factors, Marketing and Technical, each with two questions as described below:

Marketing=30% of total score

Q1. How large is the market? (1−10)=you answer 5

Q2. Is it a good market? (1−10)=you answer 10

Technical=70% of total score

Q1. Is this a good technology? (1−10)=you answer 8

Q2. Is it easy to make? (1−10)=you answer 2

This shows that Marketing factors are weighted 30% of the total score, whereas, Technical factors are 70% of the score. So, if both marketing questions were answered 10 each, the total marketing score would be 20. In this case, the answer is (5+10)=15 out of a possible 20, or 15/20=0.75, but then you need to multiply by 30%, so 0.75*0.30=0.225. Therefore, the total weighted Marketing score is 22.5%. The Technical score is ((8+2)/20)*0.70=0.35, or 35%, so the overall score is 22.5%+35%=57.5%

The administrator has the ability to create, edit, and delete question sets, along with the associated analysis factors and questions.

Create New Question Set

To create a new question set follow these steps:

1. From the administrator menu, click ‘Innovator Configuration’, then click ‘Question Sets’, a list of all the available question sets will be shown.

{bmct Questionset_list.bmp}

2. Click on the button labeled ‘New Question Set.’ Type in the name of the new question set, then click OK, you will be returned to the question set list.

3. Click ‘Edit’ in column next to your newly created question set to add analysis factors.

{bmct Questionset_factor.bmp}

4. Click on the button labeled ‘New Analysis Factor.’ Type in the name of the new analysis factor, then click OK.

5. Click ‘Edit’ in the column next to your newly created analysis factor, you will be taken to the Edit Analysis Factor page.

{bmct Questionset_question.bmp}

6. Enter the Weight of this factor. It must be a number between 1 and 100, and it will represent the percentage that this analysis factor is scaled versus other analysis factors.

7. Add questions by clicking on the ‘Insert New Question’ button. A text box will appear. Type in the question, the minimum and the maximum values allowed for the answer. It's a good practice to use a standard minimum and maximum, such as ‘1’ and ‘10’ to avoid confusion.

8. Continue adding questions and analysis factors until you are completed. Make certain to click on the ‘Save Changes’ link so that you don't lose your questions.

9. After you finish entering questions, make sure to return to the main list of question sets (see #1 above), and click on the ‘Cache All Question Sets’ button. This makes the questions available to the users. Note: Since there can be only one active question set per Innovation Type, this function is necessary so that a partial question set is not inadvertently used. The old question set will continue to be active until this button is pressed.

Innovation Security

The security mechanism within the Innovator system is very extensive and flexible. It distinguishes between security for individual users and groups of users as well as individual innovations and groups of innovations. Generally speaking, you will want to set up several user groups and several innovation protection levels.

User groups allow you to assign privileges to all of the members of a user group. For example, you may want to create a user group called “R&D”, assign all of the people from the Pittsburgh location into that group, and then allow them only to Submit, View, and Analyze innovations.

If you want to set up a new group of users, click User Groups.

In contrast to user groups that assign rights to users, innovation protection assigns groups of innovations to different classes. Classes do not assign privileges; they are merely groups of innovations. These hierarchical classes are then related with specific user groups. For example, you can decide that a specific user group(s) can view innovations that are classified as High, as well as decide that the user group can only view innovations that are “Trade Secrets.” In the example above, the R&D group can Submit, View, and Analyze innovations that are within the High or Low classification. If you want to set up classes for a new group of innovations, click Innovation Protection.

User Groups

User groups allow you to assign privileges to all of the members of a user group. For example, you may want to create a user group called “Read Only” and then assign all of the people from the Pittsburgh location into that group. In addition to assigning people to a group, you will also set the privileges for that group. To get a complete understanding of security, you should read the overview of Innovation Security, and the section about Innovation Protection Groups.

To create a user group:

1. Click on ‘User Groups’ under ‘Security’ in the Administration Functions menu. You will see all of the current User Groups available in the Innovator.

2. Click on the ‘New’ button to add a new group.

3. A pop-up window will ask you to enter the name of the new user group you want to create. Type in a name and click the ‘OK’ button. You will be returned to the main list of groups

4. Select the new user group you just created and either double-click it or highlight and click the ‘Edit’ button. The Edit Group page will be displayed.

5. Add users to the new group by clicking on the ‘Add’ button under the heading User Group Members. Edit the name and/or description as required. To see a list of all the groups that a user is a member of, click on Setup Users in the Administration Functions menu, and select the user. You can also add/change/delete the user from groups in this page, click User Maintenance for more details.

6. Select the appropriate Group Access rights.

Setting Group Access

There are four main types of access to assign in this section: innovation settings, profile settings, innovation management, and administration functions. See the sections below to configure each one.

Innovation Settings

This section will assign the privileges that a group can have with respect to viewing, editing, analyzing, and forwarding an innovation. To begin configuring a section, click on the checkbox labeled ‘Configure for this Group’. Within each section, there are several checkboxes and drop-down lists to configure. Note that not all items are available under each section. Also note that similarly named items such as, View innovations from locations and Edit innovations from locations perform identical functions in their respect sections.

1. Submitting: Allows user to make submissions. If this is not checked the submit page is not shown in the menu.

2. All Public Innovations Page: Allows user to view the All Public Innovations Page. If this is not checked, this page is not shown in the menu.

3. Showcase Page: Allows user to view the Showcase Page. If this is not checked, this page is not shown in the menu.

4. All Comments Page: Allows user to view the All Comments Page. If this is not checked, this page is not shown in the menu.

5. Education Center: Allows user to view the Education Center Page. If this is not checked, this page is not shown in the menu.

6. Search Page: Allows user to perform innovation searches. If this is not checked, then the selection for searching innovations is not shown as an option.

7. Viewing, Editing, Analyzing, Forwarding: Configure these sections to explicitly determine what groups of users can handle what types of innovations.

a. Own Innovations: check this box if you want the Inventor/Author to be able to [view-edit-analyze-forward] his/her own innovations.

b. Contributing Innovations: check this box if you want contributors to be able to [view-edit-analyze-forward] their own innovation. Contributors are people who are added to an initial submission by the original submitter. By default the person who submits the innovation is the author and other inventors are called contributors. In most cases, if you allow an author to have a right you should also allow the contributors to have the same right

c. Subordinate's Innovations: check this box if you want managers to be able to [view-edit-analyze-forward] their direct reports' innovations.

d. Forwarded Innovations: check this box if you want this group to be able to [view-edit-analyze-forward] innovations that are forwarded to them.

e. [View-Edit-Analyze-Forward] innovations from department: With this drop-down list you can decide what departments a person in the group can [view-edit-analyze-forward]. If you select ‘Any’, then this group will be able to [view-edit-analyze-forward] innovations. If you select a specific department, then it will be limited to that department. In addition, since departments are set up with a hierarchy, you can decide that the group can only [view-edit-analyze-forward] the selected department, or all sub departments as well. If you select ‘None’, then the group will not be able to [view-edit-analyze-forward] any innovations.

i. In this case where ‘None’ is selected, it will cancel out any other selections, meaning that the group will not be able to [view-edit-analyze-forward] any innovations. It will also not matter whether you have any settings in the location drop-down list.

ii. In the case where ‘Any’ is selected, the group will be allowed to [view-edit-analyze-forward] regardless of whether you have a specific location set in the location drop-down list.

f. [View-Edit-Analyze-Forward] innovations from locations: Similar to department, with this drop-down list you can decide what locations a person in the group can [view-edit-analyze-forward]. If you select ‘Any’, then this group will be able to [view-edit-analyze-forward] all innovations. If you select a specific location, then it will be limited to that location. In addition, since locations are set up with a hierarchy, you can decide that the group can only [view-edit-analyze-forward] the selected location, or all sub locations as well. If you select ‘None’, then the group will not be able to [view-edit-analyze-forward] any innovations.

i. In this case where ‘None’ is selected, it will cancel out any other selections, meaning that the group will not be able to [view-edit-analyze-forward] any innovations. It will also not matter whether you have any settings in the location drop-down list.

ii. In the case where ‘Any’ is selected, the group will be allowed to [view-edit-analyze-forward] regardless of whether you have a specific location set in the location drop-down list.

g. Innovation security level: This is the where the main linkage to Innovation Protection Groups is determined. Pick the security levels from the drop-down list that this group will be able to [view-edit-analyze-forward].

h. Sections to [view-edit]: The default is for all sections of an innovation to be [viewable-editable]. If you check this box, then another list of checkboxes will be shown. You will then be able to select specific items for [viewing-editing].

Profile Settings

This section will assign privileges that a group can have with respect to viewing and editing profiles. To configure, click on the checkbox labeled ‘Configure for this Group’. Within each section, there are several checkboxes and drop-down lists to configure.

1. Allow to Search: This allows the group to search through the profiles. If this is not checked, then the search choice for profiles in not shown and the Find Experts menu item is not shown.

2. View Personal Statistics: Allows users to view the personal statistics page.

3. Viewing: As name implies, allows to view profiles. See Innovation Settings above for description of configurable items.

4. Editing: Allows profile to be editing. See Innovation Settings above for description of configurable items.

Innovation Management

This section assigns privileges that a group can have with respect to innovation management. Specific functions that can be allowed include: Make Innovation Private, Set Status, Edit Protection Information, Change Department, Set Showcase, Set Spotlight, Edit Challenges, Detailed Reports, and Summary Reports. To activate a function, click on the checkbox next to the name of the function and then configure any additional information, such as, department and/or location restrictions.

Administration Functions

This section assigns privileges that a group can have with respect to system administration. Specific functions that can be allowed include All Private Innovations, Review Committees, Question Sets, E-Mail Configuration, Setup Users, Setup Groups, Innovation Protections, Innovation Types, Configure Education, Personal Statistics, Setup Departments, and Setup Locations. To activate a function, click on the checkbox next to the name of the function and then configure any additional information, such as, department and/or location.

Innovation Protection Groups

In contrast to user groups that assign rights to users, innovation protection assigns groups of innovations to different classes. Classes do not assign privileges; they are merely groups of innovations. These hierarchical classes are then related with specific user groups. For example, you can decide that a specific user group can view innovations that are classified as “High”, “Medium”, or “Low”, as well as decide that the user group can only view innovations that are “Medium.” You should also read the overview of Innovation Security, and the section on User Groups. To create a new Innovation Protection level, perform the following steps:

1. Click on ‘Inv. Protection’ in the ‘Security’ menu item under the Administration Functions. You will see a list of the currently configured Innovation Protections.

2. Click on the ‘New Protection’ button to add a new innovation protection.

3. A pop-up window will ask you to enter the name of the new protection level you want to create. Type in a name and select a parent from the drop-down list, if necessary, and click the ‘OK’ button. You will be returned to the main list of innovation protections.

{bmct InnovationProtection_list.bmp}

Email Configuration

When users forward/send their innovations to others for review and/or comment, a message is displayed on the forward—to person's Innovator home page. In addition, an automatically generated e-mail can be sent to the forward—to person's e-mail account. This allows the forward—to person to see the review request from the e-mail software client at the same time, and could speed review time for users who do not visit their Innovator home page often.

To configure the system for automatic e-mail notification:

1. Click the menu item ‘Email’ under ‘Innovator Configuration’ in the administration menu.

2. Select the type of e-mail that you want to configure from the drop-down list. The choices are:

a. Forwarding-send an e-mail when an innovation is forwarded,

b. Status Change—send an e-mail when the status of an innovation changes,

c. Comment Made-send an e-mail when a comment has been made on an innovation,

d. Department Change_send an e-mail when the (review) department has been changed,

e. Analyzed/Reviewed-send an e-mail when an analysis has been performed on an innovation,

f. Spotlight-send an e-mail when an innovation has been selected for the Spotlight,

g. Showcase send an e-mail when an innovation has been selected for a Showcase.

3. In the From field, type the name that the e-mail message will come from. It MUST be a valid e-mail address, such as admin@company.com.

4. In the Subject field, type the e-mail subject. Pick a subject that indicates the type of e-mail that is coming from the Innovator, such as “Innovation Review/Analysis Request.”

5. In the Importance field, select High, Normal, or Low from the drop-down list. The importance will be displayed on the recipients e-mail software program.

6. In the Body field, type the text for the body of the e-mail message. Enter text that describes the procedure and the request, such as “You have been requested to review/analyze the innovation below. Click on the link to go directly to the innovation. Do not reply to this message as it is sent automatically and no one will respond. Thank you.” You can also add field variables, designated by [ ] into the body of the e-mail. Field variables include:

a. [InnovationName]

b. [InnovationNumber]

c. [UserFirstName]

d. [UserLastName]

e. [StatusName]

f. [StatusComment]

g. [CommentText]

7. Click on the Enable checkbox.

8. Click on the ‘Submit’ button to enable automatic e-mail notification. Note that you can later disable this feature by simply unchecking the Enable checkbox.

{bmct emailConfig.bmp}

System Variables

There are a number of “system variables” that make changes to the application that can only be made by editing the file GLOBAL.ASA in the wwwroot directory. These include:

login_header: The normal login page contains only a username and password entry fields. This allows you to add text, links, or other information to the initial login page.

profile_warning: This allows you to add text/information to the user profile page. Some organizations require that a notice be given to employees notifying them that others may share their information.

report_footer: This is the footer displayed on all of the report pages.

page_footer: This is the footer displayed on all pages in the Innovator.

forgot_password: When set to “true” it displays a link “Forgot Password?” link.

new_page_expires: This is the number of minutes before web pages must be refreshed. Set it to zero to never expire. Note 1,440 seconds equals 24 hours.

allowCreateUser: If you want to allow users to create their own account, then set this to “true” When the Innovator cannot authenticate a user based on their domain password or e-mail account (they are not in the Innovator), then this allows them to set up their own account. Since users can theoretically enter false information through this, it is optional. The text displayed is “Click her to create new login”. hidelnventorsOnSubmit: If true, this hides the Inventors/Contributors section on the submit page, but allows the user to unhide by clicking a checkbox labeled Additional Inventors. It is implied that the person making the submission is an inventor.

showIAMNotLink: If “true” then

SecurityModel: This determines how security will work in the Innovator. There are three choices:

EIMS: In this mode, the Innovator (and only the Innovator) will authenticate users into the system. Note: If a user has the ‘Use NT Login’ boxed checked on their User Profile, the password will still be their network/NT password-not the password recorded in the User Profile. Also note that the security for the virtual directory should be set to ANONYMOUS.

NTLM: In this mode, users will be authenticated based on their domain username and password. If users have to “log on” to your network before they can access any programs/internet, then this allows security to be handled seamlessly. Note that the ‘Use NT Login’ boxed on each User Profile should be checked for this to work properly. If it is not checked, then the Innovator login page will be displayed instead. In any case, the user MUST be logged into the domain first. If they are not, then they will be unable to access the Innovator. Security for the virtual directory should be set to one of the NT validation schemes and ANONYMOUS should be disabled.

MIXED: This mode will first try to authenticate based on the domain username and password (NTLM mode), and if unsuccessful will try the Innovator database (EIMS). Unlike the NTLM mode, in this mode, the user does not have to be logged into the network first.

Reportlogo: This is the graphical logo displayed on all of the report pages.

SysAdminEmail: This is the e-mail account that receives e-mails that cannot be delivered by the Innovator. It also serves as the e-mail account that will receive messages when the user clicks on the “I am not John Smith” link.

DefaultDomain: This is the domain the user's password will be authenticated in. The server that the Innovator is running from should have easy access to this domain via your organization's network. For example, putting the Innovator server such that it requires communicating with various Domain Controllers to authenticate users will slow system login time.

CompanyName: This is the name that is shown on reports and various pages throughout the Innovator.

User Maintenance

From time to time, it may be necessary to change users within the Innovator. The ‘Users’ menu item under ‘Company Configuration’ in the Administration Functions is where this capability is provided.

Click on Setup Users under the Administration Functions menu. You will see the entire list of current users available in the Innovator. Use the filters for Department, Location, User Group, Review Committees to limit the number of users shown. Enter any combination of letters in the Last Name or First Name fields to find specific users. For example, you only need to type in ‘g’ to the Last Name field to retrieve all of the users with a last name that starts with ‘G’. Click on the button labeled ‘Apply Filter’ to retrieve list based on your specific filters.

{bmet setup_users_list.bmp}

1. Click on the ‘New’ button to add a new user. A blank page will be presented. Fill in the required information. Click on ‘Use NT Logon’ if your system uses NT authentication to allow users into the Innovator, for more information, click System Variables.

2. Click on the ‘Edit’ button to change/modify user details. On this page, you can change the groups and review committees that a user is a member of by clicking on a group name and then either clicking the >> button to remove the user from the group or the << button to add the user to the group.

{bmct setup_users_details.bmp}

3. Click on ‘View Profile’ to view that user's profile.

4. Click on ‘Deactivate’ to remove that user from the active user list. In this case, the user will no longer be shown as an option for an inventor or contributor.

5. Click on the ‘Activate’ to reactivate a user.

Challenges

In the interest of spurring focused innovation, the Breakthrough Challenges section presents a list of strategic problems/areas that management would like solved by the general user community. To create a new challenge use this function to enter the name, description, start and end dates.

1. Select ‘Challenges’ from the ‘Innovator Configuration’ menu within the Administration Functions. Challenges are color-coded based on date: red is used for challenges that are expired, black is used for current challenges, and green for future challenges.

To add a new challenge, click the ‘Add’ button. NOTE: You cannot Add a new challenge if the drop-down lists show ‘All Departments’ and ‘All Locations’. This simply lists all of the challenges in the system.

a. Select a department and/or location from the drop-down lists to indicate where a challenge should be shown. For a challenge that should be viewed by every department and every location, select ‘Global’ and ‘Global’. If you want a challenge to show up under a particular department, select that department, for example ‘Manufacturing’. If that challenge should be shown to all Manufacturing departments in every location, then select ‘Global’ for the location. If instead, you only want the Manufacturing department for a particular location, then select that location from the drop-down list.

b. Enter a title, description, start date, and end date into the appropriate fields.

c. Decide whether to include sub-departments and sub-locations by clicking the Hierarchy checkbox. If you do NOT check this box, then the challenge will only be viewable by users whose department/location matches exactly with what you selected.

To remove challenges from the list, select a challenge from the list and then click the ‘Remove’ button.

To change the order of the challenges within the list, select a challenge from the list and then click either the ‘Up’ or ‘Down’ button to move the challenge.

To view the submissions that have been made to a particular challenge, click on the [+] and a list will appear beneath the challenge. Click on the title of the innovation for an overview or click on ‘Remove Innovation From Challenge’ to delete.

2. Click the ‘Save Changes’ button to save your work.

With respect to the Figures, the drawings, containing as they do unusually large amounts of text compared to more conventional patent disclosures, constitute the preferred embodiment for carrying out the inventive intentions of this disclosure. It is presently believed that the means by which the various schemes herein disclosed, such as programming of web pages, back end databases, networking, internet programming, and the like are all well within the knowledge of those skilled in the computer and internet programming arts, and as such are not required to be recited in this disclosure.

In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

We claim:

1. A system for streamlining the process of creating, preserving and protecting proprietary assets, wherein the system identifies, classifies, compiles, tracks and routes real-time data automatically on a continuous basis, and provides instant access to stored database information, such as trade secret archives, patent filings, computed valuations, user information and a variety of detailed reports, further wherein an employee has instant access to her latest innovations and proprietary materials, and constant supervision over them.

2. A system for web based development and exploitation of IP, the system comprising:
a. an innovator attraction module;
b. a developer attraction module;
c. a registration module;
d. a match module;
whereby the registration module is adapted to accept and store dated related to an innovator and the innovator's innovation in an innovation database, and further whereby the match module is adapted to match a registered innovation and innovator with a developer having stated requirements and resources for development.
